(19) United States
(12) Patent Application Publication
(10) Pub. No.: US 2026/0321601 A1
(43) Pub. Date: Oct. 15, 2026

(54) METHOD FOR FORMING POSITIVE ELECTRODE ACTIVE MATERIAL, POSITIVE ELECTRODE, SECONDARY BATTERY, ELECTRONIC DEVICE, POWER STORAGE SYSTEM, AND VEHICLE

(71) Applicant: SEMICONDUCTOR ENERGY LABORATORY CO., LTD., Atsugi-shi (JP)

(72) Inventors: Shunpei YAMAZAKI, Tokyo (JP); Tetsuya KAKEHATA, Isehara (JP); Shuhei YOSHITOMI, Ayase (JP); Atsushi KAWATSUKI, Atsugi (JP)

(21) Appl. No.: 19/657,196

(22) Filed: Apr. 24, 2026

Related U.S. Application Data
(62) Division of application No. 18/249,901, filed on Oct. 13, 2021.

(30) Foreign Application Priority Data
Oct. 26, 2020 (JP) 2020-179194
Nov. 9, 2020 (JP) 2020-186852
Nov. 17, 2020 (JP) 2020-191054

(51) Int. Cl. H01M 4/36; C01F 7/02; C01G 49/00; C01G 53/66; H01M 4/02; H01M 4/48; H01M 4/525; H01M 4/58

(52) U.S. Cl. CPC H01M 4/366; C01F 7/02; C01G 49/009; C01G 53/66; H01M 4/483; H01M 4/525; H01M 4/5825; C01P 2002/85; C01P 2004/03; C01P 2004/04; C01P 2006/40; H01M 2004/028; H01M 2220/20

(57) ABSTRACT

A positive electrode active material that is stable in a high potential state or a high temperature state and a highly safe secondary battery are provided. The positive electrode includes a first material and a second material and includes a region where at least part of a surface of the first material is covered with the second material. The first material includes a lithium cobalt oxide containing magnesium, fluorine, aluminum, and nickel. The second material includes a composite oxide (containing one or more selected from Fe, Ni, Co, and Mn) having an olivine crystal structure.

### CROSS REFERENCE TO RELATED APPLICATIONS

This application is a divisional of U.S. application Ser. No. 18/249,901, filed Apr. 20, 2023, now allowed, which is incorporated by reference, and is a U.S. National Phase Application under 35 U.S.C. § 371 of International Application PCT/IB2021/059382, filed on Oct. 13, 2021, which is incorporated by reference and claims the benefit of foreign priority applications filed in Japan on Oct. 26, 2020, as Application No. 2020-179194, on Nov. 9, 2020, as Application No. 2020-186852, and on Nov. 17, 2020, as Application No. 2020-191054.

### TECHNICAL FIELD

One embodiment of the present invention relates to a method for forming a positive electrode active material. Another embodiment of the present invention relates a method for forming a positive electrode. Another embodiment of the present invention relates a method for forming a secondary battery. Another embodiment of the present invention relates to a portable information terminal, a power storage system, a vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. Note that one embodiment of the present invention particularly relates to a method for forming a positive electrode active material or the positive electrode active material. Alternatively, one embodiment of the present invention particularly relates to a method for forming a positive electrode or the positive electrode. Alternatively, one embodiment of the present invention particularly relates to a method for forming a secondary battery or the secondary battery.

Note that semiconductor devices in this specification mean all devices that can function by utilizing semiconductor characteristics, and an electro-optical device, a semiconductor circuit, and an electronic device are all semiconductor devices.

Note that electronic devices in this specification mean all devices including positive electrode active materials, secondary batteries, or power storage devices, and electro-optical devices including positive electrode active materials, positive electrodes, secondary batteries, or power storage devices, information terminal devices including power storage devices, and the like are all electronic devices.

Note that in this specification and the like, a power storage device refers to every element and device having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demands for lithium-ion secondary batteries with high output and high energy density have rapidly grown with the development of the semiconductor industry, for portable information terminals such as mobile phones, smartphones, and laptop computers, portable music players, digital cameras, medical equipment, home power storage systems, industrial power storage systems, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

Above all, composite oxides having a layered rock salt structure, such as a lithium cobalt oxide and a lithium nickel-cobalt-manganese oxide, are widely used. These materials have characteristics of high capacity and high discharge voltage, which are useful for active materials for power storage devices; to exhibit high capacity, a positive electrode is exposed to a high potential versus a lithium potential at the time of charging. In such a high potential state, release of a large amount of lithium might cause a reduction in stability of the crystal structure to cause significant deterioration in charge and discharge cycles. In the aforementioned background, improvements of positive electrode active materials included in positive electrodes of secondary batteries are actively conducted so as to achieve highly stable secondary batteries with high capacity (e.g., Patent Document 1 to Patent Document 3).

### REFERENCE

### Patent Document

[Patent Document 1] Japanese Published Patent Application No. 2018-088400
[Patent Document 2] PCT International Publication No. WO2018/203168
[Patent Document 3] Japanese Published Patent Application No. 2020-140954

### Non-Patent Document

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16), 2009, 165114
[Non-Patent Document 3] Zhaohui Chen et al., “Staging Phase Transitions in LiₓCoO₂”, Journal of The Electrochemical Society, 2002, 149 (12), 2002, 149 (12), A1604-A1609.
[Non-Patent Document 4] W. E. Counts et al., Journal of the American Ceramic Society, 1953, 36 [1], pp. 12-17. FIG. 01471.
[Non-Patent Document 5] Belsky, A. et al., “New developments in the Inorganic Crystal Structure Database (ICSD): accessibility in support of materials research and design”, Acta Cryst., 2002, B58, pp. 364-369.

### SUMMARY OF THE INVENTION

### Problems to be Solved by the Invention

In spite of the active improvements of positive active materials conducted in Patent Documents 1 to 3, development of lithium-ion secondary batteries and positive electrode active materials used therein has room for improvement in terms of charge and discharge capacity, cycle performance, reliability, safety, cost, and the like.

In view of the above, an object of one embodiment of the present invention is to provide a method for forming a positive electrode active material that is stable in a high potential state and/or a high temperature state. Another object is to provide a method for forming a positive electrode active material whose crystal structure is not easily broken even when charging and discharging are repeated. Another object is to provide a method for forming a positive electrode active material with excellent charge and discharge cycle performance. Another object is to provide a method for forming a positive electrode active material with high charge and discharge capacity. Another object is to provide a highly reliable or safe secondary battery.

An object of one embodiment of the present invention is to provide a method for forming a positive electrode that is stable in a high potential state and/or a high temperature state. Another object is to provide a method for forming a positive electrode with excellent charge and discharge cycle performance. Another object is to provide a method for forming a positive electrode with high charge and discharge capacity. Another object is to provide a highly reliable or safe secondary battery.

Another object of one embodiment of the present invention is to provide a novel material, novel active material particles, a novel electrode, a novel secondary battery, a novel power storage device, or a formation method thereof. Another object of one embodiment of the present invention is to provide a method for forming a secondary battery having one or more of characteristics selected from increased purity, improved performance, and increased reliability or to provide the secondary battery.

Note that the description of these objects does not preclude the existence of other objects. Note that one embodiment of the present invention does not have to achieve all the objects. Other objects can be derived from the description of the specification, the drawings, and the claims.

### Means for Solving the Problems

For a composite including a positive electrode active material, a structure where at least part of a particle surface of a particulate first material functioning as a positive electrode active material is covered with a second material is preferred, and a structure where substantially the entire particle surface of the particulate first material is covered with the second material is further preferred. Here, the state of covering substantially the entire particle surface refers to a state where the particulate first material is not directly in contact with an electrolyte.

In the state where at least part of the particle surface, desirably, substantially the entire particle surface of the first material is covered with the second material, a region where the first material is directly in contact with the electrolyte is small, which can inhibit release of a transition metal element and/or oxygen from the first material in a high-voltage charged state. Accordingly, a capacity reduction due to repeated charging and discharging can be inhibited. As effects obtained when a material with a stable crystal structure is used as the second material also in a high-voltage charged state, an improvement in stability at high temperatures, an improvement in fire resistance, and the like can be achieved in the secondary battery including the composite of one embodiment of the present invention.

Furthermore, the use of the material having excellent stability in a high-voltage charged state as the first material allows the composite to have further improved durability and further improved stability in a high-voltage charged state. In addition, the secondary battery including the composite can have further improved heat resistance and/or fire resistance.

It is preferable to use, for example, a lithium cobalt oxide having excellent stability in a high-voltage charged state and/or a metal-oxide-coated composite oxide having excellent stability in a high-voltage charged state, as the first material. As the lithium cobalt oxide having excellent stability in a high-voltage charged state, it is possible to use a lithium cobalt oxide to which magnesium and fluorine are added or a lithium cobalt oxide to which magnesium, fluorine, aluminum, and nickel are added, for example. As the metal-oxide-coated composite oxide having excellent stability in a high-voltage charged state, a metal-oxide-coated composite oxide in which secondary particles of lithium nickel-cobalt-manganese oxide are covered with an aluminum oxide is preferably used, for example. The lithium nickel-cobalt-manganese oxide can have an atomic ratio such as nickel:cobalt:manganese=8:1:1 or nickel:cobalt:manganese=9:0.5:0.5.

Note that the lithium cobalt oxide to which magnesium, fluorine, aluminum, and nickel are added exhibits remarkably excellent repetitive charge and discharge characteristics at a high voltage when initial heating described later is performed, and thus is a material particularly preferred as the first material.

One or both of an oxide and LiM2PO₄ (M2 is one or more selected from, Fe, Ni, Co, and Mn) can be used as the second material that covers at least part of the particle surface, desirably, substantially the entire particle surface of the first material. Examples of the oxide include an aluminum oxide, a zirconium oxide, a hafnium oxide, and a niobium oxide. Examples of LiM2PO₄ (M2 is one or more selected from, Fe, Ni, Co, and Mn) include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

Note that the positive electrode of the present invention may have a structure where at least part of the surface of the composite is covered with a graphene compound. It is preferable that 80% or more of the particle surface of the composite and/or 80% or more of an aggregate including the composite be covered with a graphene compound.

One embodiment of the present invention is a positive electrode including a first material and a second material covering at least part of a surface of the first material. The first material includes a first composite oxide represented by LiM1O₂ (M1 is one or more selected from Fe, Ni, Co, Mn, and Al). The second material includes a second composite oxide represented by LiM2PO₄ (M2 is one or more selected from Fe, Ni, Co, and Mn).

One embodiment of the present invention is a positive electrode including a first material and a second material covering at least part of a surface of the first material. The first material includes a lithium cobalt oxide containing magnesium, fluorine, aluminum, and nickel. The second material includes a second composite oxide represented by LiM2PO₄ (M2 is one or more selected from Fe, Ni, Co, and Mn).

One embodiment of the present invention is a positive electrode including a first material and a second material covering at least part of a surface of the first material. The first material includes a lithium cobalt oxide containing magnesium, fluorine, aluminum, and nickel. A surface portion of the lithium cobalt oxide includes a region with the highest concentrations of the magnesium, the fluorine, and the aluminum. The second material includes a second composite oxide represented by LiM2PO₄ (M2 is one or more selected from Fe, Ni, Co, and Mn).

One embodiment of the present invention is a positive electrode including a first material and a second material covering at least part of a surface of the first material. The first material includes a first composite oxide represented by LiM1O₂ (M1 is one or more selected from Fe, Ni, Co, Mn, and Al). The second material includes an aluminum oxide.

One embodiment of the present invention is a positive electrode including a first material and a second material covering at least part of a surface of the first material. The first material includes a lithium cobalt oxide containing magnesium, fluorine, aluminum, and nickel. The second material includes an aluminum oxide.

One embodiment of the present invention is a positive electrode including a first material and a second material covering at least part of a surface of the first material. The first material includes a lithium cobalt oxide containing magnesium, fluorine, aluminum, and nickel. A surface portion of the lithium cobalt oxide includes a region with the highest concentrations of the magnesium, the fluorine, and the aluminum. The second material includes an aluminum oxide.

One embodiment of the present invention is a positive electrode including a first material and a second material. The first material includes a first composite oxide represented by LiM1O₂ (M1 is one or more selected from Fe, Ni, Co, Mn, and Al). The second material includes a second composite oxide represented by LiM2PO₄ (M2 is one or more selected from Fe, Ni, Co, and Mn).

One embodiment of the present invention is a secondary battery including the positive electrode described in any one of the above.

One embodiment of the present invention is a vehicle including the above secondary battery.

One embodiment of the present invention is a power storage system including the above secondary battery.

One embodiment of the present invention is an electronic device including the above secondary battery.

One embodiment of the present invention is a method for forming a positive electrode active material including a first material and a second material, which includes a first step of covering at least part of a surface of the first material with the second material to form a composite, and a second step of heating the composite. The first material includes a lithium cobalt oxide containing magnesium, fluorine, aluminum, and nickel. The second material includes a second composite oxide represented by LiM2PO₄ (M2 is one or more selected from Fe, Ni, Co, and Mn). The heating is performed in an oxygen-containing atmosphere.

One embodiment of the present invention is a method for forming a positive electrode active material including a first material and a second material, which includes a first step of covering at least part of a surface of the first material with the second material to form a composite, and a second step of heating the composite. The first material includes a lithium cobalt oxide containing magnesium, fluorine, aluminum, and nickel. The second material includes an aluminum oxide. The heating is performed in an oxygen-containing atmosphere.

In one embodiment of the present invention, the heating is preferably performed at higher than or equal to 450° C. and lower than or equal to 800° C. in any one of the above,

### Effect of the Invention

According to one embodiment of the present invention, a method for forming a positive electrode active material that is stable in a high potential state and/or a high temperature state can be provided. Alternatively, a method for forming a positive electrode active material whose crystal structure is not easily broken even when charging and discharging are repeated can be provided. Alternatively, a method for forming a positive electrode active material with excellent charge and discharge cycle performance can be provided. Alternatively, a method for forming a positive electrode active material with high charge and discharge capacity can be provided. Alternatively, a highly reliable or safe secondary battery can be provided.

According to one embodiment of the present invention, a novel material, novel active material particles, a novel secondary battery, a novel power storage device, or a formation method thereof can be provided. According to one embodiment of the present invention, a method for forming a secondary battery having one or more of characteristics selected from increased purity, improved performance, and increased reliability or to provide the secondary battery can be provided.

Note that the description of these effects does not preclude the existence of other effects. Note that one embodiment of the present invention does not need to have all the effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A to FIG. 1C are diagrams showing examples of a method for forming a positive electrode active material of one embodiment of the present invention.

FIG. 2A and FIG. 2B are diagrams relating to calculation on an example of a positive electrode active material of one embodiment of the present invention.

FIG. 3A to FIG. 3C are graphs relating to calculation on an example of a positive electrode active material of one embodiment of the present invention.

FIG. 4 is a diagram relating to calculation on an example of a positive electrode active material of one embodiment of the present invention.

FIG. 5A and FIG. 5B are graphs relating to calculation on an example of a positive electrode active material of one embodiment of the present invention.

FIG. 6A and FIG. 6B are diagrams showing an example of a method for forming a positive electrode of one embodiment of the present invention.

FIG. 7A and FIG. 7B are diagrams showing an example of a method for forming a positive electrode of one embodiment of the present invention.

FIG. 8 is a diagram showing an example of a method for forming a positive electrode of one embodiment of the present invention.

FIG. 9 is a diagram showing an example of a method for forming a positive electrode of one embodiment of the present invention.

FIG. 10A and FIG. 10B are diagrams showing examples of a method for forming a positive electrode active material of one embodiment of the present invention.

FIG. 11A to FIG. 11C are diagrams showing an example of a method for forming a positive electrode active material of one embodiment of the present invention.

FIG. 12 is a diagram showing an example of a method for forming a positive electrode active material of one embodiment of the present invention.

FIG. 13A to FIG. 13C are diagrams showing example of a method for forming a positive electrode active material of one embodiment of the present invention.

FIG. 14A to FIG. 14C are diagrams showing an example of a method for forming a positive electrode active material.

FIG. 15 is a diagram showing an example of a method for forming a positive electrode active material.

FIG. 16A to FIG. 16C are diagrams showing an example of a method for forming a positive electrode active material.

FIG. 17A is a top view of a positive electrode active material of one embodiment of the present invention, and FIG. 17B is a cross-sectional view of the positive electrode active material of one embodiment of the present invention.

FIG. 18 is a diagram illustrating the occupancy rate of Li and crystal structures of a positive electrode active material of one embodiment of the present invention.

FIG. 19 shows XRD patterns calculated from crystal structures.

FIG. 20 is a diagram illustrating the occupancy rate of Li and crystal structures of a positive electrode active material for a comparison example.

FIG. 21 shows XRD patterns calculated from crystal structures.

FIG. 22A to FIG. 22C show lattice constants calculated with XRD.

FIG. 23A to FIG. 23C show lattice constants calculated with XRD.

FIG. 24 is a graph of charge capacity and voltage.

FIG. 25A is a graph of dQ/dV of a secondary battery of one embodiment of the present invention. FIG. 25B is a graph of dQ/dV of a secondary battery of one embodiment of the present invention. FIG. 25C is a graph of dQ/dV of a secondary battery of a comparative example.

FIG. 26 is a schematic cross-sectional view of a positive electrode active material.

FIG. 27A and FIG. 27B are SEM images of a positive electrode.

FIG. 28A is a front view showing three-dimensional information, FIG. 28B is an enlarged view of part thereof, FIG. 28C is a cross-sectional view thereof, FIG. 28D is a side view showing three-dimensional information, FIG. 28E is an enlarged view of part thereof, and FIG. 28F is a cross-sectional view thereof.

FIG. 29A to FIG. 29C are SEM images of a positive electrode.

FIG. 30A to FIG. 30C are SEM images of a positive electrode.

FIG. 31A and FIG. 31B are STEM images of a positive electrode.

FIG. 32A to FIG. 32C show EDX analysis results of a positive electrode.

FIG. 33A and FIG. 33B are cross-sectional TEM images of a positive electrode active material layer.

FIG. 34A to FIG. 34C show nanobeam electron diffraction patterns of a positive electrode active material layer.

FIG. 35A to FIG. 35C are diagrams illustrating examples of a crystal structure.

FIG. 36A is cross-sectional STEM image of a particle after being pressed, and FIG. 36B and FIG. 36C are cross-sectional schematic views.

FIG. 37 is a diagram showing an example of a method for forming a positive electrode active material of one embodiment of the present invention.

FIG. 38 is a diagram showing an example of a method for forming a positive electrode active material of one embodiment of the present invention.

FIG. 39A to FIG. 39E are diagrams showing an example of a method for forming a positive electrode active material of one embodiment of the present invention.

FIG. 40 is a diagram showing an example of a method for forming a positive electrode active material of one embodiment of the present invention.

FIG. 41 is a diagram showing an example of a method for forming a positive electrode active material of one embodiment of the present invention.

FIG. 42 is a diagram showing an example of a method for forming a positive electrode active material of one embodiment of the present invention.

FIG. 43 is a diagram showing an example of a method for forming a positive electrode active material of one embodiment of the present invention.

FIG. 44 is a diagram showing an example of a method for forming a positive electrode active material of one embodiment of the present invention.

FIG. 45 is a diagram showing an example of a method for forming a positive electrode active material of one embodiment of the present invention.

FIG. 46 is a diagram showing an example of a method for forming a positive electrode active material of one embodiment of the present invention.

FIG. 47 is a diagram showing an example of a method for forming a positive electrode active material of one embodiment of the present invention.

FIG. 48A and FIG. 48B are cross-sectional views of a positive electrode active material.

FIG. 49A to FIG. 49C are diagrams showing concentration distribution in a positive electrode active material.

FIG. 50 is a diagram showing an example of a method for forming a positive electrode active material of one embodiment of the present invention.

FIG. 51 is a diagram showing an example of a method for forming a positive electrode active material of one embodiment of the present invention.

FIG. 52 is a diagram illustrating an example of a positive electrode of one embodiment of the present invention.

FIG. 53A is an exploded perspective view of a coin-type secondary battery, FIG. 53B is a perspective view of the coin-type secondary battery, and FIG. 53C is a cross-sectional perspective view thereof.

FIG. 54A illustrates an example of a cylindrical secondary battery. FIG. 54B illustrates an example of a cylindrical secondary battery. FIG. 54C illustrates an example of a plurality of cylindrical secondary batteries. FIG. 54D illustrates an example of a power storage system including a plurality of cylindrical secondary batteries.

FIG. 55A and FIG. 55B are diagram illustrating examples of a secondary battery, and FIG. 55C is a diagram illustrating the internal state of the secondary battery.

FIG. 56A to FIG. 56C are diagrams illustrating an example of a secondary battery.

FIG. 57A and FIG. 57B are external views of a secondary battery.

FIG. 58A to FIG. 58C are diagrams illustrating a method for forming a secondary battery.

FIG. 59A to FIG. 59C are diagrams illustrating structure examples of a battery pack.

FIG. 60A and FIG. 60B are diagrams illustrating examples of a secondary battery.

FIG. 61A to FIG. 61C are diagrams illustrating an example of a secondary battery.

FIG. 62A and FIG. 62B are diagrams illustrating examples of a secondary battery.

FIG. 63A is a perspective view of a battery pack of one embodiment of the present invention,

FIG. 63B is a block diagram of a battery pack, and FIG. 63C is a block diagram of a vehicle including a motor.

FIG. 64A to FIG. 64D are diagrams illustrating examples of transport vehicles.

FIG. 65A and FIG. 65B are diagrams illustrating power storage devices of one embodiment of the present invention.

FIG. 66A is a diagram illustrating an electric bicycle, FIG. 66B is a diagram illustrating a secondary battery of the electric bicycle, and FIG. 66C is a diagram illustrating an electric motorcycle.

FIG. 67A to FIG. 67D are diagrams illustrating examples of electronic devices.

FIG. 68A illustrates examples of wearable devices, FIG. 68B is a perspective view of a watch-type device, and FIG. 68C is a diagram illustrating a side surface of the watch-type device.

FIG. 68D is a diagram illustrating an example of wireless earphones.

FIG. 69A to FIG. 69C are surface SEM images of a positive electrode active material.

FIG. 70A and FIG. 70B are graphs showing cycle performance.

### MODE FOR CARRYING OUT THE INVENTION

Embodiments of the present invention will be described in detail below with reference to the drawings. However, the present invention is not limited to the description below and it is easily understood by those skilled in the art that the mode and details can be modified in various ways. In addition, the present invention should not be construed as being limited to the description of the embodiments below.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly include a substance that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite including a positive electrode active material.

In this specification and the like, particles are not necessarily spherical (with a circular cross section). Other examples of the cross-sectional shapes of particles include an ellipse, a rectangle, a trapezoid, a pyramid, a quadrilateral with rounded corners, and an asymmetrical shape, and a particle may have an indefinite shape.

Particle diameters can be measured by laser diffraction particle distribution and can be compared by the numerical values of D50. Here, D50 is a particle diameter when the accumulated amount of particles accounts for 50% of an accumulated particle amount curve which is the result of the particle size distribution measurement. Measurement of the size of a particle is not limited to laser diffraction particle distribution measurement; in the case where the size is less than or equal to the lower measurement limit of laser diffraction particle distribution measurement, the major axis of a cross section of the particle may be measured by analysis with a SEM (Scanning Electron Microscope), a TEM (Transmission Electron Microscope), or the like.

In this specification and the like, the Miller index is used for the expression of crystal planes and orientations. An individual plane that shows a crystal plane is denoted by “( )”. In the crystallography, a bar is placed over a number in the expression of crystal planes, orientations, and space groups; in this specification and the like, because of application format limitations, crystal planes, orientations, and space groups are sometimes expressed by placing − (minus sign) in front of the number instead of placing a bar over the number.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist in part of the crystal structure.

In this specification and the like, the theoretical capacity of a positive electrode active material refers to the amount of electricity for the case where all the lithium that can be inserted and extracted in the positive electrode active material is extracted. For example, the theoretical capacity of LiFePO₄ is 170 mAh/g, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, the remaining amount of lithium that can be inserted into and extracted from a positive electrode active material is represented by x in a compositional formula, e.g., LiₓCoO₂ or LiₓMO₂. In this specification, LiₓCoO₂ can be replaced with LiₓMO₂ as appropriate. In the case of a positive electrode active material in a secondary battery, x can be represented by (theoretical capacity-charge capacity)/theoretical capacity. For example, when a secondary battery including LiCoO₂ as a positive electrode active material is charged to 219.2 mAh/g, the positive electrode active material can be represented by Li_{0.2}CoO₂ or x=0.2. Small x in LiₓCoO₂ means, for example, 0.1<x≤0.24.

Lithium cobalt oxide to be used for a positive electrode, which has been appropriately synthesized and almost satisfies the stoichiometric proportion, is LiCoO₂, and the occupancy rate x of Li in the lithium sites is 1. For a secondary battery after its discharge ends, it can be said that lithium cobalt oxide is LiCoO₂ and x=1. Here, “discharge ends” means that a voltage becomes 2.5 V (vs Li/Li⁺) or lower at a discharge current of 100 mA/g, for example.

In this specification and the like, an example in which a lithium metal is used for a negative electrode in a secondary battery including a positive electrode and a positive electrode active material of one embodiment of the present invention is described in some cases; however, the secondary battery of one embodiment of the present invention is not limited to this example. A different material such as graphite or lithium titanate may be used for a negative electrode, for example. The properties of the positive electrode and the positive electrode active material of one embodiment of the present invention, such as a crystal structure unlikely to be broken by repeated charge and discharge and excellent cycle performance, are not affected by the material of the negative electrode. For example, the secondary battery of one embodiment of the present invention using a lithium counter electrode is charged and discharged at a relatively high charge voltage of 4.6 V in some cases; however, charging and discharging may be performed at a lower voltage. Charging and discharging at a lower voltage will result in cycle performance better than that described in this specification and the like.

In this specification and the like, the term “kiln” refers to an apparatus for heating an object. Instead of the kiln, the term “furnace”, “stove”, or “heating apparatus” may be used, for example.

### Embodiment 1

In this embodiment, a composite including a positive electrode active material, a method for forming a composite, and a method for forming a positive electrode that are embodiments of the present invention will be described.

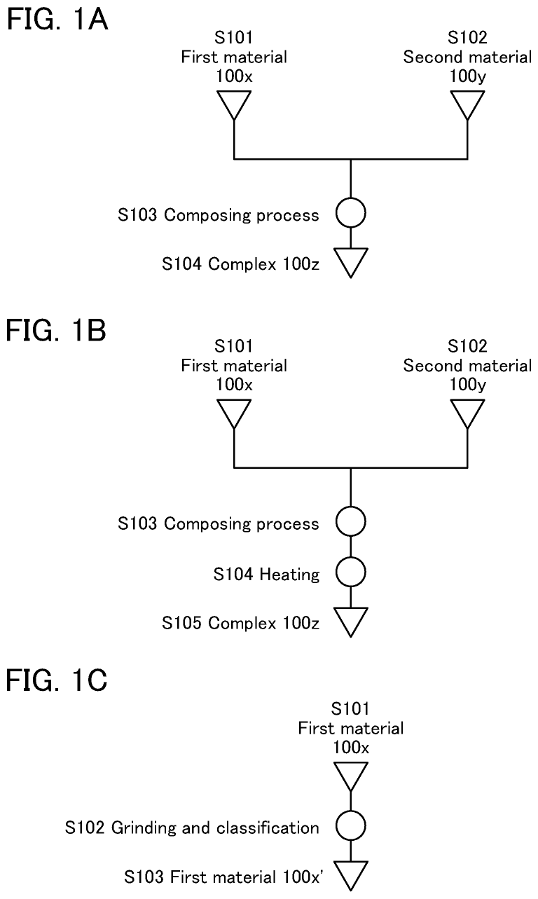

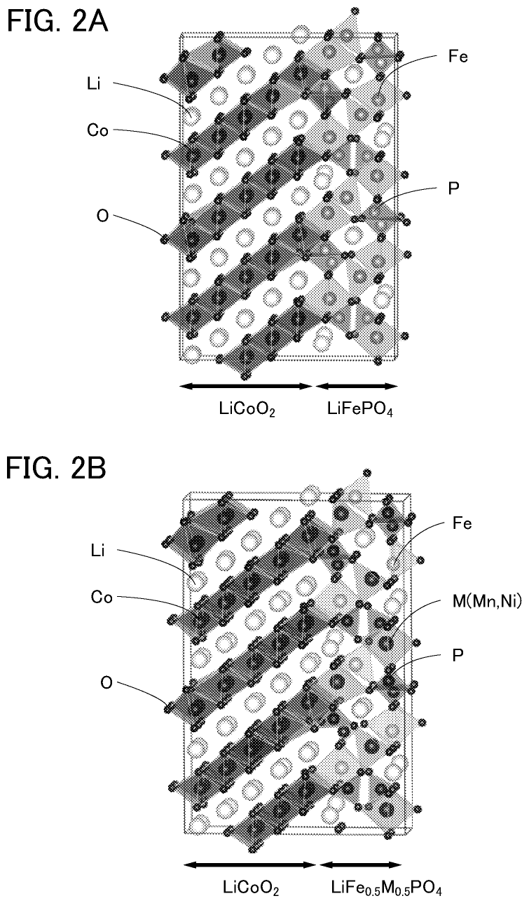

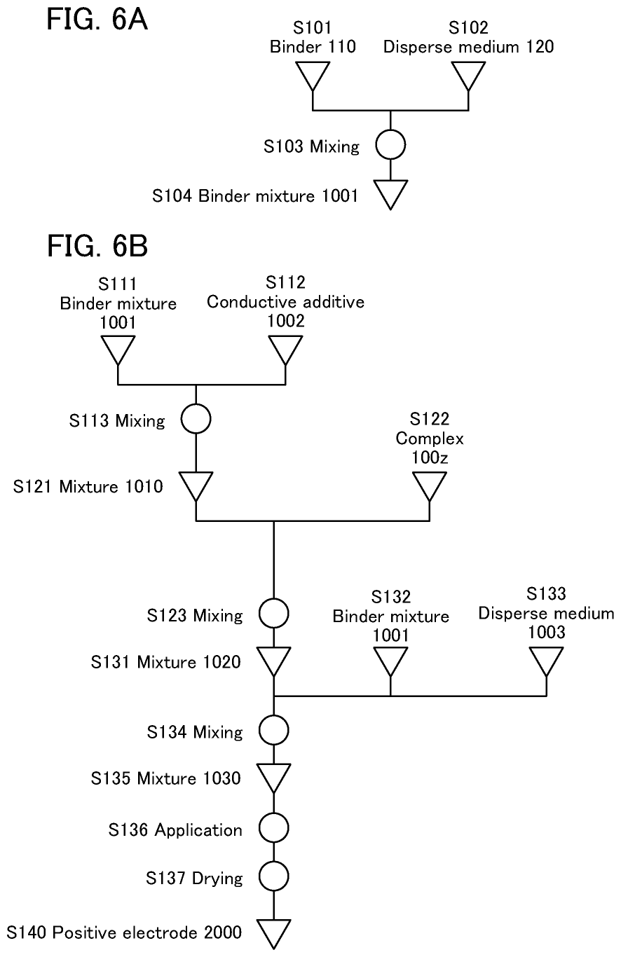

FIG. 1A to FIG. 1C show a method for forming a composite including a positive electrode active material. FIG. 2A to FIG. 5B are diagrams relating to calculation on a composite including a positive electrode active material. FIG. 6A to FIG. 9 each show a method for forming a positive electrode.

A positive electrode includes a positive electrode active material layer and a positive electrode current collector. The positive electrode active material layer includes a composite including a first material functioning as a positive electrode active material and a second material covering at least part of the first material, and may further include a conductive additive and a binder. Note that the composite including the positive electrode active material is simply referred to as a positive electrode active material in some cases.

The composite including the positive electrode active material can be obtained by a composing process, which will be described later, with the use of at least the first material and the second material. As the composing process, at least one or more of the following composing processes can be performed: a composing process utilizing mechanical energy, e.g., a mechanochemical method, a mechanofusion method, or a ball mill method; a composing process utilizing a liquid phase reaction, e.g., a coprecipitation method, a hydrothermal method, or a sol-gel method; and a composing process utilizing a gas phase reaction, e.g., a barrel sputtering method, an ALD (Atomic Layer Deposition) method, an evaporation method, or a CVD (Chemical Vapor Deposition) method. After the composing process, heat treatment is preferably performed. Note that a composing process in this specification is also referred to as a surface coating process or a coating process.

When heat treatment is performed after the composing process, the second material covering at least part of the first material sinters or melts and spreads, in which case an effect of reducing areas where the first material is directly in contact with an electrolyte can be expected. When the temperature of the heat treatment after the composing process is too high, elements of the second material diffuse into the inside of the first material more than necessary, in which case the chargeable/dischargeable capacity of the first material may be reduced and an effect of the second material as the covering layer might be lowered. Therefore, when heat treatment is performed after the composing process, the heating temperature, heating time, and heating atmosphere need to be set appropriately.

As a method 1 for forming a composite, a formation method for the case of performing a composing process on a first material 100x and a second material 100y using mechanical energy will be described. Note that the present invention should not be interpreted as being limited to these descriptions.

### [Method 1 for Forming Composite]

An example of the method for forming a composite including a positive electrode active material of one embodiment of the present invention will be described with reference to FIG. 1A to FIG. 1C.

The first material 100x is prepared in Step S101 in FIG. 1A, and the second material 100y is prepared in Step S102.

As the first material 100x, it is possible to use a composite oxide to which an additive element X is added, which is formed by a formation method described in Embodiment 3 below and represented by LiM1O₂ (M1 is one or more selected from Fe, Ni, Co, Mn, and Al), e.g., a lithium cobalt oxide to which magnesium and fluorine are added, or a lithium cobalt oxide to which magnesium, fluorine, aluminum, and nickel are added. In particular, a lithium cobalt oxide to which magnesium, fluorine, aluminum, and nickel are added and which is subjected to initial heating described in Embodiment 3 is preferred. As another example of the first material 100x, a lithium nickel-cobalt-manganese oxide can be used. Here, as for the proportions of the transition metals of the lithium nickel-cobalt-manganese oxide, the proportion of nickel is preferably high; e.g., a material with an atomic ratio of nickel:cobalt:manganese=8:1:1 or nickel:cobalt:manganese=9:0.5:0.5 is preferred.

Moreover, a metal-oxide-coated composite oxide in which secondary particles of lithium nickel-cobalt-manganese oxide are coated with an aluminum oxide can be used. Here, the thickness of the coating layer (aluminum oxide) of the metal-oxide-coated composite oxide is preferably small, for example, greater than or equal to 1 nm and less than or equal to 200 nm, further preferably greater than or equal to 1 nm and less than or equal to 100 nm. A lithium nickel-cobalt-manganese oxide to which calcium is added is preferably included as the above-described lithium nickel-cobalt-manganese oxide.

As the second material 100y, LiM2PO₄ (M2 is one or more selected from Fe, Ni, Co, and Mn) can be used. Alternatively, an oxide can be used as the second material 100y. Examples of the oxide include an aluminum oxide, a zirconium oxide, a hafnium oxide, and a niobium oxide. The above-described material, e.g., LiFePO₄, LiMnPO₄, LiFeₐMn_{b}PO₄ (a+b≤1, 0<a<1, 0<b<1), or LiFeₐNi_{b}PO₄ (a+b≤1, 0<a<1, 0<b<1) can be used as LiM2PO₄. In addition, a carbon coating layer may be provided on the particle surface of the second material 100y.

Note that in the case where a material functioning as a positive electrode active material is used as the second material 100y, it is possible to select, as a combination of the first material 100x and the second material 100y, a combination that is less likely to generate a step in a charge-discharge curve in accordance with characteristics required for a secondary battery or a combination that generates a step in a charge-discharge curve in a desired charge rate.

Next, in Step S103, a composing process of the first material 100x and the second material 100y is performed. In the case of using mechanical energy, the composing process can be performed by a mechanochemical method. Alternatively, the process may be performed by a mechanofusion method.

In the case where a ball mill is used in Step S103, zirconia balls are preferably used as media, for example. In order to perform mixing, a dry ball mill process is desired. In the case of performing a wet ball mill process, acetone can be used. In the case of performing a wet ball mill process, it is preferable to use dehydrated acetone with a moisture content of 100 ppm or lower, desirably 10 ppm or lower.

The composing process in Step S103 can creates a state where at least part of, desirably substantially the entire particle surface of the particulate first material 100x is covered with the second material 100y.

Through the above steps, a composite 100z including a positive electrode active material of one embodiment of the present invention shown in FIG. 1A can be formed (Step S104). Note that the composite 100z including the positive electrode active material obtained here is simply referred to as a positive electrode active material in some cases.

In a formation method show in FIG. 1B, the steps up to Step S103 are the same as those in the formation method shown in FIG. 1A, and heat treatment is performed in Step S104 after Step S103. The heating in Step S104 is performed in an oxygen-containing atmosphere at higher than or equal to 400° C. and lower than or equal to 950° C., preferably higher than or equal to 450° C. and lower than or equal to 800° C., for longer than or equal to 1 hour and shorter than or equal to 60 hours, preferably for longer than or equal to 2 hours and shorter than or equal to 20 hours.

Through the above steps, the composite 100z including the positive electrode active material of one embodiment of the present invention shown in FIG. 1B can be formed (Step S105). Note that the composite 100z including the positive electrode active material obtained here is simply referred to as a positive electrode active material in some cases.

Note that in order to obtain a favorable coating state in the composing process, the ratio of the particle diameter of the second material 100y to the particle diameter of the first material 100x (the particle diameter of the second material 100y/the particle diameter of the first material 100x) is preferably greater than or equal to 1/100 and less than or equal to 1/50, further preferably greater than or equal to 1/200 and less than or equal to 1/100. To adjust the particle diameter of second material 100y, a microparticulation process may be performed by the method shown in FIG. 1C.

### [Calculation 1 on Composite]

For the calculation on an example of the composite including the positive electrode active material, a structure with a combination of LiCoO₂ and LiFePO₄ and a structure with a combination of LiCoO₂ and LiFe_{0.5}Mn_{0.5}PO₄ or LiFe_{0.5}Ni_{0.5}PO₄ are optimized by density functional theory (DFT) and evaluated. Table 1 shows main calculation conditions, and FIG. 2A and FIG. 2B show the initial states of the models used for the calculation.

TABLE 1

| Software | VASP | |
|---|---|---|
| Functional | GGA + U (DFT-D2) | |
| Pseudo potential | PAW | |
| Cut-off energy (eV) | 600 | |
| U potential | Mn | 4.64 |
| | Fe | 4.90 |
| | Co | 4.91 |
| | Ni | 5.26 |

| | |
|---|---|
| Number of atoms | 52 Li atoms, 40 Co atoms, 6 Fe atoms, |
| | 6 Fe, Mn, or Ni atoms, 12 P atoms, |
| | and 128 O atoms |
| k-points | 1 × 1 × 1 |
| Calculation target | Lattices and atomic positions are optimized |

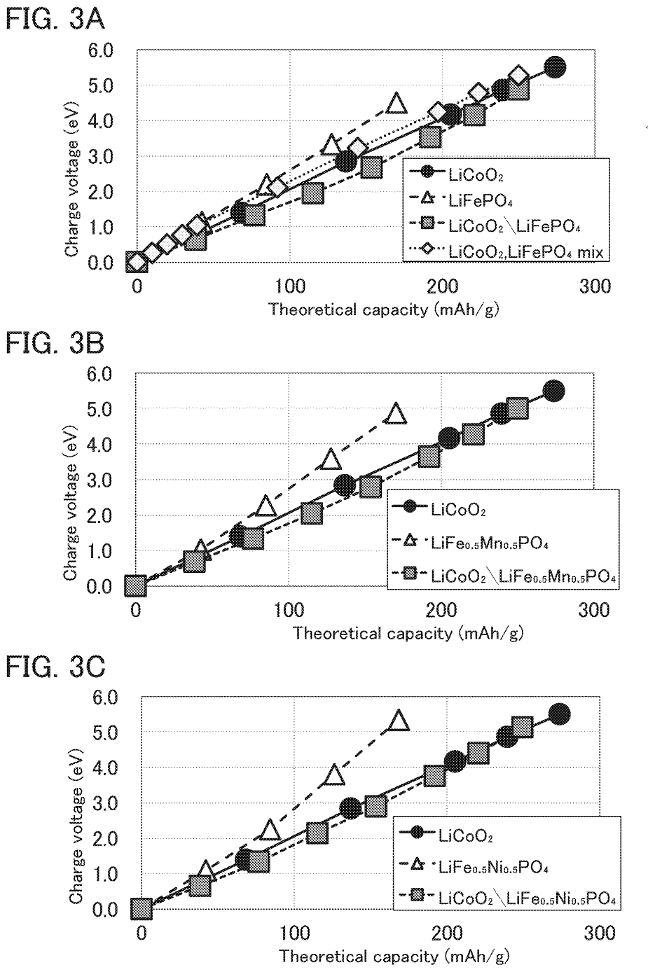

FIG. 2A shows the structure with the combination of LiCoO₂ and LiFePO₄ as the initial state of the model used for calculation. FIG. 2B shows the structure with the combination of LiCoO₂ and LiFe_{0.5}Mn_{0.5}PO₄ or LiFe_{0.5}Ni_{0.5}PO₄. A potential difference between before and after extraction of Li (corresponding to a potential difference at the time of charging) is calculated for each of these models with the structures. The calculation results are shown in FIG. 3A, FIG. 3B, and FIG. 3C as graphs of theoretical capacity-charge voltage.

It is found from the calculation results shown in FIG. 3A, FIG. 3B, and FIG. 3C that the charge voltage increases in the order of LiFePO₄<LiMnPO₄<LiNiPO₄. Furthermore, the charge voltage tends to be larger in LiFePO₄ where part of Fe is replaced with Mn than in LiFePO₄, and that the charge voltage tends to be larger in LiFePO₄ where part of Fe is replaced with Ni than in LiFePO₄ where part of Fe is replaced with Mn.

### [Calculation 2 On Composite]

Lattice distortion at the interface between the first material 100x and the second material 100y in the composite where the particle surface of the first material 100x is covered with the second material 100y is examined by first-principles calculation.

Here, calculation is performed on a structure (hereinafter referred to as NCM-LFP bonding) where the first material 100x is LiNi_{8/10}Co_{1/10}Mn_{1/10}O₂ (Ni:Co:Mn=8:1:1) and the second material 100y is LiFePO₄. In the structure, the (001) plane of LiFePO₄ is bonded to the (104) plane of LiNi_{8/10}Co_{1/10}Mn_{1/10}O₂. In the particle, the molar ratio is set to approximately LiNi_{8/10}Co_{1/10}Mn_{1/10}O₂:LiFePO₄=9:1.

In addition, a LiNi_{8/10}Co_{1/10}Mn_{1/10}O₂ particle alone (hereinafter referred to as NCM alone) and a LiFePO₄ particle alone (hereinafter referred to as LFP alone) are each examined.

In addition, a case where a LiNi_{8/10}Co_{1/10}Mn_{1/10}O₂ particle and a LiFePO₄ particle are not bonded to but mixed with each other (hereinafter referred to as an NCM-LFP mix) is also examined. For the mixed particles, the molar ratio is set to approximately LiNi_{8/10}Co_{1/10}Mn_{1/10}O₂:LiFePO₄=9:1.

First, optimization calculation is performed using density functional theory (DFT). The main calculation conditions are listed in Table 2. The number of atoms used for the calculation is as follows: 116 Li atoms, 82 Ni atoms, 11 Co atoms, 11 Mn atoms, 12 Fe atoms, 12 P atoms, and 256 O atoms are used for the NCM-LFP bonding. For the NCM alone, 60 Li atoms, 48 Ni atoms, 6 Co atoms, 6 Mn atoms, and 120 O atoms are used. For the LFP alone, 32 Li atoms, 32 Fe atoms, 32 P atoms, and 128 O atoms are used.

TABLE 2

| Software | VASP | |
|---|---|---|
| Functional | GGA + U (DFT-D2) | |
| Pseudo potential | PAW | |
| Cut-off energy (eV) | 600 | |
| U potential | Mn | 4.64 |
| | Fe | 4.90 |
| | Co | 4.91 |
| | Ni | 5.26 |

| | |
|---|---|
| k-points | 1 × 1 × 1 |
| Calculation target | Lattices and atomic positions are optimized |

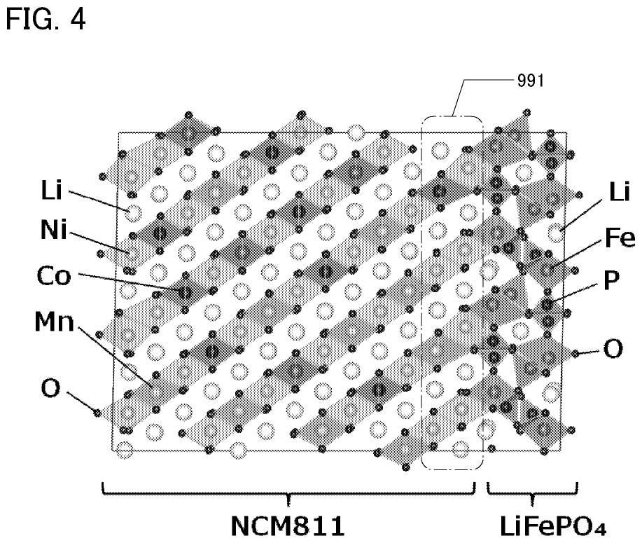

FIG. 4 shows the state of the bonding interface after optimization calculation. The bonding with LiFePO₄ in the vicinity of the bonding interface causes distortion in the structure of LiNi_{8/10}Co_{1/10}Mn_{1/10}O₂ as shown in a region 991 in FIG. 4.

Next, a potential difference between before and after extraction of a lithium atom (corresponding to a potential difference at the time of charging) is calculated for the optimized structure. Note that for the NCM-LFP mix, the potential different in the NCM alone and the potential difference in the LFP alone are multiplied together.

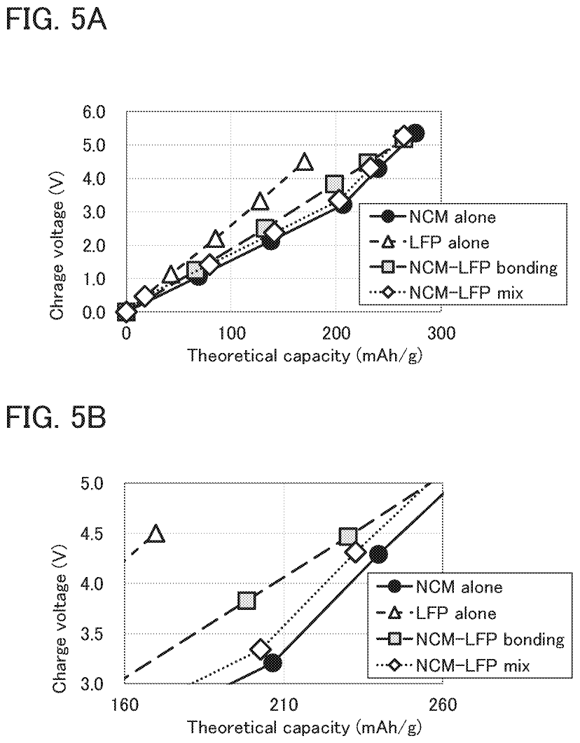

FIG. 5A shows the relationship between theoretical capacity and charge voltage, which is obtained by the calculation. FIG. 5B is an enlarged view of part of the graph of FIG. 5A.

In the structure where LiFePO₄ is bonded to the surface of LiNi_{8/10}Co_{1/10}Mn_{1/10}O₂ (Ni:Co:Mn=8:1:1), the charge voltage changes linearly with respect to the capacity. This is probably because the structure of LiNi_{8/10}Co_{1/10}Mn_{1/10}O₂ is distorted as described with reference to FIG. 4, and the interaction between a nickel atom and a cobalt atom is weakened.

### [Positive Electrode Active Material]

As the first material 100x, a composite oxide represented by LiM1O₂ (M1 is one or more selected from Fe, Ni, Co, Mn, and Al) and having a layered rock-salt crystal structure can be used. Alternatively, as the first material 100x, a composite oxide that is represented by LiM1O₂ and to which the additive element X is added can be used. As the additive element X included in the first material 100x, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used. These elements further stabilize the crystal structure of the first material 100x in some cases. That is, the first material 100x can include lithium cobalt oxide to which magnesium and fluorine are added, lithium cobalt oxide to which magnesium, fluorine, aluminum, and nickel are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-cobalt-manganese oxide to which magnesium and fluorine are added, or the like. Here, as for the proportions of the transition metals of the lithium nickel-cobalt-manganese oxide, the proportion of nickel is preferably high; e.g., a material with an atomic ratio of nickel:cobalt:manganese=8:1:1 or nickel:cobalt:manganese=9:0.5:0.5 is preferred. A lithium nickel-cobalt-manganese oxide to which calcium is added is preferably included as the above-described lithium nickel-cobalt-manganese oxide.

Alternatively, as the first material 100x, a material in which secondary particles of the composite oxide represented by LiM1O₂ (M1 is one or more selected from Fe, Ni, Co, Mn, and Al) are coated with a metal oxide may be used. As the metal oxide, an oxide of one or more metals selected from Al, Ti, Nb, Zr, La, and Li can be used. For example, a metal-oxide-coated composite oxide in which secondary particles of the composite oxide represented by LiM1O₂ (M1 is one or more selected from Fe, Ni, Co, Mn, and Al) are coated with an aluminum oxide can be used as the first material 100x. For example, a metal-oxide-coated composite oxide in which secondary particles of lithium nickel-cobalt-manganese oxide with an atomic ratio of nickel:cobalt:manganese=8:1:1 or nickel:cobalt:manganese=9:0.5:0.5 are coated with an aluminum oxide can be used. Here, the thickness of the coating layer is preferably small, for example, greater than or equal to 1 nm and less than or equal to 200 nm, further preferably greater than or equal to 1 nm and less than or equal to 100 nm. A lithium nickel-cobalt-manganese oxide to which calcium is added is preferably included as the above-described lithium nickel-cobalt-manganese oxide.

As the method of forming the first material 100x, any of formation methods in Embodiments 3 and 4 described later can be used.

As the second material 100y, one or more of an oxide and LiM2PO₄ (M2 is one or more selected from Fe, Ni, Co, and Mn) having an olivine crystal structure can be used (also referred to as a composite oxide having an olivine crystal structure (containing one or more selected from Fe, Ni, Co, and Mn)). Examples of the oxide include aluminum oxide, zirconium oxide, hafnium oxide, and niobium oxide. Examples of LiM2PO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e+1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1). In addition, a carbon coating layer may be provided on the particle surface of the second material 100y. As a method for forming LiM2PO₄ (M2 is one or more selected from Fe, Ni, Co, and Mn) having an olivine crystal structure, a formation method described in Embodiment 5 below can be used.

### [Composite]

In this embodiment, the method 1 for forming a composite is described above as an example of a method for forming a composite in which at least part of the particle surface of the particulate first material 100x functioning as a positive electrode active material is covered with the second material 100y. For the composite including a positive electrode active material, a structure where at least part of the particle surface of the particulate first material 100x is covered with the second material 100y is preferred, and a structure where substantially the entire particle surface of the particulate first material 100x is covered with the second material 100y is further preferred. Here, the state where substantially the entire particle surface is covered refers to a state where the particulate first material 100x is not directly in contact with the electrolyte.

In the state where at least part of the particle surface, desirably, substantially the entire particle surface of the particulate first material 100x functioning as a positive electrode active material is covered with the second material 100y, a region where the first material 100x is directly in contact with the electrolyte is small. This can inhibit release of a transition metal element and/or oxygen from the first material 100x in a high-voltage charged state to inhibit a capacity reduction due to repeated charging and discharging. As effects obtained by covering with the second material 100y that has a stable crystal structure even in a high-voltage charge state, an improvement in stability at high temperatures, an improvement in fire resistance, and the like can be achieved in a secondary battery using the composite including the positive electrode active material of one embodiment of the present invention.

In particular, the use of the material having excellent stability in a high-voltage charged state as the first material 100x allows the composite to have further improved durability and further improved stability in a high-voltage charged state. In addition, the secondary battery including the composite can have further improved heat resistance and/or fire resistance.

As the material having excellent stability in a high-voltage charge state, a lithium cobalt oxide to which magnesium and fluorine are added or a lithium cobalt oxide to which magnesium, fluorine, aluminum, and nickel are added is preferably used. Moreover, as the material having excellent stability in a high-voltage charge state, a metal-oxide-coated composite oxide in which secondary particles of lithium nickel-cobalt-manganese oxide are coated with an aluminum oxide, or the like is preferably used. The lithium nickel-cobalt-manganese oxide can have an atomic ratio of nickel:cobalt:manganese=8:1:1, nickel:cobalt:manganese=9:0.5:0.5, or the like.

The lithium cobalt oxide to which magnesium, fluorine, aluminum, and nickel are added exhibits remarkably excellent repetitive charge and discharge characteristics at a high voltage when initial heating described later is performed, and thus is a material particularly preferred as the first material 100x.

As the second material that covers at least part of the particle surface, desirably, substantially the entire particle surface of the particulate first material 100x functioning as a positive electrode active material, one or more of an oxide and LiM2PO₄ (M2 is one or more selected from Fe, Ni, Co, and Mn) can be used. Examples of the oxide include an aluminum oxide, a zirconium oxide, a hafnium oxide, and a niobium oxide. Examples of LiM2PO₄ (M2 is one or more selected from, Fe, Ni, Co, and Mn) include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b><1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

In the state where substantially the entire particle surface of the particulate first material 100x functioning as a positive electrode active material is covered with the second material 100y, there is a possibility that the obtained charge and discharge characteristics differ from those in the case where the first material 100x and the second material 100y are simply mixed.

Note that the positive electrode of the present invention may have a structure where at least part of the surface of the composite including the positive electrode active material is covered with a graphene compound. It is preferable that 80% or more of the particle surface of the composite including the positive electrode active material and/or 80% or more of an aggregate including the composite be covered with a graphene compound. The graphene compound will be described later.

### [Method 1 for Forming Positive Electrode]

An example of a method for forming a positive electrode active material of one embodiment of the present invention will be described with reference to FIG. 6A and FIG. 6B.

A binder 110 is prepared in Step S101 of FIG. 6A, and a dispersion medium 120 is prepared in Step S102.

As the binder 110, for example, one kind or two or more kinds of materials such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose can be used.

Polyimide has extremely excellent thermal, mechanical, and chemical stability. In the case of using polyimide as a binder, a dehydration reaction and a cyclization (imidizing) reaction are performed. These reactions can be performed by heat treatment, for example. In an electrode of one embodiment of the present invention, when graphene including a functional group containing oxygen and polyimide are used as the graphene compound and the binder, respectively, the graphene compound can also be reduced by the heat treatment, leading to simplification of the process. Because of high heat-resistance, heat treatment can be performed at a heat temperature of 200° C. or higher. The heat treatment at a heat temperature of 200° C. or higher allows the graphene compound to be reduced sufficiently and the conductivity of the electrode to increase.

A fluorine polymer which is a high molecular material containing fluorine, specifically, polyvinylidene fluoride (PVDF) can be used, for example. PVDF is a resin having a melting point in the range of higher than or equal to 134° C. and lower than or equal to 169° C., and is a material with excellent thermal stability.

As the binder, a rubber material such as styrene-butadiene rubber (SBR), styrene-isoprene-styrene rubber, acrylonitrile-butadiene rubber, butadiene rubber, or an ethylene-propylene-diene copolymer can be used. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such water-soluble polymers be used in combination with any of the above rubber materials.

Two or more of the above-described materials may be used in combination for the binder.

For example, one of water, methanol, ethanol, acetone, tetrahydrofuran (THF), dimethylformamide (DMF), N-methylpyrrolidone (NMP), and dimethyl sulfoxide (DMSO), or a mixed solution of two or more of the above can be used as the dispersion medium 120.

A combination of polyvinylidene fluoride (PVDF) and N-methylpyrrolidone (NMP) is preferably used as the combination of the binder 110 and the dispersion medium 120.

Next, the binder 110 and the dispersion medium 120 are mixed in Step S103 to obtain a binder mixture 1001 of Step S104. As a mixing means, for example, a propeller mixer, a planetary mixer, or a thin-film spin mixer can be used. In the binder mixture 1001, the binder 110 is preferably dispersed well in the dispersion medium 120.

The binder mixture 1001 is prepared in Step S111 of FIG. 6B, and a conductive additive 1002 is prepared in Step S112. In order to knead the mixture stiffly in a later step, the amount of the binder mixture 1001 prepared in Step S111 is set to be smaller than the total amount of the binder mixture 1001 required for forming a positive electrode active material layer to achieve a suitable mixing amount for kneading. In this case, an additional binder mixture 1001 is preferably added in a step after the kneading for a shortage of the binder mixture 1001. Note that kneading means mixing something until it has a high viscosity.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive additive 1002.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group containing oxygen. The graphene compound preferably has a bent shape. A graphene compound may be rounded like a carbon nanofiber.

In this specification and the like, for example, graphene oxide contains carbon and oxygen, has a sheet-like shape, and has a functional group, in particular, an epoxy group, a carboxy group, or a hydroxy group.

In this specification and the like, for example, reduced graphene oxide contains carbon and oxygen, has a sheet-like shape, and has a two-dimensional structure formed of a six-membered ring composed of carbon atoms. A graphene compound may also be referred to as a carbon sheet. The reduced graphene oxide functions by itself and may have a stacked-layer structure. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive agent with high conductivity even with a small amount. In addition, the intensity ratio G/D of a G band to a D band of the Raman spectrum of the reduced oxide graphene oxide is preferably 1 or more. The reduced graphene oxide with such an intensity ratio can function as a conductive agent with high conductivity even with a small amount.

A graphene compound can sometimes be provided with pores by reduction of graphene oxide.

A material obtained by terminating an end portion of graphene with fluorine may be used.

In the longitudinal cross section of the active material layer, the sheet-like graphene compounds are dispersed substantially uniformly in a region inside the active material layer. The plurality of graphene compounds are formed to partly cover a plurality of particulate active materials or adhere to the surfaces of the plurality of particulate active materials, so that the graphene compounds make surface contact with the particulate active materials.

Here, the plurality of graphene compounds can be bonded to each other to form a net-like graphene compound sheet (hereinafter, referred to as a graphene compound net or a graphene net). A graphene net that covers the active material can function as a binder for bonding the active materials. Accordingly, the amount of the binder can be reduced, or the binder does not have to be used. This can increase the proportion of the active material in the electrode volume and the electrode weight. That is, the charge and discharge capacity of the secondary battery can be increased.

Here, it is preferable to perform reduction after a layer to be the active material layer is formed in such a manner that graphene oxide is used as the graphene compound and mixed with an active material. That is, the formed active material layer preferably contains reduced graphene oxide. When graphene oxide with extremely high dispersibility in a polar solvent is used to form the graphene compounds, the graphene compounds can be substantially uniformly dispersed in a region inside the active material layer. The solvent is removed by volatilization from a dispersion medium containing the uniformly dispersed graphene oxide to reduce the graphene oxide; hence, the graphene compounds remaining in the active material layer partly overlap with each other and are dispersed such that surface contact is made, thereby forming a three-dimensional conductive path. Note that graphene oxide may be reduced by heat treatment or with use of a reducing agent, for example.

It is possible to form, with a spray dry apparatus, a graphene compound serving as a conductive agent as a coating film to cover the entire surface of the active material in advance and to electrically connect the active materials by the graphene compound to form a conductive path.

A material used in formation of the graphene compound may be mixed with the graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The D50 of the particles is preferably less than or equal to 1 μm, further preferably less than or equal to 100 nm.

The graphene compound preferably includes a vacancy in part of a carbon sheet. In the graphene compound, a vacancy through which carrier ions such as lithium ions can pass is provided in part of a carbon sheet, which can facilitate insertion and extraction of carrier ions in the surface of an active material covered with the graphene compound to increase the rate characteristics of a secondary battery. The vacancy provided in part of the carbon sheet is referred to as a hole, a defect, or a gap in some cases.

Next, the binder mixture 1001 and the conductive additive 1002 are mixed in Step S113 to obtain a mixture 1010 of Step S121. As a mixing means, for example, a propeller mixer, a planetary mixer, or a thin-film spin mixer can be used.

Next, the composite 100z including the positive electrode active material is prepared in Step S122 of FIG. 6B.

Next, the mixture 1010 and the composite 100z including the positive electrode active material are mixed in Step S123 to obtain a mixture 1020 of Step S131. As a mixing means, for example, a propeller mixer, a planetary mixer, or a thin-film spin mixer can be used. In the case where the viscosity is appropriately adjusted in the mixing in Step S123, it is possible to separate an aggregation of a powder of the positive electrode active material or the like by kneading.

Next, the binder mixture 1001 is prepared in Step S132, and a disperse medium 1003 is prepared in Step S133. In the case where the amount of the binder mixture 1001 prepared in Step S111 is smaller than the total amount required for forming the positive electrode active material layer, an additional binder mixture 1001 can be added in Step S132 for a shortage of the binder mixture 1001. In the case where the total amount of the binder mixture 1001 required for forming the positive electrode active material layer is prepared in Step S111, it is unnecessary to prepare the binder mixture 1001 in Step S132. A disperse medium similar to that in Step S102 of FIG. 6A can be used as the disperse medium 1003. It is desirable to adjust the amount of the disperse medium 1003 to be prepared so that the viscosity is appropriate for application in a later step.

Next, in Step S134, the mixture 1020 of Step S131 and the disperse medium 1003 are mixed with the binder mixture 1001 prepared in Step S132 to obtain a mixture 1030 of Step S135. The mixture 1030 is sometimes referred to as positive electrode slurry.

Next, the mixture 1030 is applied to a current collector in Step S136. The current collector can be formed using a material that has high conductivity, such as a metal like stainless steel, gold, platinum, aluminum, or titanium, or an alloy thereof. It is preferable that a material used for the positive electrode current collector not be dissolved at the potential of the positive electrode. Any of materials described in Embodiment 6 may be used as the material used for the current collector. For the application method in Step S136, a slot die method, a gravure method, a blade method, or a combination of any of them can be used, for example. Furthermore, a continuous coater or the like may be used for the application. Subsequent to Step S136, the mixture 1030 applied to the current collector is dried in Step S137. As the drying method, for example, a batch-type method using a hot plate, a drying furnace, a circulation drying furnace, a vacuum drying furnace, or the like, or a sequential-type method using a combination of warm-air drying, infrared drying, or the like with a continuous coater can be used.

Through the above steps, a positive electrode 2000 of one embodiment of the present invention can be formed (Step S140).

This embodiment can be implemented in appropriate combination with the other embodiments.

### Embodiment 2

In this embodiment, a method for forming a positive electrode of one embodiment of the present invention will be described.

The positive electrode includes a positive electrode active material layer and a positive electrode current collector. The positive electrode active material layer may include the first material 100x functioning as a positive electrode active material and the second material 100y, and may further include a conductive additive and a binder.

As a material that can be used as the first material 100x, any of the above-described materials and the materials described in Embodiment 3 and Embodiment 4 can be used. As a material that can be used as the second material 100y, any of the above-described materials and the materials described in Embodiment 5 can be used.

In this embodiment, a method 2 for forming a positive electrode, a method 3 for forming a positive electrode, and a method 4 for forming a positive electrode will be described as examples of a method for forming a positive electrode including the first material 100x and the second material 100y. As a desirable form of the positive electrode, it is desirable that the first material 100x and the second material 100y be dispersed favorably in the positive electrode active material layer and a favorable conductive network be included. For example, the amount of a conductive additive in contact with one of the first material 100x and the second material 100y, which is a positive electrode active material having lower electron conductivity, is desirably larger than the amount of a conductive additive in contact with the other thereof. Here, the amount of the conductive additive in contact with the positive electrode active material can be regarded as the coverage of the particle surface of the positive electrode active material with the conductive additive, and can be measured by surface SEM observation, cross-sectional SEM observation, or cross-sectional TEM observation, for example.

In the case where LiM1O₂ (M1 is one or more selected from Fe, Ni, Co, Mn, and Al) is described as the first material 100x above and LiM2PO₄ (M2 is one or more selected from, Fe, Ni, Co, and Mn) is described as the second material 100y above at the time of mixing the first material 100x and the second material 100y for the positive electrode of one embodiment of the present invention, as the mixing proportion of the second material 100y, which is highly stable at high temperatures and has a stable crystal structure even in a high-voltage charge state, is increased, the fire resistance and heat resistance of a secondary battery including the positive electrode of one embodiment of the present invention becomes higher. Note that even when the proportion of the second material 100y is reduced, e.g., the mixing ratio of the first material 100x: the second material 100y is 7:3, 8:2, or 9:1, there is a possibility that the secondary battery including the positive electrode of one embodiment of the present invention has fire resistance.

As the method 2 for forming a positive electrode, an example of a method for forming a positive electrode, which includes a formation step of mixing the first material 100x, the second material 100y, and a mixture of a conductive additive and a binder, is described. As the method 3 for forming a positive electrode, an example of a method for forming a positive electrode, which includes a first formation step of mixing the first material 100x and the second material 100y and a second formation step of mixing the mixture obtained in the first step and a mixture of a conductive additive and a binder, is described. As the method 4 for forming a positive electrode, an example of a method for forming a positive electrode, which includes a first formation step of mixing the second material 100y and a mixture of a conductive additive and a binder and a second formation step of mixing the mixture obtained in the first step and the first material 100x, is described. Note that the present invention should not be interpreted as being limited to those descriptions.

### [Method 2 for Forming Positive Electrode]

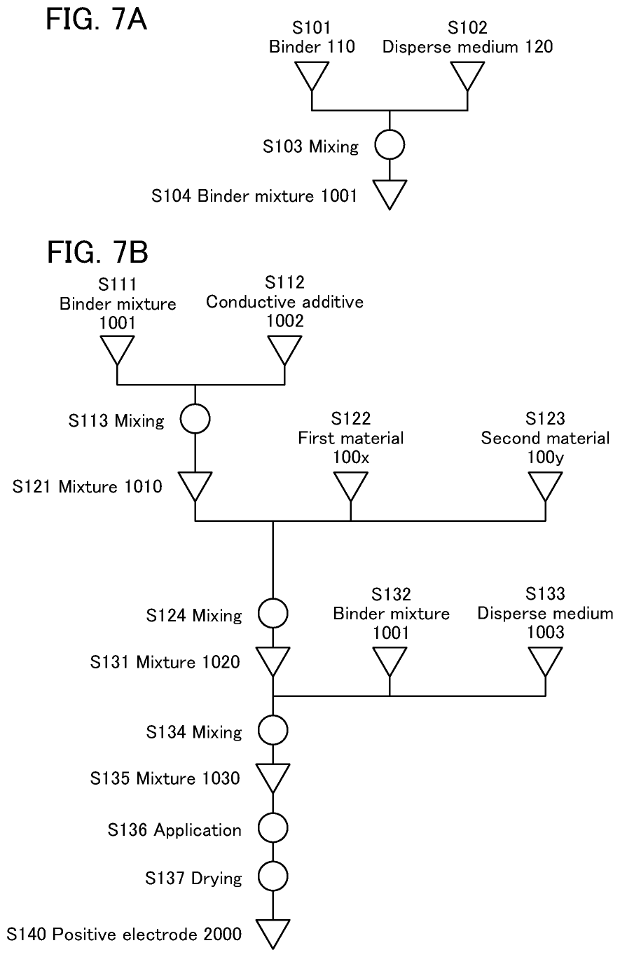

An example of a method for forming a positive electrode active material of one embodiment of the present invention will be described with reference to FIG. 7A and FIG. 7B.

The binder 110 is prepared in Step S101 of FIG. 7A, and the dispersion medium 120 is prepared in Step S102. The materials described in Embodiment 1 can be used for the binder 110 and the dispersion medium 120.

Next, the binder 110 and the dispersion medium 120 are mixed in Step S103 to obtain the binder mixture 1001 of Step S104. As a mixing means, for example, a propeller mixer, a planetary mixer, or a thin-film spin mixer can be used. In the binder mixture 1001, the binder 110 is preferably dispersed well in the dispersion medium 120.

The binder mixture 1001 is prepared in Step S111 of FIG. 7B, and the conductive additive 1002 is prepared in Step S112. In order to knead the mixture stiffly in a later step, the amount of the binder mixture 1001 prepared in Step S111 is set to be smaller than the total amount of the binder mixture 1001 required for forming a positive electrode active material layer to achieve a suitable mixing amount for kneading. In this case, an additional binder mixture 1001 is preferably added in a step after the kneading for a shortage of the binder mixture 1001. Note that kneading means mixing something until it has a high viscosity.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive additive 1002.

Next, the binder mixture 1001 and the conductive additive 1002 are mixed in Step S113 to obtain the mixture 1010 of Step S121. As a mixing means, for example, a propeller mixer, a planetary mixer, or a thin-film spin mixer can be used.

The first material 100x is prepared in Step S122 of FIG. 7B, and the second material 100y is prepared in Step S123.

For each of the first material 100x and the second material 100y, the material described in Embodiment 1 can be used.

Note that as a combination of the first material 100x and the second material 100y, it is possible to select a combination less likely to cause a step in a charge-discharge curve according to characteristics required for the secondary battery or select a combination causing a step in a charge-discharge curve in a desired charging rate.

Next, the mixture 1010, the first material 100x, and the second material 100y are mixed in Step S124 to obtain the mixture 1020 of Step S131. As a mixing means, for example, a propeller mixer, a planetary mixer, or a thin-film spin mixer can be used. In the case where the viscosity is appropriately adjusted in the mixing in Step S124, it is possible to separate an aggregation of a powder of the positive electrode active material or the like by kneading.

Next, the binder mixture 1001 is prepared in Step S132, and the disperse medium 1003 is prepared in Step S133. In the case where the amount of the binder mixture 1001 prepared in Step S111 is smaller than the total amount required for forming the positive electrode active material layer, an additional binder mixture 1001 can be added in Step S132 for a shortage of the binder mixture 1001. In the case where the total amount of the binder mixture 1001 required for forming the positive electrode active material layer is prepared in Step S111, it is unnecessary to prepare the binder mixture 1001 in Step S132. A disperse medium similar to that in Step S102 of FIG. 7A can be used as the disperse medium 1003. It is desirable to adjust the amount of the disperse medium 1003 to be prepared so that the viscosity is appropriate for application in a later step.

Next, in Step S134, the mixture 1020 of Step S131, the binder mixture 1001 prepared in Step S132, and the disperse medium 1003 prepared in Step S133 are mixed to obtain the mixture 1030 of Step S135. The mixture 1030 may be referred to as positive electrode slurry.

Next, the mixture 1030 is applied to a current collector in Step S136. For the current collector, any of the materials described in Embodiment 1 can be used. The application in Step S136 and drying in Step S137 can be performed in the same manner as Step S136 and Step S137 shown in FIG. 6.

Through the above steps, the positive electrode 2000 of one embodiment of the present invention can be formed (Step S140).

### [Method 3 for Forming Positive Electrode]

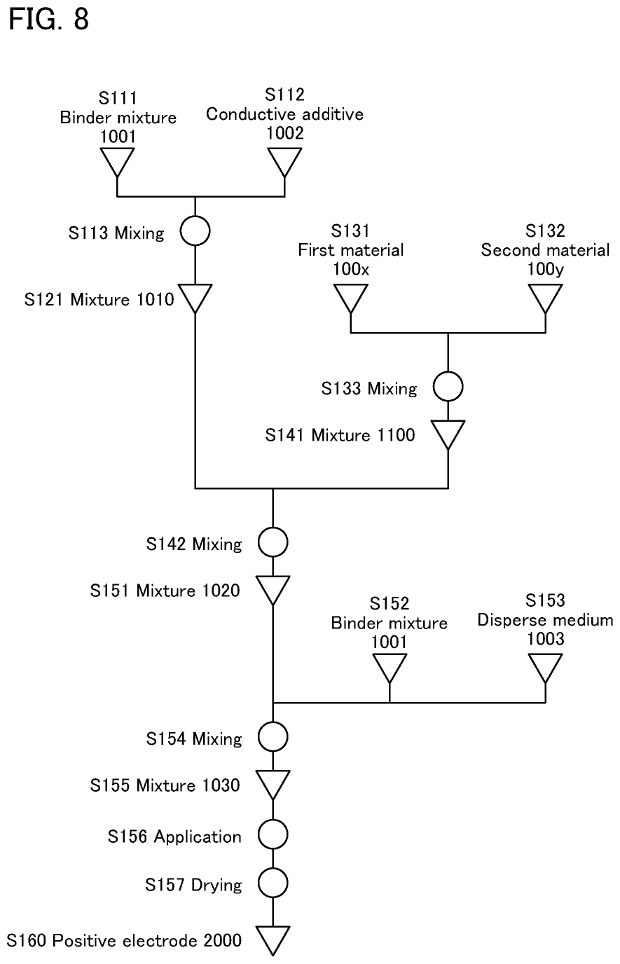

Another example of a method for forming a positive electrode active material of one embodiment of the present invention will be described with reference to FIG. 8.

The binder mixture 1001 is prepared in Step S111 of FIG. 8, and the conductive additive 1002 is prepared in Step S112. As the binder mixture 1001, the binder mixture 1001 shown in FIG. 7A can be used. In order to knead the mixture in a later step, the amount of the binder mixture 1001 prepared in Step S111 is set to be smaller than the total amount of the binder mixture 1001 required for forming a positive electrode active material layer to achieve a suitable mixing amount for kneading. In this case, an additional binder mixture 1001 is preferably added in a step after the kneading for a shortage of the binder mixture 1001. Note that kneading means mixing something until it has a high viscosity.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive additive 1002.

Next, the binder mixture 1001 and the conductive additive 1002 are mixed in Step S113 to obtain the mixture 1010 of Step S121. As a mixing means, for example, a propeller mixer, a planetary mixer, or a thin-film spin mixer can be used.

The first material 100x is prepared in Step S131 of FIG. 8, and the second material 100y is prepared in Step S132.

For each of the first material 100x and the second material 100y, the material described in Embodiment 1 can be used.

Note that as a combination of the first material 100x and the second material 100y, it is possible to select a combination less likely to cause a step in a charge-discharge curve according to characteristics required for the secondary battery or select a combination causing a step in a charge-discharge curve in a desired charging rate.

Next, the first material 100x and the second material 100y are mixed in Step S133 to obtain a mixture 1100 of Step S141. As a mixing means, for example, a ball mill, a propeller mixer, a planetary mixer, or a thin-film spin mixer can be used.

Next, the mixture 1010 of Step S121 and the mixture 1100 of Step S141 are mixed in Step S142 to obtain the mixture 1020 of Step S151. As a mixing means, for example, a propeller mixer, a planetary mixer, or a thin-film spin mixer can be used. In the case where the viscosity is appropriately adjusted in the mixing in Step S142, it is possible to separate an aggregation of a powder of the positive electrode active material or the like by kneading.

Next, the binder mixture 1001 is prepared in Step S152, and the disperse medium 1003 is prepared in Step S153. In the case where the amount of the binder mixture 1001 prepared in Step S111 is smaller than the total amount required for forming the positive electrode active material layer, an additional binder mixture 1001 can be added in Step S152 for a shortage of the binder mixture 1001. In the case where the total amount of the binder mixture 1001 required for forming the positive electrode active material layer is prepared in Step S111, it is unnecessary to prepare the binder mixture 1001 in Step S152. A disperse medium similar to that in Step S102 of FIG. 7A can be used as the disperse medium 1003. It is desirable to adjust the amount of the disperse medium 1003 to be prepared so that the viscosity is appropriate for application in a later step.

Next, in Step S154, the mixture 1020 of Step S151, the binder mixture 1001 prepared in Step S152, and the disperse medium 1003 prepared in Step S153 are mixed to obtain the mixture 1030 of Step S155. The mixture 1030 is sometimes referred to as positive electrode slurry.

Next, the mixture 1030 is applied to a current collector in Step S156. For the current collector, any of the materials described in Embodiment 1 can be used. The application in Step S156 and drying in Step S157 can be performed in the same manner as Step S136 and Step S137 shown in FIG. 6.

Through the above steps, the positive electrode 2000 of one embodiment of the present invention can be formed (Step S160).

### [Method 4 for Forming Positive Electrode]

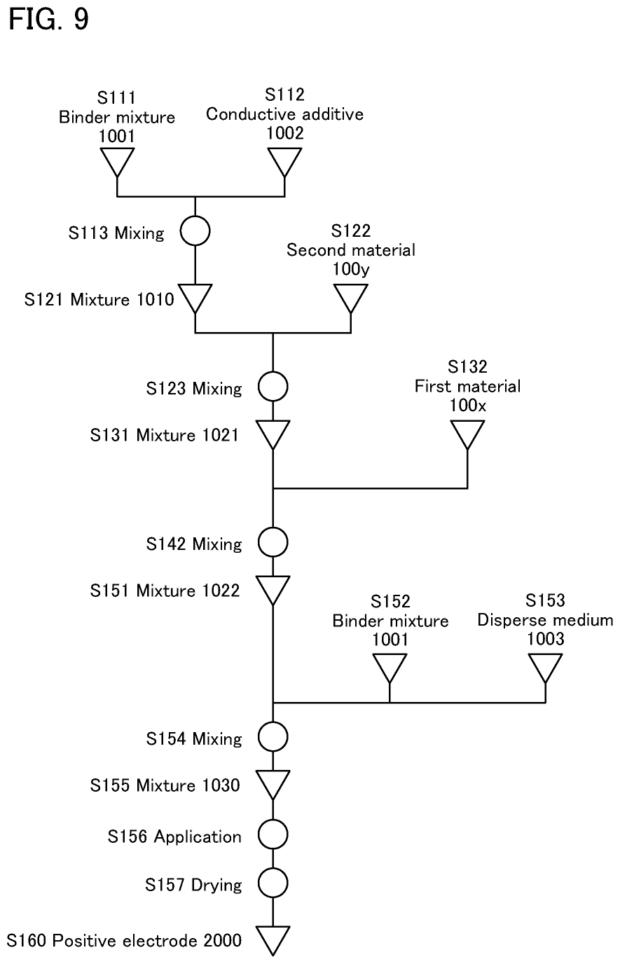

Another example of a method for forming a positive electrode active material of one embodiment of the present invention will be described with reference to FIG. 9.

The binder mixture 1001 is prepared in Step S111 of FIG. 9, and the conductive additive 1002 is prepared in Step S112. As the binder mixture 1001, the binder mixture 1001 shown in FIG. 7A can be used. In order to knead the mixture in a later step, the amount of the binder mixture 1001 prepared in Step S111 is set to be smaller than the total amount of the binder mixture 1001 required for forming a positive electrode active material layer to achieve a suitable mixing amount for kneading. In this case, for a shortage of the binder mixture 1001, an additional binder mixture 1001 is preferably added in a step after the kneading. Note that kneading means mixing something until it has a high viscosity.

For example, one kind or two or more kinds of carbon black such as acetylene black and furnace black, graphite such as artificial graphite and natural graphite, carbon fiber such as carbon nanofiber and carbon nanotube, and a graphene compound can be used as the conductive additive 1002.

Next, the binder mixture 1001 and the conductive additive 1002 are mixed in Step S113 to obtain the mixture 1010 of Step S121. As a mixing means, for example, a propeller mixer, a planetary mixer, or a thin-film spin mixer can be used.

Next, the second material 100y is prepared in Step S122 of FIG. 9.

As the second material 100y, LiM2PO₄ (M2 is one or more selected from Fe, Ni, Co, and Mn) that is formed by a formation method described in Embodiment 5 below and has an olivine crystal structure can be used. The above-described material, e.g., LiFePO₄, LiMnPO₄, LiFeₐMn_{b}PO₄ (a+b≤1, 0<a<1, 0<b<1), or LiFₐNi_{b}PO₄ (a+b≤1, 0<a<1, 0<b<1) can be used as LiM2PO₄. In addition, a carbon coating layer may be provided on the particle surface of the second material 100y.

Next, the mixture 1010 and the second material 100y are mixed in Step S123 to obtain a mixture 1021 of Step S131. As a mixing means, for example, a propeller mixer, a planetary mixer, or a thin-film spin mixer can be used. In the case where the viscosity is appropriately adjusted in the mixing in Step S123, it is possible to separate an aggregation of a powder of the positive electrode active material or the like by kneading.

In the case where the second material 100y has lower electron conductivity than the first material 100x in the formation process of the positive electrode including the first material 100x and the second material 100y, it is desirable that the second material 100y and a conductive additive be mixed before a step of mixing the first material 100x. This makes it possible to obtain a structure in which the amount of the conductive additive in contact with the second material 100y is larger than the amount of the conductive additive in contact with the first material 100x.

Next, the first material 100x is prepared in Step S132.

For each of the first material 100x and the second material 100y, the material described in Embodiment 1 can be used.

Note that as a combination of the first material 100x and the second material 100y, it is possible to select a combination less likely to cause a step in a charge-discharge curve according to characteristics required for the secondary battery or select a combination causing a step in a charge-discharge curve in a desired charging rate

Next, the mixture 1021 and the first material 100x are mixed in Step S142 to obtain a mixture 1022 of Step S151. As a mixing means, for example, a propeller mixer, a planetary mixer, or a thin-film spin mixer can be used. In the case where the viscosity is appropriately adjusted in the mixing in Step S142, it is possible to separate an aggregation of a powder of the positive electrode active material or the like by kneading.

Next, the binder mixture 1001 is prepared in Step S152, and the disperse medium 1003 is prepared in Step S153. In the case where the amount of the binder mixture 1001 prepared in Step S111 is smaller than the total amount required for forming the positive electrode active material layer, an additional binder mixture 1001 can be added in Step S152 for a shortage of the binder mixture 1001. In the case where the total amount of the binder mixture 1001 required for forming the positive electrode active material layer is prepared in Step S111, it is unnecessary to prepare the binder mixture 1001 in Step S152. A disperse medium similar to that in Step S102 of FIG. 7A can be used as the disperse medium 1003. It is desirable to adjust the amount of the disperse medium 1003 to be prepared so that the viscosity is appropriate for application in a later step.

Next, in Step S154, the mixture 1022 of Step S151, the binder mixture 1001 prepared in Step S152, and the disperse medium 1003 prepared in Step S153 are mixed to obtain the mixture 1030 of Step S155. The mixture 1030 is sometimes referred to as positive electrode slurry.

Next, the mixture 1030 is applied to a current collector in Step S156. For the current collector, any of the materials described in Embodiment 1 can be used. The application in Step S156 and drying in Step S157 can be performed in the same manner as Step S136 and Step S137 shown in FIG. 6.

Through the above steps, the positive electrode 2000 of one embodiment of the present invention can be formed (Step S160).

This embodiment can be implemented in appropriate combination with the other embodiments.

### Embodiment 3

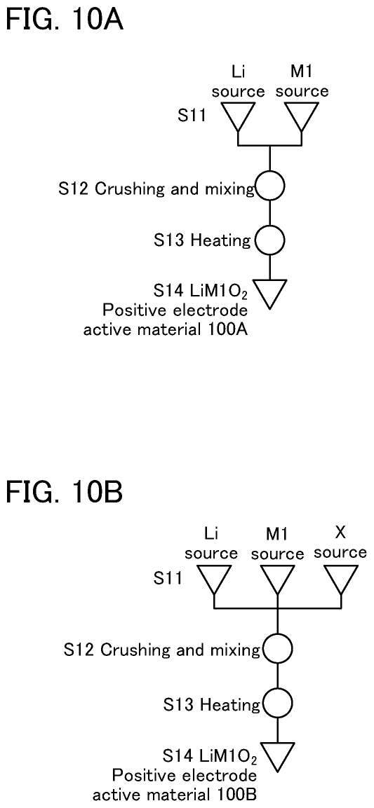

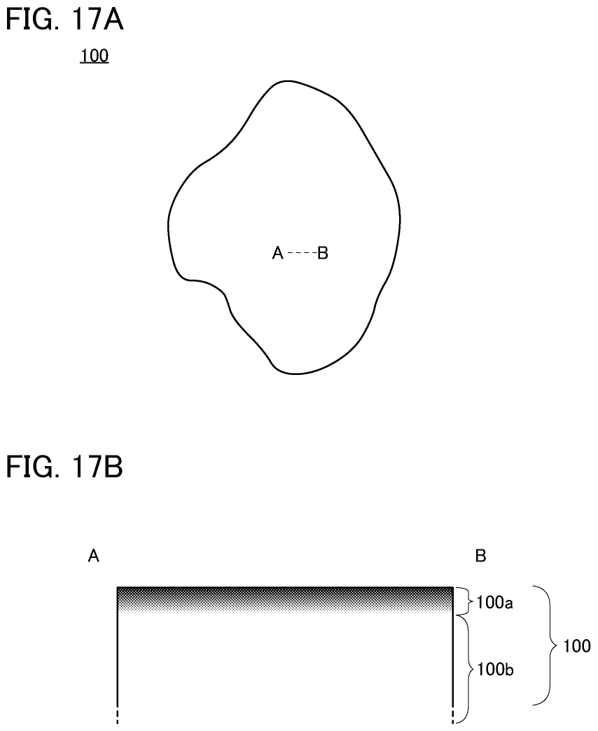

In this embodiment, an example of a method for forming a positive electrode active material of one embodiment of the present invention will be described with reference to FIG. 10A to FIG. 16C. Furthermore, a positive electrode active material of one embodiment of the present invention will be described with reference to FIG. 17A to FIG. 25C.

### [Method 1 for Forming Positive Electrode Active Material]

An example of a method for forming a positive electrode active material of one embodiment of the present invention will be described below with reference to FIG. 10A and FIG. 10B.

### <Step S11>

In Step S11 of FIG. 10A, a lithium source and a transition metal source are prepared as materials of lithium and transition metal. Note that the transition metal source is expressed as an M1 source in the drawings.

As the lithium source, for example, lithium carbonate, lithium fluoride, or the like can be used.

As the transition metal source, at least one of manganese, cobalt, and nickel can be used, for example. As the transition metal source, for example, cobalt alone; nickel alone; two metals of cobalt and manganese; two metals of cobalt and nickel; or three metals of cobalt, manganese, and nickel may be used.

For the transition metal source used in synthesis, a high-purity material is preferably used. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a secondary battery and/or increase the reliability of a secondary battery.

In addition, it is preferable that the transition metal source at this time have high crystallinity. For example, the transition metal source preferably includes single crystal grains. To evaluate the crystallinity of the transition metal source, for example, the crystallinity can be judged by a TEM (transmission electron microscope) image, an STEM (scanning transmission electron microscope) image, a HAADF-STEM (high-angle annular dark field scanning transmission electron microscope) image, an ABF-STEM (annular bright-field scan transmission electron microscope) image, and the like. For evaluation of the crystallinity of the transition metal source, X-ray diffraction (XRD), electron diffraction, neutron diffraction, and the like can also be used for judging. Note that the above-described crystallinity evaluation can be applied not only to the transition metal source but also to a primary particle or a secondary particle.

When metals that can form a layered rock-salt composite oxide are used, cobalt, manganese, and nickel are preferably mixed at the ratio at which the composite oxide can have a layered rock-salt crystal structure. In addition, an additive element X may be added to these transition metals as long as a layered rock-salt crystal structure can be obtained. FIG. 10B shows an example of a process of adding the additive element X. The lithium source, the transition metal source, and an additive element X source are prepared in Step S11, and then Step S12 is performed.

For the additive element X source, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. In addition to the above elements, bromine and beryllium may be used for the additive element X source. Note that the additive element X source given earlier is more suitable because bromine and beryllium are elements having toxicity to living things.

As the transition metal source, an oxide or a hydroxide of the metal described as an example of the transition metal, or the like can be used. As a cobalt source, for example, cobalt oxide, cobalt hydroxide, or the like can be used.

As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

### <Step S12>

Next, in Step S12, the lithium source and the transition metal source are crushed and mixed. The crushing and mixing can be performed by a dry process or a wet process. It is particularly preferable to perform crushing with the use of dehydrated acetone at a purity of 99.5% or higher with a reduced moisture content of 10 ppm or lower. Note that in this specification and the like, the term “crushing” can be replaced with “grinding”. For the mixing, a ball mill, a bead mill, or the like can be used, for example. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. Note that Step S12 is performed at a peripheral speed of 838 mm/s (the number of rotations: 400 rpm, the diameter of a ball mill container: 40 mm). The use of the dehydrated acetone in crushing and mixing can reduce impurities that might be mixed into the material.

### <Step S13>

Next, in Step S13, the materials mixed in the above manner are heated. The heating temperature of this step is preferably higher than or equal to 800° C. and lower than 1100° C., further preferably higher than or equal to 900° C. and lower than or equal to 1000° C., still further preferably approximately 950° C. An excessively low temperature might lead to insufficient decomposition and melting of the lithium source and the transition metal source. In contrast, an excessively high temperature might lead to a defect due to evaporation of lithium from the lithium source and/or excessive reduction of the metal used as the transition metal source, for example. The use of cobalt as the transition metal, for example, may lead to a defect in which cobalt has divalence.

The heating time can be longer than or equal to 1 hour and shorter than or equal to 100 hours, for example, and is preferably longer than or equal to 2 hours and shorter than or equal to 20 hours. The heating is preferably performed in an atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 1000° C. for 10 hours, the temperature rise is preferably 200° C./h and the flow rate of a dry air is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S13 is not essential.

Note that a crucible or a saggar used at the time of heating in Step S13 is preferably made of alumina (aluminum oxide), mullite cordierite, magnesia, or zirconia, i.e., preferably includes a highly heat resistant material. An alumina crucible is preferable because it is a material into which impurities do not enter. In this embodiment, a crucible made of alumina with a purity of 99.9% is preferably used. The heating is preferably performed with the crucible or the saggar covered with a lid. This can prevents volatilization of the materials.

It is suitable to collect the materials subjected to the heating in Step S13 after the materials are transferred from the crucible to a mortar because impurities are prevented from entering the materials. The mortar is suitably made of a material into which impurities do not enter. Specifically, it is suitable to use a mortar made of alumina with a purity of 90% or higher, preferably 99% or higher. Note that conditions equivalent to those in Step S13 can be employed in an after-mentioned heating step other than Step S13.

### <Step S14>

Through the above steps, a positive electrode active material 100A of one embodiment of the present invention can be formed in FIG. 10A, and a positive electrode active material 100B can be formed in FIG. 10B (Step S14). The positive electrode active material 100A and the positive electrode active material 100B can each be used as the first material 100x described in Embodiment 1 and Embodiment 2.

### [Method 2 for Forming Positive Electrode Active Material]

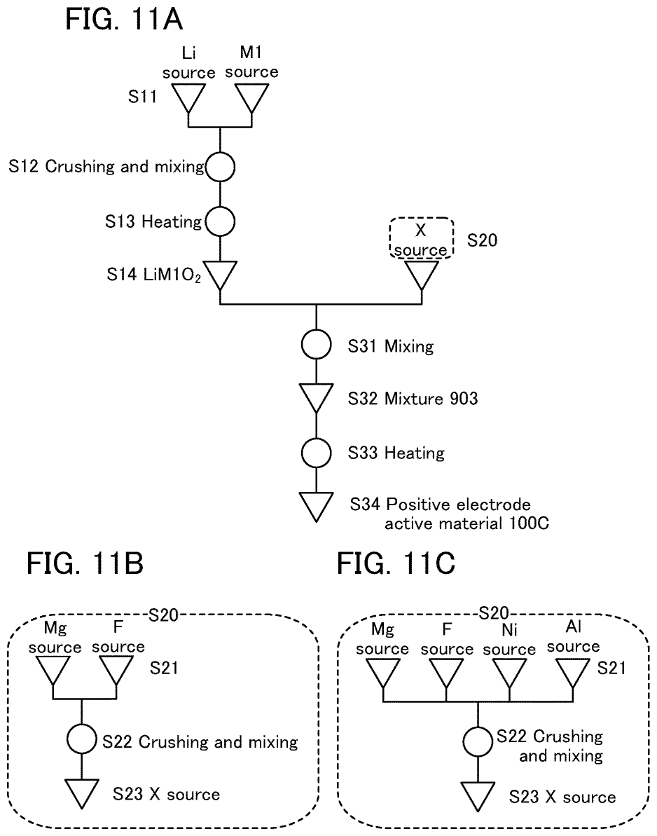

Next, another example of a method for forming a positive electrode active material of one embodiment of the present invention will be described with reference to FIG. 11A, FIG. 11B, and FIG. 11C.

In FIG. 11A, Steps S11 to S14 are performed in the same manner as those in FIG. 10A to prepare a composite oxide (LiM1O₂) containing lithium, a transition metal, and oxygen.

Note that a pre-synthesized composite oxide may be used in Step S14. In this case, Step S11 to Step S13 can be omitted. Note that in the case of preparing a pre-synthesized composite oxide, it is preferable that the material have high purity. The purity of the material is higher than or equal to 99.5%, preferably higher than or equal 99.9%, further preferably higher than or equal to 99.99%.

### <Step S20>

In Step S20 in FIG. 11A, an additive element X source is prepared. As the additive element X, any of the materials described above can be used. A plurality of elements may be used as the additive element X. The case of using a plurality of elements as the additive element X is described with reference to FIG. 11B and FIG. 11C.

<Step S21>

In Step S21 of FIG. 11B, a magnesium source (Mg source) and a fluorine source (F source) are prepared. In addition, a lithium source may be prepared together with the magnesium source and the fluorine source.

As the magnesium source, for example, magnesium fluoride, magnesium oxide, magnesium hydroxide, or magnesium carbonate can be used.

As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. The fluorine source is not limited to a solid, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. A plurality of fluorine sources may be mixed to be used. Among them, lithium fluoride, which has a relatively low melting point of 848° C., is preferable because it is easily melted in a heating step described later.

As the lithium source, for example, lithium fluoride or lithium carbonate can be used. That is, lithium fluoride can be used as both the lithium source and the fluorine source. In addition, magnesium fluoride can be used as both the fluorine source and the magnesium source.

In this embodiment, lithium fluoride LiF is prepared as the fluorine source, and magnesium fluoride MgF₂ is prepared as the fluorine source and the magnesium source.

When lithium fluoride LiF and magnesium fluoride MgF₂ are mixed at approximately LiF:MgF₂=65:35 (molar ratio), the effect of reducing the melting point becomes the highest (Non-Patent Document 4). On the other hand, when the amount of lithium fluoride increases, cycle performance might deteriorate because of too large an amount of lithium. Thus, the molar ratio of lithium fluoride LiF to magnesium fluoride MgF₂ is preferably LiF:MgF₂=x:1 (0≤x≤1.9), further preferably LiF:MgF₂=x:1 (0.1≤x<0.5), still further preferably LiF:MgF₂=x:1 (x=the vicinity of 0.33). Note that in this specification and the like, the vicinity means a value greater than 0.9 times and less than 1.1 times a certain value.

In the case where the next mixing and crushing step is performed by a wet process, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used.

### <Step S22>

Next, the above-described materials are mixed and crushed in Step S22 of FIG. 11B. Although the mixing can be performed by a dry process or a wet process, a wet process is preferable because the materials can be crushed to a smaller size. For example, a ball mill, a bead mill, or the like can be used for the mixing. When a ball mill is used, zirconia balls are preferably used as media, for example. Conditions of the ball mill, the bead mill, or the like are set to be the same as those in Step S12.

### <Step S23>

Next, the materials crushed and mixed in the above manner are collected in Step S23 to obtain the additive element X source. Note that the additive element X source shown in Step S23 may be referred to as a mixture because the additive element X source is made from a plurality of materials.

For example, the above-described mixture preferably has a D50 (median diameter) of greater than or equal to 600 nm and less than or equal to 20 μm, further preferably greater than or equal to 1 μm and less than or equal to 10 μm. When mixed with a composite oxide containing lithium, a transition metal, and oxygen in the later step, the mixture pulverized to such a small size is easily attached to the surfaces of composite oxide particles uniformly. The mixture is preferably attached to the surfaces of composite oxide particles uniformly because both halogen and magnesium are easily distributed to the vicinity of the surfaces of the composite oxide particles after heating. When there is a region containing neither halogen nor magnesium in the vicinity of the surfaces, an O3′ type crystal structure, which is described later, is less likely to be formed in a charged state.

Although the method of mixing two kinds of materials is described as an example in Step S21 of FIG. 11B, the method is not limited thereto. For example, as shown in FIG. 11C, four kinds of materials (a magnesium source (Mg source), a fluorine source (F source), a nickel source (Ni source), and an aluminum source (Al source)) may be mixed to prepare the additive element X source. Alternatively, a single material, i.e., one kind of material may be used to prepare the additive element X source. Note that as the nickel source, nickel oxide, nickel hydroxide, or the like can be used. As the aluminum source, aluminum oxide, aluminum hydroxide, or the like can be used.

### <Step S31>

Next, in Step S31 of FIG. 11A, LiM1O₂ obtained in Step S14 and the additive element X source are mixed. The ratio of the number M of the transition metal atoms in the composite oxide containing lithium, the transition metal, and oxygen to the number Mg of magnesium atoms in the additive element X source is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the particles of the composite oxide. For example, conditions with a lower rotation frequency or shorter time than the mixing in Step S12 are preferable. In addition, it can be said that the dry process has a milder condition than the wet process. For example, a ball mill, a bead mill, or the like can be used for the mixing. When a ball mill is used, zirconia balls are preferably used as media, for example.

Here, the mixing is performed with a ball mill using zirconia balls with a diameter of 1 mm by a dry process at 150 rpm for 1 hour. The mixing is performed in a dry room the dew point of which is higher than or equal to −100° C. and lower than or equal to −10° C.

### <Step S32>

Next, in Step S32 of FIG. 11A, the materials mixed in the above manner are collected to obtain a mixture 903.

Note that this embodiment describes the method of adding the mixture of lithium fluoride and magnesium fluoride to lithium cobalt oxide with few impurities; however, one embodiment of the present invention is not limited thereto. A mixture obtained through heating after addition of a magnesium source, a fluorine source, and the like to the starting material of lithium cobalt oxide may be used instead of the mixture 903 in Step S32. In that case, there is no need to separate steps of Step S11 to Step S14 and steps of Step S21 to Step S23, which is simple and productive.

Alternatively, a lithium cobalt oxide to which magnesium and fluorine are added in advance may be used. When a lithium cobalt oxide to which magnesium and fluorine are added is used, the process can be simpler because the steps up to Step S32 can be omitted.

Alternatively, a magnesium source and a fluorine source may be further added to the lithium cobalt oxide to which magnesium and fluorine are added in advance.

### <Step S33>

Next, in Step S33, the mixture 903 is heated in an oxygen-containing atmosphere. The heating is preferably performed such that particles of the mixture 903 are not adhered to one another.

When particles of the mixture 903 adhere to one another during heating, additive elements to be described later which are preferably distributed in the vicinity of surfaces might be distributed in an undesired manner. The surfaces of the particles, which are preferably even, might become uneven due to adhered particles and have more defects such as a split and/or a crack. This is probably because the adhesion of the particles of the mixture 903 reduces the contact area with oxygen in the atmosphere and blocks a path through which the additive elements diffuse.

The heating in Step S33 may be performed with a rotary kiln. The heating with a rotary kiln can be performed while stirring is performed in either case of a sequential rotary kiln or a batch-type rotary kiln. The heating in Step S33 may be performed with a roller hearth kiln.

The heating temperature in Step S33 needs to be higher than or equal to the temperature at which a reaction between LiM1O₂ and the additive element X source proceeds. Here, the temperature at which the reaction proceeds is a temperature at which interdiffusion between elements included in LiM1O₂ and elements included in the additive element X source occurs. Therefore, the heat treatment temperature can be lower than the melting temperatures of these material in some cases. For example, in an oxide, solid-phase diffusion occurs at a temperature that is 0.757 times (Tamman temperature T_{d}) the melting temperature Tₘ. Accordingly, it is only required that the heating temperature in Step S33 be higher than or equal to 500° C., for example.

A temperature higher than or equal to the temperature at which at least part of the mixture 903 is melted is preferable because the reaction proceeds more easily. In the case where LiF and MgF₂ are included as the additive element X sources, the eutectic point of LiF and MgF₂ is around 742° C., and the heating temperature in Step S33 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the heating temperature is further preferably higher than or equal to 830° C.

A higher heating temperature is preferable because it facilitates the reaction, shortens the heating time, and enables high productivity.

Note that the heating temperature needs to be lower than or equal to a decomposition temperature of LiM1O₂ (the decomposition temperature of LiCoO₂ is 1130° C.). At around the decomposition temperature, a slight amount of LiM1O₂ might be decomposed. Thus, the heating temperature in Step S33 is preferably lower than or equal to 1130° C., further preferably lower than or equal to 1000° C., further preferably lower than or equal to 950° C., and further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., and yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., and yet still further preferably higher than or equal to 742° C. and lower than or equal to 900° C. Furthermore, the heating temperature is preferably higher than or equal to 830° C. and lower than or equal to 1130° C., further preferably higher than or equal to 830° C. and lower than or equal to 1000° C., still further preferably higher than or equal to 830° C. and lower than or equal to 950° C., and yet still further preferably higher than or equal to 830° C. and lower than or equal to 900° C.

In addition, at the time of heating the mixture 903, the partial pressure of fluorine or a fluoride in the atmosphere is preferably controlled to be within an appropriate range.

In the formation method described in this embodiment, some of the materials, e.g., LiF as the fluorine source, function as flux in some cases. Owing to this function, the heating temperature can be lower than the decomposition temperature of LiM1O₂, e.g., a temperature higher than or equal to 742° C. and lower than or equal to 950° C., which allows distribution of the additive element such as magnesium in the vicinity of the surface and formation of the positive electrode active material having favorable performance.

However, since LiF in a gas phase has a specific gravity less than that of oxygen, LiF in a gas phase is easily degassed from the upper portion of the content for heating. Thus, when LiF vaporizes by heating, LiF in the mixture 903 decreases. As a result, the function of a flux deteriorates. Thus, heating needs to be performed while volatilization of LiF is inhibited. Note that even when LiF is not used as the fluorine source or the like, Li at the surface of LiM1O₂ and F might react to produce LiF, which might volatilize. Therefore, the volatilization needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

In the case of using a rotary kiln for the heating, the flow rate of an oxygen-containing atmosphere in the kiln is preferably controlled while the mixture 903 is heated. For example, the flow rate of an oxygen-containing atmosphere is preferably set low, or no flowing of an atmosphere is preferably performed after an atmosphere is purged first and an oxygen atmosphere is introduced into the kiln.

In the case of using a roller hearth kiln for the heating, the mixture 903 can be heated in an atmosphere containing LiF with the container containing the mixture 903 covered with a lid, for example.

The heating is preferably performed for an appropriate time. The heating time is changed depending on conditions, such as the heating temperature, and the particle size and composition of LiM1O₂ in Step S14. In the case where the particle size is small, the heating is preferably performed at a lower temperature or for a shorter time than the case where the particle size is large, in some cases.

When the average particle diameter (D50) of the composite oxide in Step S14 of FIG. 11A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example.

In the case where the average particle diameter (D50) of the composite oxide in Step S14 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than tor equal to 10 hours and shorter than or equal to 50 hours.

### <Step S34>

Next, the heated materials are collected to form a positive electrode active material 100C. At this time, the collected particles are preferably made to pass through a sieve. Through the above steps, the positive electrode active material 100C of one embodiment of the present invention can be formed (Step S34). The positive electrode active material 100C can be used as the first material 100x described in Embodiment 1 and Embodiment 2.

### [Method 3 for Forming Positive Electrode Active Material]

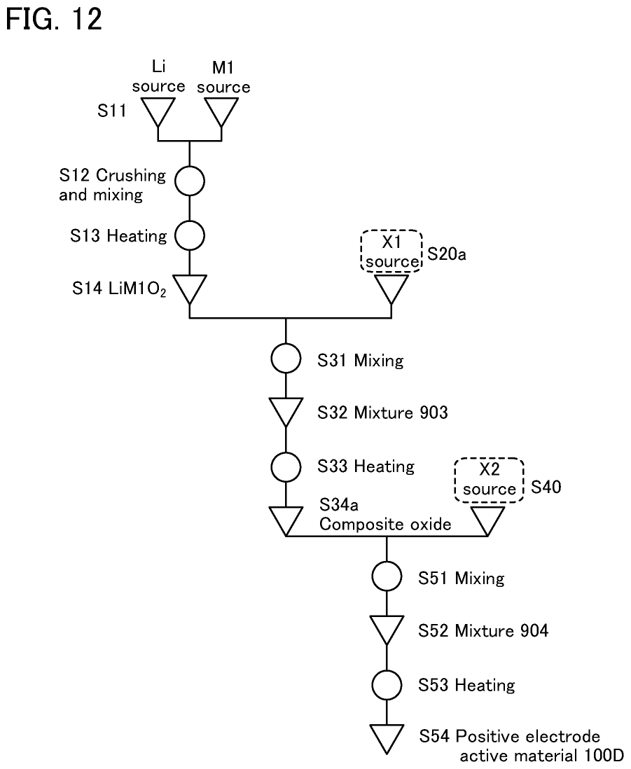

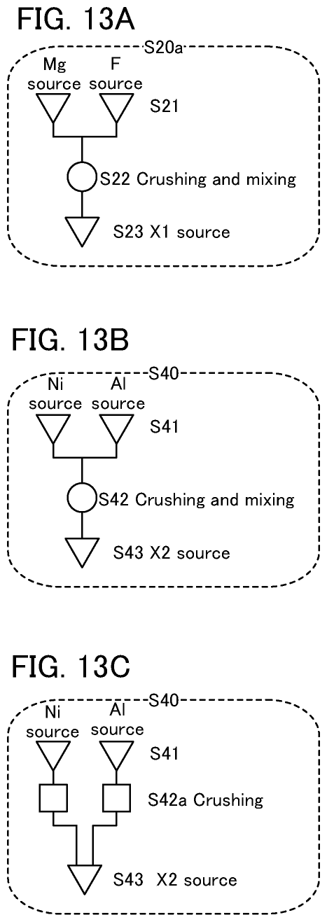

Next, another example of a method for forming a positive electrode active material of one embodiment of the present invention will be described with reference to FIG. 12, FIG. 13A, FIG. 13B, and FIG. 13C.

In FIG. 12, Steps S11 to S14 are performed in the same manner as those in FIG. 10A to prepare a composite oxide (LiM1O₂) containing lithium, a transition metal, and oxygen.

Note that pre-synthesized composite oxide containing lithium, the transition metal, and oxygen may be used in Step S14. In this case, Step S11 to Step S13 can be omitted.

### <Step S20a>

In Step S20a in FIG. 12, an additive element X1 source is prepared. The additive element X1 source can be selected from the above-described additive elements X to be used. For example, one or more selected from magnesium, fluorine, and calcium can be suitably used as the additive element X1. In this embodiment, an example in which magnesium and fluorine are used as the additive element X1 is shown with reference to FIG. 13A. Step S21 and Step S22 included in Step S20a in FIG. 13A can be performed in the same manner as that in Step S21 and Step S22 in FIG. 11B.

Step S23 in FIG. 13A is a step of collecting the material crushed and mixed in Step S22 in FIG. 13A to obtain the additive element X1 source.

Steps S31 to S33 in FIG. 12 can be performed in a manner similar to that in Steps S31 to S33 in FIG. 11.

### <Step S34a>

Next, the material heated in Step S33 is collected to form a composite oxide.

### <Step S40>

In Step S40 in FIG. 12, an additive element X2 source is prepared. The additive element X2 source can be selected from the above-described additive elements X. For example, one or more selected from nickel, titanium, boron, zirconium, and aluminum can be suitably used as the additive element X2. In this embodiment, an example in which nickel and aluminum are used as the additive element X2 is shown with reference to FIG. 13B. Step S41 and Step S42 included in Step S40 in FIG. 13B can be performed in the same manner as that in Step S21 and Step S22 in FIG. 11B.

Step S43 in FIG. 13B is a step of collecting the material crushed and mixed in Step S42 in FIG. 13B to obtain the additive element X2 source.

Step S40 in FIG. 13C is a modification example of Step S40 in FIG. 13B. In FIG. 13C, a nickel source and an aluminum source are prepared (Step S41) and subjected to crushing (Step S42a) independently, whereby a plurality of additive element X2 sources are prepared (Step S43).

### <Step S51 to Step S53>

Next, Step S51 in FIG. 12 is a step of mixing the composite oxide formed in Step S34a and the additive element X2 source formed in Step S40. Note that Step S51 in FIG. 12 can be performed in the same manner as that in Step S31 in FIG. 11A. In addition, Step S52 in FIG. 12 can be performed in the same manner as that in Step S32 in FIG. 11A. Note that a material formed in Step S52 in FIG. 12 corresponds to a mixture 904. The mixture 904 corresponds to a material that contains the additive element X2 source added in Step S40 in addition to the material of the mixture 903. Step S53 in FIG. 12 can be performed in the same manner as that in Step S33 in FIG. 11A.

### <Step S54>

Next, the heated materials are collected to form a positive electrode active material 100D. At that time, the collected particles are preferably made to pass through a sieve.

Through the above steps, the positive electrode active material 100D of one embodiment of the present invention can be formed (Step S54). The positive electrode active material 100D can be used as the first material 100x described in Embodiment 1 and Embodiment 2.

When steps of introducing the transition metal, the additive element X1, and the additive element X2 are separated as shown in FIG. 12 and FIG. 13A to FIG. 13C, the profiles of the elements in the depth direction can vary in some cases. For example, the concentration of an additive element can be made higher in the vicinity of the surface of the particle than in the inner portion thereof. Furthermore, with the number of atoms of the transition metal as a reference, the ratio of the number of atoms of the additive element with respect to the reference can be higher in the vicinity of the surface than in the inner portion.

### [Method 4 for Forming Positive Electrode Active Material]

### <Step S11>

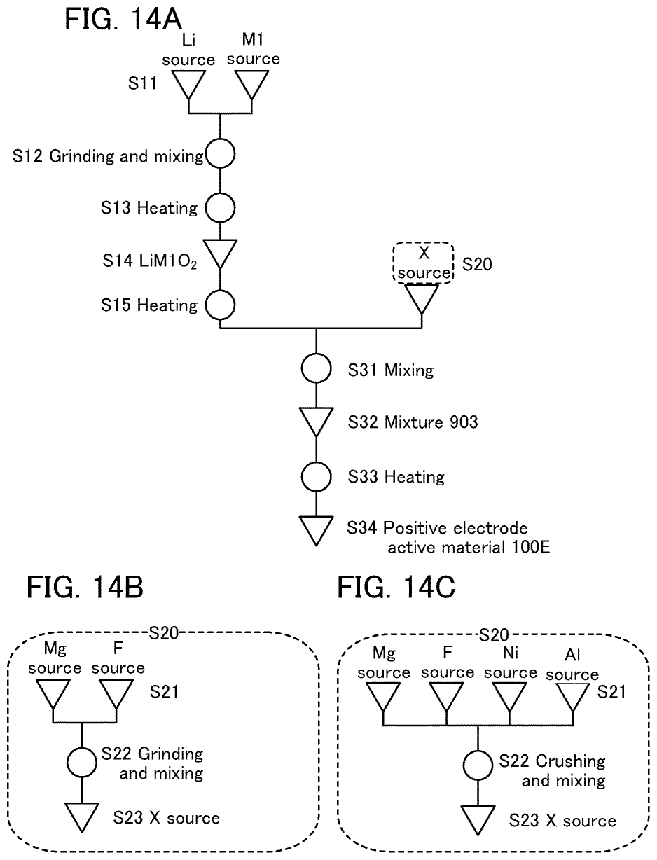

In Step S11 shown in FIG. 14A, a lithium source (Li source) and a transition metal source (M source) are prepared as materials of lithium and a transition metal which are starting materials.

A compound containing lithium is preferably used as the lithium source; for example, lithium carbonate, lithium hydroxide, lithium nitrate, lithium fluoride, or the like can be used. The lithium source preferably has a high purity and is preferably a material having a purity of higher than or equal to 99.99%, for example.

The transition metal can be selected from the elements belonging to Groups 4 to 13 of the periodic table and for example, at least one of manganese, cobalt, and nickel is used. As the transition metal, for example, cobalt alone; nickel alone; two metals of cobalt and manganese; two metals of cobalt and nickel; or three metals of cobalt, manganese, and nickel may be used. When cobalt alone is used, the positive electrode active material to be obtained contains lithium cobalt oxide (LCO); when three metals of cobalt, manganese, and nickel are used, the positive electrode active material to be obtained contains lithium nickel cobalt manganese oxide (NCM).

As the transition metal source, a compound containing the above transition metal is preferably used and for example, an oxide, a hydroxide, or the like of any of the metals given as examples of the transition metal can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using the high-purity material. As a result, a secondary battery with an increased capacity and/or increased reliability can be obtained.

Furthermore, the transition metal source preferably has high crystallinity, and preferably includes single crystal particles, for example.

In the case of using two or more transition metal sources, the two or more transition metal sources are preferably prepared to have proportions (mixing ratio) such that a layered rock-salt crystal structure would be obtained.

### <Step S12>

Next, in Step S12 shown in FIG. 14A, the lithium source and the transition metal source are ground and mixed to form a mixed material. The grinding and mixing can be performed by a dry process or a wet process. A wet method is preferred because it can crush a material into a smaller size. When the mixing is performed by a wet process, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used. It is preferable that the lithium source and the transition metal source be mixed into dehydrated acetone whose moisture content is less than or equal to 10 ppm and which has a purity of higher than or equal to 99.5% in the crushing and mixing. With the use of dehydrated acetone with the above-described purity, impurities that might be mixed can be reduced.

A ball mill, a bead mill, or the like can be used as a means of the mixing and the like. When the ball mill is used, alumina balls or zirconia balls are preferably used as grinding media, for example. Zirconia balls are preferable because they release fewer impurities. When a ball mill, a bead mill, or the like is used, the peripheral speed is preferably higher than or equal to 100 mm/s and lower than or equal to 2000 mm/s in order to inhibit contamination from the media. In this embodiment, the peripheral speed is set to 838 mm/s (the rotational frequency is 400 rpm, and the diameter of the ball mill container is 40 mm).

### <Step S13>

Next, the materials mixed in the above manner are heated in Step S13 shown in FIG. 14A. The heating temperature is preferably higher than or equal to 800° C. and lower than or equal to 1100° C., further preferably higher than or equal to 900° C. and lower than or equal to 1000° C., and still further preferably approximately 950° C. An excessively low temperature might lead to insufficient decomposition and melting of the lithium source and the transition metal source. An excessively high temperature might lead to a defect due to evaporation of lithium from the lithium source and/or excessive reduction of the metal used as the transition metal source, for example. The defect is, for example, an oxygen defect which could be induced by a change of trivalent cobalt into divalent cobalt due to excessive reduction, in the case where cobalt is used as the transition metal.

The heating time is longer than or equal to 1 hour and shorter than or equal to 100 hours, preferably longer than or equal to 2 hours and shorter than or equal to 20 hours.

The temperature raising rate is preferably higher than or equal to 80° C./h and lower than or equal to 250° C./h, although depending on the end-point temperature of the heating. For example, in the case of heating at 1000° C. for 10 hours, the temperature rise is preferably at 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible or a saggar used at the time of the heating is preferably made of alumina (aluminum oxide), mullite cordierite, magnesia, or zirconia, i.e., preferably includes a highly heat resistant material. An alumina crucible is preferable because it is a material into which impurities do not enter. In this embodiment, a crucible made of alumina with a purity of 99.9% is preferably used. A crucible or a saggar is preferably heated with a cover put thereon. This can prevents volatilization of the materials.

The heated material is ground as needed and may be made to pass through a sieve. Before collection of the heated material, the material may be moved from the crucible to a mortar. As the mortar, an alumina mortar can be suitably used. An alumina mortar is made of a material into which impurities do not enter. Specifically, a mortar made of alumina with a purity of 90% or higher, preferably 99% or higher, is used. Note that heating conditions equivalent to those in Step S13 can be employed in a later-described heating step other than Step S13.

### <Step S14>

Through the above steps, a composite oxide containing the transition metal (LiM1O₂) can be obtained in Step S14 shown in FIG. 14A. The composite oxide needs to have a crystal structure of a lithium composite oxide represented by LiM1O₂, but the composition is not strictly limited to Li:M1:O=1:1:2. When the transition metal is cobalt, the composite oxide is referred to as a composite oxide containing cobalt and is represented by LiCoO₂. The composition is not strictly limited to Li:Co:O=1:1:2.

Although the example is described in which the composite oxide is formed by a solid phase method as in Steps S11 to S14, the composite oxide may be formed by a coprecipitation method. Alternatively, the composite oxide may be formed by a hydrothermal method.

### <Step S15>

Next, in Step S15 shown in FIG. 14A, the above composite oxide is heated. The heating in Step S15 is the first heating performed on the composite oxide and thus, this heating is sometimes referred to as the initial heating. The heating is performed before Step S20 described below and thus is sometimes referred to as preheating or pretreatment.

The initial heating may cause release of lithium from part of the lithium composite oxide of Step S14. In addition, an effect of increasing the crystallinity of the lithium composite oxide can be expected. Since impurities are mixed into the lithium source and/or the transition metal M1 prepared in Step S11 and the like, the initial heating can reduce the impurities of the lithium composite oxide of Step S14.

Through the initial heating, the surface of the composite oxide becomes smooth. A smooth surface refers to a state of having little unevenness and being rounded as a whole, and its corner portion is rounded. Being smooth refers to a state where few foreign matters are attached to the surface. Foreign matters are deemed to cause unevenness and are preferably not attached to a surface. In an observation on a cross-section of a smooth active material by a scanning transmission electron microscope (STEM), the smooth active material can have a surface roughness of at least less than or equal to 10 nm, preferably less than 3 nm when the surface unevenness information is converted into numbers.

The initial heating is heating performed after a composite oxide is obtained, and the initial heating for making the surface smooth can reduce degradation after charge and discharge. The initial heating for making the surface smooth does not need a lithium compound source.

Alternatively, the initial heating for making the surface smooth does not need an added element source.

Alternatively, the initial heating for making the surface smooth does not need a flux.

The lithium source and the transition metal source prepared in Step S11 and the like might contain impurities. The initial heating can reduce impurities in the composite oxide completed in Step S14.

The heating conditions in this step can be freely set as long as the heating makes the surface of the above composite oxide smooth. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The heating in Step S13 might cause a temperature difference between the surface and an inner portion of the composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth, or “surface improvement is achieved”, through Step S15. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth, or “crystal grains might be aligned”. In other words, it is deemed that Step S15 reduces the shift due to a crystal or the like which is caused in the composite oxide to make the surface of the composite oxide smooth.

In a secondary battery including a composite oxide with a smooth surface as a positive electrode active material, degradation by charge and discharge is suppressed and a crack in the positive electrode active material can be prevented.

It can be said that when surface unevenness information in one cross section of a composite oxide is converted into numbers with measurement data, a smooth surface of the composite oxide has a surface roughness of at least less than or equal to 10 nm, preferably less than 3 nm. The one cross section is, for example, a cross section obtained in observation using a scanning transmission electron microscope (STEM).

Note that a composite oxide containing lithium, the transition metal, and oxygen, synthesized in advance may be used in Step S14. In this case, Step S11 to Step S13 can be omitted. When Step S15 is performed on the pre-synthesized composite oxide, a composite oxide with a smooth surface can be obtained.

The initial heating might decrease lithium in the composite oxide. An additive element described for Step S20 below might easily enter the composite oxide owing to the decrease in lithium.

### <Step S20>

An additive element X may be added to the composite oxide having a smooth surface as long as a layered rock-salt crystal structure can be obtained. When the additive element X is added to the composite oxide having a smooth surface, the additive element X can be It is thus preferable that the initial heating precede the addition of the uniformly added. additive element X. The step of adding the additive element X is described with reference to FIGS. 14B and 14C.

### <Step S21>

In Step S21 shown in FIG. 14B, an Mg source and an F source are prepared for the additive element source (X source) to be added to the composite oxide. A lithium source may be prepared together with the additive element sources.

As the additive element X, one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element X, one or more selected from bromine and beryllium can be used. Note that the aforementioned additive elements are more suitable because bromine and beryllium are elements having toxicity to living things.

When magnesium is selected as the additive element X, the additive element source can be referred to as a magnesium source. As the magnesium source, for example, magnesium fluoride, magnesium oxide, magnesium hydroxide, or magnesium carbonate can be used. Two or more of these magnesium sources may be used.

When fluorine is selected as the additive element X, the additive element source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. Among them, lithium fluoride, which has a relatively low melting point of 848° C., is preferable because it is easily melted in a heating step described later.

In addition, magnesium fluoride can be used as both the fluorine source and the magnesium source. Lithium fluoride can be used as both the lithium source and the fluorine source. Another example of the lithium source that can be used in Step S21 is lithium carbonate.

The fluorine source may be a gas, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at approximately LiF:MgF₂=65:35 (molar ratio), the effect of reducing the melting point becomes the highest (see Non-Patent Document 4). On the other hand, when the amount of lithium fluoride increases, cycle performance might deteriorate because of too large an amount of lithium. Therefore, the molar ratio of lithium fluoride to magnesium fluoride (LiF:MgF₂) is preferably x:1 (0≤x≤1.9), further preferably x:1 (0.1≤x<0.5), still further preferably x:1 (x=0.33 or an approximate value thereof). Note that in this specification and the like, the vicinity means a value greater than 0.9 times and less than 1.1 times a certain value.

### <Step S22>

Next, in Step S22 shown in FIG. 14B, the magnesium source and the fluorine source are ground and mixed. Any of the conditions for the grinding and mixing that are described for Step S12 can be selected to perform this step.

A heating step may be performed after Step S22 as needed. For the heating step, any of the heating conditions described for Step S13 can be selected. The heating time is preferably longer than or equal to two hours and the heating temperature is preferably higher than or equal to 800° C. and lower than or equal to 1100° C.

### <Step S23>

Next, in Step S23 shown in FIG. 14B, the materials ground and mixed in the above step are collected to obtain the additive element source (X source). Note that the additive element source in Step S23 contains a plurality of starting materials and can be referred to as a mixture.

As for the particle diameter of the mixture, its D50 (median diameter) is preferably greater than or equal to 600 nm and less than or equal to 20 μm, further preferably greater than or equal to 1 μm and less than or equal to 10 μm. Also when one kind of material is used as the added element source, the D50 (median diameter) is preferably greater than or equal to 600 nm and less than or equal to 20 μm, further preferably greater than or equal to 1 μm and less than or equal to 10 μm.

Such a pulverized mixture (which may contain only one kind of the additive element) is easily attached to the surface of a composite oxide particle uniformly in a later step of mixing with the composite oxide. The mixture is preferably attached uniformly to the surface of the composite oxide, in which case the additive element is easily distributed or dispersed uniformly in a surface portion of the composite oxide after heating. The region where the additive element is distributed can also be referred to as a surface portion. When there is a region containing no additive element in the surface portion, the positive electrode active material might be less likely to have an 03′ type crystal structure, which is described later, in the charged state. Note that although fluorine is used in the above description, chlorine may be used instead of fluorine, and a general term “halogen” for these elements can replace “fluorine”.

### <Step S21>

A process different from that in FIG. 14B is described with reference to FIG. 14C. In Step S21 shown in FIG. 14C, four kinds of additive element sources to be added to the composite oxide are prepared. In other words, FIG. 14C is different from FIG. 14B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 14B. As the nickel source, nickel oxide, nickel hydroxide, or the like can be used. As the aluminum source, aluminum oxide, aluminum hydroxide, or the like can be used.

### <Step S22 and Step S23>

Next, Step S22 and Step S23 shown in FIG. 14C are similar to the steps described with reference to FIG. 14B.

### <Step S31>

Next, in Step S31 shown in FIG. 14A, the composite oxide and the additive element source (X source) are mixed. The ratio of the number M of the transition metal atoms in the composite oxide containing lithium, the transition metal, and oxygen to the number Mg of magnesium atoms in the additive element X source is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the composite oxide. For example, conditions with a lower rotation frequency or shorter time than the mixing in Step S12 are preferable. In addition, it can be said that the dry process has a milder condition than the wet process. For example, a ball mill, a bead mill, or the like can be used for the mixing. When a ball mill is used, zirconia balls are preferably used as media, for example.

In this embodiment, the mixing is performed with a ball mill using zirconia balls with a diameter of 1 mm by a dry process at 150 rpm for 1 hour. The mixing is performed in a dry room the dew point of which is higher than or equal to −100° C. and lower than or equal to −10° C.

### <Step S32>

Next, in Step S32 of FIG. 14A, the materials mixed in the above manner are collected to obtain the mixture 903. At the time of collection, the materials may be sieved as needed after being crushed.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal source in Step S11, i.e., at the stage of the starting materials of the composite oxide. Then, the heating in Step S13 is performed, so that LiM1O₂ to which magnesium and fluorine are added can be obtained. In that case, there is no need to separate steps of Step S11 to Step S14 and steps of Step S21 to Step S23, which is simple and productive.

Alternatively, a lithium cobalt oxide to which magnesium and fluorine are added in advance may be used. When a lithium cobalt oxide to which magnesium and fluorine are added is used, Steps S11 to S32 and Step S20 can be skipped, so that the method is simplified and enables increased productivity.

Alternatively, to a lithium cobalt oxide to which magnesium and fluorine are added in advance, a magnesium source and a fluorine source may be further added as in Step S20 of FIG. 14B, or a magnesium source, a fluorine source, a nickel source, and an aluminum source may be further added as in Step S20 of FIG. 14C.

### <Step S33>

Then, in Step S33 shown in FIG. 14A, the mixture 903 is heated. For the heating, any of the heating conditions described for Step S13 can be selected. The heating time is preferably longer than or equal to two hours.

Here, a supplementary explanation of the heating temperature is provided. The lower limit of the heating temperature in Step S33 needs to be higher than or equal to the temperature at which a reaction between the composite oxide (LiM1O₂) and the additive element source proceeds. The temperature at which the reaction proceeds is the temperature at which interdiffusion of the elements included in LiM1O₂ and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element source, the eutectic point of LiF and MgF₂ is around 742° C. Therefore, the lower limit of the heating temperature in Step S33 is preferably higher than or equal to 742° C.

The mixture 903 obtained by mixing such that LiCoO₂:LiF:MgF₂=100:0.33:1 (molar ratio) exhibits an endothermic peak at around 830° C. in differential scanning calorimetry measurement (DSC measurement). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiM1O₂ (the decomposition temperature of LiCoO₂ is 1130° C.). At around the decomposition temperature, a slight amount of LiM1O₂ might be decomposed. Thus, the heating temperature is preferably lower than or equal to 1000° C., further preferably lower than or equal to 950° C., and further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., and yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., and yet still further preferably higher than or equal to 742° C. and lower than or equal to 900° C. Furthermore, the heating temperature is higher than or equal to 800° C. and lower than or equal to 1100° C., preferably higher than or equal to 830° C. and lower than or equal to 1130° C., further preferably higher than or equal to 830° C. and lower than or equal to 1000° C., still further preferably higher than or equal to 830° C. and lower than or equal to 950° C., and yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating the fluorine source or the like is preferably controlled to be within an appropriate range.

In the formation method described in this embodiment, some of the materials, e.g., LiF as the fluorine source, function as a flux in some cases. Owing to this function, the heating temperature can be lower than the decomposition temperature of the composite oxide (LiM1O₂), e.g., a temperature higher than or equal to 742° C. and lower than or equal to 950° C., which allows distribution of the additive element such as magnesium in the surface portion and formation of the positive electrode active material having favorable performance.

However, since LiF in a gas phase has a specific gravity less than that of oxygen, heating might volatilize LiF and in that case, LiF in the mixture 903 decreases. As a result, the function of a flux deteriorates. Thus, heating needs to be performed while volatilization of LiF is inhibited. Note that even when LiF is not used as the fluorine source or the like, Li at the surface of LiM1O₂ and F of the fluorine source might react to produce LiF, which might volatilize. Therefore, the volatilization needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions, such as the heating temperature, and the particle size and composition of LiM1O₂ in Step S14. In the case where the size of LiM1O₂ is small, it is sometimes preferable that the heating be performed at a lower temperature or for a shorter time than the case where the size of LiM1O₂ is large.

When the median diameter (D50) of the composite oxide (LiM1O₂) in Step S14 in FIG. 14A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than or equal to 10 hours and shorter than or equal to 50 hours.

When the median diameter (D50) of the composite oxide (LiM1O₂) in Step S14 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 14A, in which crushing is performed as needed; thus, a positive electrode active material 100E is obtained. Here, the collected particles are preferably made to pass through a sieve. Through the above steps, the positive electrode active material 100E of one embodiment of the present invention can be formed. The positive electrode active material of one embodiment of the present invention has a smooth surface. The positive electrode active material 100E can be used as the first material 100x described in Embodiment 1 and Embodiment 2.

### [Method 5 for Forming Positive Electrode Active Material]

Next, as one embodiment of the present invention, a method different from the method 2 for forming a positive electrode active material will be described.

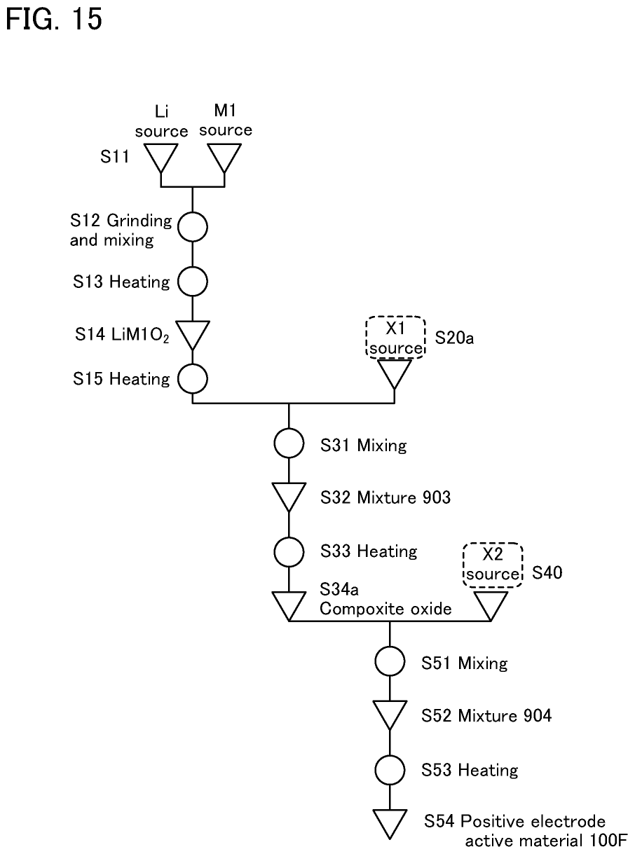

Steps S11 to S15 in FIG. 15 are performed as in FIG. 14A to prepare a composite oxide (LiM1O₂) having a smooth surface.

### <Step S20a>

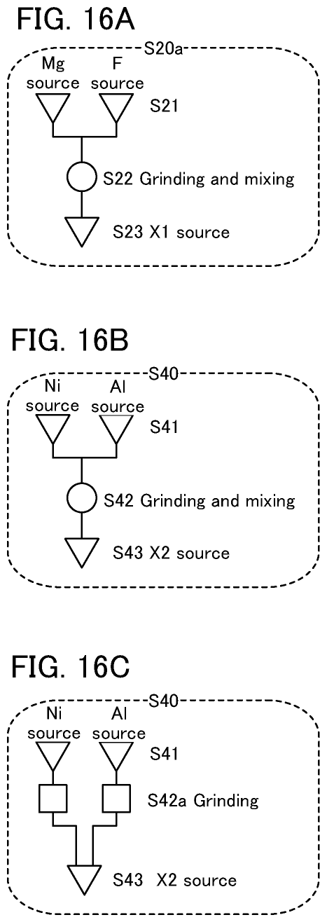

As already described above, the additive element X may be added to the composite oxide as long as a layered rock-salt crystal structure can be obtained. The formation method 2 has two or more steps of adding the additive element, as described below with reference to FIG. 16A.

### <Step S21>

FIG. 16A shows details of Step S20a. In Step S21, an Mg source and an F source are prepared for a first additive element source (X1 source). The X1 source can be selected from the additive elements X described for Step S21 with reference to FIG. 14B to be used. For example, one or more selected from magnesium, fluorine, and calcium can be suitably used for the additive element X1. FIG. 16A shows an example of using a magnesium source (Mg source) and a fluorine source (F source) as the first additive element source (X1 source).

Step S21 to Step S23 shown in FIG. 16A can be performed under the same conditions as those in Step S21 to Step S23 shown in FIG. 14B. As a result, the first additive element source (X1 source) can be obtained in Step S23. The first additive element source (X1 source) is used as the X1 source of Step S20a shown in FIG. 15.

Steps S31 to S33 shown in FIG. 15 can be performed in a manner similar to that of Steps S31 to S33 shown in FIG. 14A.

### <Step S34a>

Next, the material heated in Step S33 shown in FIG. 15 is collected to form a composite oxide containing the additive element X1. This composite oxide is called a second composite oxide to be distinguished from the composite oxide in Step S14.

### <Step S40>

In Step S40 shown in FIG. 15, a second additive element source (X2 source) is added. Details of Step S40 will be described with reference also to FIG. 16B and FIG. 16C.

### <Step S41>

In Step S41 shown in FIG. 16B, a Ni source and an Al source are prepared for the second additive element source (X2 source). The X2 source can be selected from the above-described additive elements X described for Step S21 shown in FIG. 14B. For example, one or more selected from nickel, titanium, boron, zirconium, and aluminum can be suitably used for the additive element X2. FIG. 16B shows an example of using a nickel source and an aluminum source for the second additive element source (X2 source).

Step S41 to Step S43 shown in FIG. 16B can be performed under the same conditions as those in Step S21 to Step S23 shown in FIG. 14B. As a result, the second additive element source (X2 source) can be obtained in Step S43.

FIG. 16C shows a modification example of the steps which are described with reference to FIG. 16B. A nickel source (Ni source) and an aluminum source (Al source) are prepared in Step S41 shown in FIG. 16C and are separately ground in Step S42a. Accordingly, a plurality of second additive element sources (X2 sources) are prepared in Step S43. FIG. 16C is different from FIG. 16B in separately grinding the additive elements in Step S42a.

### <Step S51 to Step S53>

Step S51 to Step S53 shown in FIG. 15 can be performed under the same conditions as those in Step S31 to Step S33 shown in FIG. 14A. The heating in Step S53 can be performed at a lower temperature and for a shorter time than the heating in Step S33. Through the above steps, a positive electrode active material 100F of one embodiment of the present invention can be formed in Step S53. The positive electrode active material of one embodiment of the present invention has a smooth surface. The positive electrode active material 100F can be used as the first material 100x described in Embodiment 1 and Embodiment 2.

As shown in FIG. 15 and FIG. 16, in the formation method 2, introduction of the additive element to the composite oxide is separated into introduction of the first additive element X1 and that of the second additive element X2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion.

The initial heating described in this embodiment makes it possible to obtain a positive electrode active material having a smooth surface.

The initial heating described in this embodiment is performed on a composite oxide. Thus, the initial heating is preferably performed at a temperature lower than the heating temperature for forming the composite oxide and for a time shorter than the heating time for forming the composite oxide. In the case of adding the added element to the composite oxide, the adding step is preferably performed after the initial heating. The adding step may be separated into two or more steps. Such an order of steps is preferred in order to maintain the smoothness of the surface achieved by the initial heating. When a composite oxide contains cobalt as a transition metal, the composite oxide can be read as a composite oxide containing cobalt.

The positive electrode active material 100F is sometimes referred to as a composite oxide containing lithium, the transition metal, and oxygen (LiM1O₂). Note that the positive electrode active material of one embodiment of the present invention only needs to have a crystal structure of a lithium composite oxide represented by LiM1O₂, and the composition is not strictly limited to Li:M1:O=1:1:2.

As described above, in one embodiment of the present invention, a positive electrode active material is formed using a high-purity material as the transition metal source used in synthesis and using a process which hardly allows entry of impurities in the synthesis. The positive electrode active material obtained by such a method for forming a positive electrode active material is a material that has a low impurity concentration, in other words, is highly purified. Furthermore, the positive electrode active material obtained by a method for forming a positive electrode active material is a material having high crystallinity. Furthermore, the positive electrode active material obtained by the method for forming a positive electrode active material, which is one embodiment of the present invention, can increase the capacity of a secondary battery and/or increase the reliability of the secondary battery.

### [Structure of Positive Electrode Active Material]

A positive electrode active material of one embodiment of the present invention is described with reference to FIG. 17 to FIG. 25.

FIG. 17A is a schematic top view of a positive electrode active material 100 which is one embodiment of the present invention. FIG. 17B is a schematic cross-sectional view taken along A-B in FIG. 17A.

### <Contained Elements and Distribution>

The positive electrode active material 100 contains lithium, a transition metal, oxygen, and an additive element. As the additive element, an element different from the transition metal contained in the positive electrode active material 100 is preferably used. In other words, the positive electrode active material 100 can be regarded as a composite oxide represented by LiM1O₂ to which an element other than M1 is added.

As the transition metal included in the positive electrode active material 100, a metal that can form, together with lithium, a composite oxide having the layered rock-salt structure belonging to the space group R-3m is preferably used. For example, at least one of manganese, cobalt, and nickel can be used. That is, as the transition metal contained in the positive electrode active material 100, only cobalt may be used, only nickel may be used, two metals of cobalt and manganese or two metals of cobalt and nickel may be used, or three metals of cobalt, manganese, and nickel may be used. In other words, the positive electrode active material 100 can contain a composite oxide containing lithium and the transition metal, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide. Nickel is preferably contained as the transition metal M in addition to cobalt, in which case a crystal structure is more stable in a high-voltage charged state.

As an additive element X included in the positive electrode active material 100, one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used. Such additive elements further stabilize a crystal structure included in the positive electrode active material 100 in some cases. The positive electrode active material 100 can include lithium cobalt oxide to which magnesium and fluorine are added, lithium cobalt oxide to which magnesium, fluorine, and titanium are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. In this specification and the like, the additive element X may be rephrased as a constituent of a mixture or a raw material or the like.

As illustrated in FIG. 17B, the positive electrode active material 100 includes a surface portion 100a and an inner portion 100b. The surface portion 100a preferably has a higher concentration of the additive element than the inner portion 100b. The concentration of the additive element preferably has a gradient as shown in FIG. 17B by gradation, in which the concentration increases from the inner portion toward the surface. In this specification and the like, the surface portion 100a refers to a region from a surface to a depth of approximately 10 nm in the positive electrode active material 100. A plane generated by a split and/or a crack may also be referred to as a surface. A region which is deeper than the surface portion 100a of the positive electrode active material 100 is referred to as the inner portion 100b.

In order to prevent the breakage of a layered structure formed of octahedrons of cobalt and oxygen even when lithium is extracted from the positive electrode active material 100 of one embodiment of the present invention by charging, the surface portion 100a having a high concentration of the additive element, i.e., the outer portion of a particle, is reinforced.

The concentration gradient of the additive element preferably exists, further preferably homogeneously, in the entire surface portion 100a of the positive electrode active material 100. A situation where only part of the surface portion 100a has reinforcement is not preferable because stress might be concentrated on parts that do not have reinforcement. The concentration of stress on part of a particle might cause defects such as cracks from that part, leading to breakage of the positive electrode active material and a decrease in charge and discharge capacity.

Magnesium is divalent and is more stable in lithium sites than in transition metal sites in the layered rock-salt crystal structure; thus, magnesium is likely to enter the lithium sites. An appropriate concentration of magnesium in the lithium sites of the surface portion 100a facilitates maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charging and discharging, and is thus preferable. However, excess magnesium might adversely affect insertion and extraction of lithium.

Aluminum is trivalent and can exist at a transition metal site in the layered rock-salt crystal structure. Aluminum can inhibit dissolution of surrounding cobalt. The bonding strength of aluminum with oxygen is high, thereby inhibiting extraction of oxygen around aluminum. Hence, aluminum contained as the additive element enables the positive electrode active material 100 to have the crystal structure that is unlikely to be broken by repeated charging and discharging.

When fluorine, which is a monovalent anion, is substituted for part of oxygen in the surface portion 100a, the lithium extraction energy is lowered. This is because the change in valence of cobalt ions associated with lithium extraction is trivalent to tetravalent in the case of not including fluorine and divalent to trivalent in the case of including fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

A titanium oxide is known to have superhydrophilicity. Accordingly, the positive electrode active material 100 including an oxide of titanium in the surface portion 100a presumably has good wettability with respect to a high-polarity solvent. Such the positive electrode active material 100 and a high-polarity electrolyte solution can have favorable contact at the interface therebetween and presumably inhibit a resistance increase when a secondary battery is formed using the positive electrode active material 100. Note that in this specification and the like, an electrolyte solution corresponds to a liquid electrolyte. The voltage of a positive electrode generally increases with increasing charge voltage of a secondary battery. The positive electrode active material of one embodiment of the present invention has a stable crystal structure even at high voltage. The stable crystal structure of the positive electrode active material in a charged state can suppress a capacity decrease due to repetitive charging and discharging.

A short circuit of a secondary battery might cause not only malfunction in charge operation and/or discharge operation of the secondary battery but also heat generation and firing. In order to obtain a safe secondary battery, a short-circuit current is preferably inhibited even at high charge voltage. In the positive electrode active material 100 of one embodiment of the present invention, a short-circuit current is inhibited even at high charge voltage. Thus, a secondary battery with high capacity and safety can be obtained.

It is preferable that a secondary battery using the positive electrode active material 100 of one embodiment of the present invention have high capacity, excellent charge and discharge cycle performance, and safety simultaneously.

The gradient of the concentration of the additive element can be evaluated using energy dispersive X-ray spectroscopy (EDX). In the EDX measurement, to measure a region while scanning the region and evaluate the region two-dimensionally is referred to as EDX planar analysis in some cases. In addition, to extract data of a linear region from EDX planar analysis and evaluate the atomic concentration distribution in the positive electrode active material is referred to as linear analysis in some cases.

By EDX surface analysis (e.g., element mapping), the concentrations of the additive element in the surface portion 100a, the inner portion 100b, the vicinity of the crystal grain boundary, and the like of the positive electrode active material 100 can be quantitatively analyzed. By EDX linear analysis, the concentration peak of the additive element can be analyzed.

When the positive electrode active material 100 is analyzed with the EDX linear analysis, a peak of the magnesium concentration in the surface portion 100a preferably exists in a region from the surface of the positive electrode active material 100 to a depth of 3 nm toward the center, further preferably to a depth of 1 nm, still further preferably to a depth of 0.5 nm.

In addition, the distribution of fluorine contained in the positive electrode active material 100 preferably overlaps with the distribution of magnesium. Thus, when the EDX linear analysis is performed, a peak of the fluorine concentration in the surface portion 100a preferably exists in a region from the surface of the positive electrode active material 100 to a depth of 3 nm toward the center, further preferably to a depth of 1 nm, still further preferably to a depth of 0.5 nm.

Note that the concentration distribution may differ between the additive elements. For example, in the case where the positive electrode active material 100 includes aluminum as the additive element, the distribution of aluminum is preferably slightly different from that of magnesium and that of fluorine. For example, in the EDX linear analysis, the peak of the magnesium concentration is preferably closer to the surface than the peak of the aluminum concentration is in the surface portion 100a. For example, the peak of the aluminum concentration is preferably present in a region from the surface of the positive electrode active material 100 to a depth of 0.5 nm or more and 20 nm or less toward the center, further preferably to a depth of 1 nm or more and 5 nm or less.

When the linear analysis or the surface analysis is performed on the positive electrode active material 100, the ratio (I/M) of an additive element I to the transition metal in the vicinity of the crystal grain boundary is preferably greater than or equal to 0.020 and less than or equal to 0.50. It is further preferably greater than or equal to 0.025 and less than or equal to 0.30. It is still further preferably greater than or equal to 0.030 and less than or equal to 0.20. For example, when the additive element is magnesium and the transition metal is cobalt, the atomic ratio (Mg/Co) of magnesium to cobalt is preferably greater than or equal to 0.020 and less than or equal to 0.50. It is further preferably greater than or equal to 0.025 and less than or equal to 0.30. It is still further preferably greater than or equal to 0.030 and less than or equal to 0.20.

As described above, an excess amount of the additive element in the positive electrode active material 100 might adversely affect insertion and extraction of lithium. The use of such a positive electrode active material 100 for a secondary battery might cause a resistance increase, a capacity decrease, and the like. Meanwhile, when the amount of additive element is insufficient, the additive element is not distributed over the whole surface portion 100a, which might reduce the effect of maintaining the crystal structure. The additive element at an appropriate concentration is required in the positive electrode active material 100; however, the adjustment of the concentration is not easy.

For this reason, the positive electrode active material 100 may include a region where the excess additive element is unevenly distributed, for example. With such a region, the excess additive element is removed from the other region, and the additive element concentration in most of the inner portion and the vicinity of the surface in the positive electrode active material 100 can be appropriate. An appropriate additive element concentration in most of the inner portion and the vicinity of the surface in the positive electrode active material 100 can inhibit a resistance increase, a capacity decrease, and the like when the positive electrode active material 100 is used for a secondary battery. A feature of inhibiting a resistance increase of a secondary battery is extremely preferable especially in charging and discharging at a high rate.

In the positive electrode active material 100 including the region where the excess additive element is unevenly distributed, mixing of an excess additive element to some extent in the formation process is acceptable. This is preferable because the margin of production can be increased.

Note that in this specification and the like, uneven distribution means that the concentration of an element differs between a region A and a region B. It may be rephrased as segregation, precipitation, unevenness, deviation, high concentration, low concentration, or the like.

### <Crystal Structure>

A material with the layered rock-salt crystal structure, such as lithium cobalt oxide (LiCoO₂), is known to have a high discharge capacity and excel as a positive electrode active material of a secondary battery. As an example of the material with the layered rock-salt crystal structure, a composite oxide represented by LiM1O₂ is given.

It is known that the Jahn-Teller effect in a transition metal compound varies in degree according to the number of electrons in the d orbital of the transition metal.

In a composite oxide containing nickel, distortion is likely to be caused because of the Jahn-Teller effect in some cases. Accordingly, when charge and discharge with a high voltage are performed on LiNiO₂, the crystal structure might be broken because of the distortion. The influence of the Jahn-Teller effect is suggested to be small in LiCoO₂; hence, LiCoO₂ is preferable because the resistance to high-voltage charging and discharging is higher in some cases.

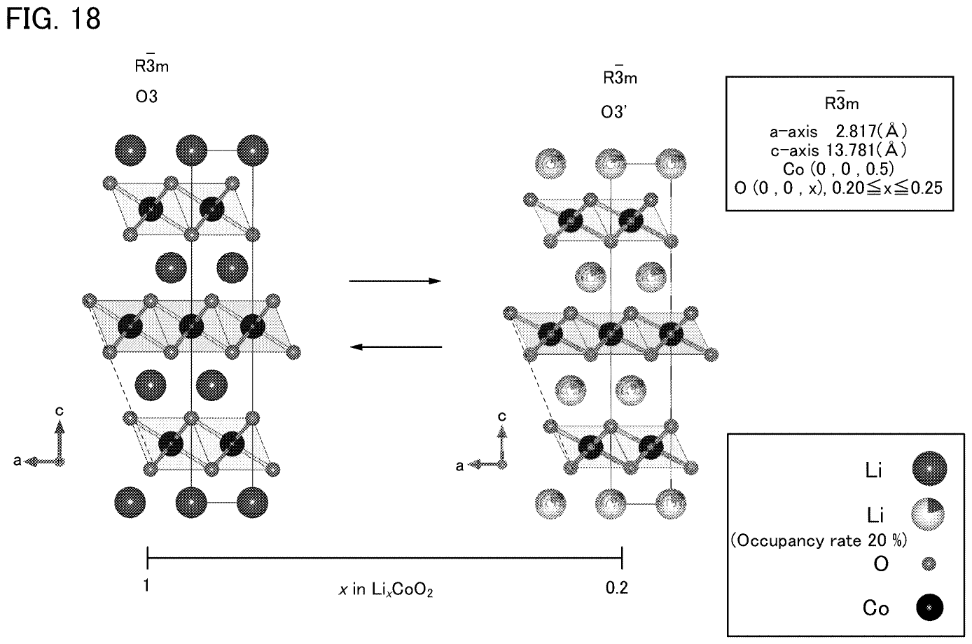

Positive electrode active materials are described with reference to FIG. 18 to FIG. 21. In FIG. 18 to FIG. 21, the case where cobalt is used as the transition metal contained in the positive electrode active material is described.

<<x in LiₓCoO₂ being 1>>

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure.

In FIG. 18, the layered rock-salt crystal structure is denoted with O3 along with the space group R-3m. The name O3 is based on the fact that lithium occupies octahedral sites in this crystal structure and a unit cell includes three CoO₂ layers. This crystal structure is also referred to as an O3 type crystal structure in some cases. Note that the CoO₂ layer has a structure in which an octahedral structure with cobalt coordinated to six oxygen atoms continues in a plane direction in an edge-shared state. The CoO₂ layer is sometimes referred to as a layer formed of octahedrons of cobalt and oxygen.

<<the State where x in LiₓCoO₂ is Small>>

The positive electrode active material 100 of one embodiment of the present invention is different from a conventional positive electrode active material in the crystal structure in the state where x in LiₓCoO₂ is small. Here, “x is small” means 0.1<x≤0.24. FIG. 18 shows a crystal structure with x=0.2.

A conventional positive electrode active material and the positive electrode active material 100 of one embodiment of the present invention are compared in respect to a change in the crystal structure due to a change of x in LiₓCoO₂.

### <Conventional Positive Electrode Active Material>

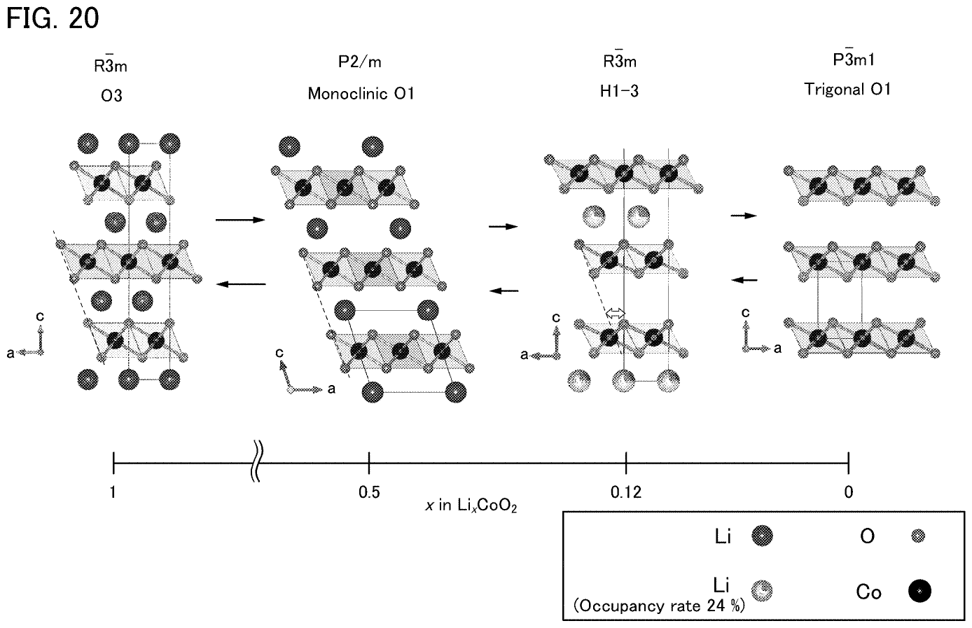

A change in the crystal structure of the conventional positive electrode active material is shown in FIG. 20. The conventional positive electrode active material shown in FIG. 20 is a lithium cobalt oxide (LiCoO₂ or LCO) to which no additive element such as halogen or magnesium is added. As described in Non-Patent Document 1 to Non-Patent Document 3 and the like, the crystal structure of the lithium cobalt oxide shown in FIG. 20 changes.

In FIG. 20, the crystal structure of the lithium cobalt oxide with x in LiₓCoO₂₌₁ is denoted with R-3m O3. x=1 corresponds to a discharge state of a secondary battery. Next, the crystal structure of the lithium cobalt oxide with x=0.5 is denoted with P2/m monoclinic O1. A conventional lithium cobalt oxide with x=approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

Furthermore, the crystal structure of lithium cobalt oxide with x in LiₓCoO₂=0 is denoted with P-3 ml trigonal O1. Conventional lithium cobalt oxide with x=0 has a trigonal crystal structure belonging to the space group P-3 ml. This structure includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when a trigonal crystal is converted into a composite hexagonal lattice.

Furthermore, the crystal structure of lithium cobalt oxide with x in LiₓCoO₂ being approximately 0.12 is denoted with R-3m H1-3. A conventional lithium cobalt oxide with x being approximately 0.12 has a crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in reality, the H1-3 type crystal structure is started to be observed when x is approximately 0.25 in practice. Moreover, the number of cobalt atoms per unit cell in the actual H1-3 type crystal structure is actually twice as large as that of cobalt atoms per unit cell in other structures. However, in this specification including FIG. 20, the c-axis of the H1-3 type crystal structure is half that of the unit cell for easy comparison with the other crystal structures.

For the H1-3 type crystal structure, as disclosed in Non-Patent Document 2, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD, for example. In this case, a unit cell is selected such that the value of GOF (goodness of fit) is small.

When charging that makes x in LiₓCoO₂ be 0.24 or less and discharging are repeated, the crystal structure of conventional lithium cobalt oxide repeatedly changes between the H1-3 type structure and the R-3m O3 structure in a discharged state (i.e., an unbalanced phase change).

However, there is a large shift in the CoO₂ layers between these two crystal structures. As denoted by the dotted lines and the arrow in FIG. 20, the CoO₂ layer in the H1-3 type structure largely shifts from that in the structure belonging to R-3m O3. Such a dynamic structural change can adversely affect the stability of the crystal structure.

A difference in volume between these two crystal structures is also large. The difference in volume per the same number of cobalt atoms between the H1-3 type crystal structure and the R-3m O3 type crystal structure in the discharged state is greater than 3.5%, typically greater than or equal to 3.9%.

In addition, a structure in which there is no lithium between CoO₂ layers and CoO₂ layers are continuous, such as the trigonal O1 type structure, included in the H1-3 type crystal structure is highly likely to be unstable.

Thus, when charging and discharging are repeated so that x becomes less than or equal to 0.24, the crystal structure of conventional lithium cobalt oxide is gradually broken.

The broken crystal structure triggers deterioration of the cycle performance. This is because the broken crystal structure has a smaller number of sites where lithium can exist stably and makes it difficult to insert and extract lithium.

### <Positive Electrode Active Material of One Embodiment of the Present Invention>

In the positive electrode active material 100 of one embodiment of the present invention shown in FIG. 18, a change in the crystal structure between a discharged state with x in LiₓCoO₂ being 1 and a state with x being 0.24 or less, e.g., x=0.2, is smaller than that in a conventional positive electrode active material. Specifically, a shift in the CoO₂ layers between the state with x being 1 and the state with x being 0.2, which is less than or equal to 0.24, can be small. Furthermore, a change in the volume can be small in the case where the positive electrode active materials have the same number of cobalt atoms. Thus, the positive electrode active material 100 of one embodiment of the present invention can have a crystal structure that is difficult to break even when charging and discharging are repeated so that x becomes 0.24 or less, and obtain excellent cycle performance.

In addition, the positive electrode active material 100 of one embodiment of the present invention with x in LiₓCoO₂ being 0.24 or less can have a more stable crystal structure than a conventional positive electrode active material. Thus, in the positive electrode active material 100 of one embodiment of the present invention, x in LiₓCoO₂ is preferably kept to be 0.24 or less, in which case a short circuit is less likely to occur and the safety of the secondary battery is improved.

FIG. 18 shows the crystal structures of a lithium cobalt oxide with x in LiₓCoO₂ being 1 and approximately 0.2. It is a composite oxide containing a lithium cobalt oxide, cobalt as a transition metal, and oxygen. In addition to the above, magnesium is preferably contained as an additive element. Furthermore, halogen such as fluorine or chlorine is preferably contained as an additive element.

The lithium cobalt oxide of one embodiment of the present invention with x=1 has a crystal structure of R-3m O3 that is the same as that of the conventional lithium cobalt oxide. The lithium cobalt oxide of one embodiment of the present invention with x being 0.24 or less, e.g., approximately 0.2, which makes the conventional lithium cobalt oxide have a H1-3 type crystal structure, has a crystal having a different structure from a conventional one.

The lithium cobalt oxide of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 18, the crystal structure with x being approximately 0.2 is denoted with R-3m O3′.

In the unit cell of the O3′ type crystal structure, the coordinates of cobalt and oxygen can be represented by Co (0, 0, 0.5) and O (0, 0, x) within the range of 0.20≤x≤0.25.

As denoted by the dotted lines in FIG. 18, the CoO₂ layers hardly shift between the R-3m O3 in the discharged state and the O3′ type crystal structure.

The R-3m O3 in the discharged state and the O3′ type crystal structure that contain the same number of cobalt atoms have a difference in volume of 2.5% or less, more specifically 2.2% or less, typically 1.8%, i.e., the difference in volume is small.

As described above, in the positive electrode active material 100, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is inhibited. Thus, the crystal structure of the positive electrode active material 100 is less likely to break even when charging that makes x be 0.24 or less and discharging are repeated. Therefore, a decrease in charge and discharge capacity of the positive electrode active material 100 in charge and discharge cycles is inhibited. Furthermore, the positive electrode active material 100 can stably use a large amount of lithium than a conventional positive electrode active material and thus has large discharge capacity per weight and per volume. Thus, with the use of the positive electrode active material 100, a secondary battery with large discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced not only by x in LiₓCoO₂ but also by the number of charge and discharge cycles, charge and discharge current, temperature, an electrolyte, and the like; thus, in some cases, the O3′ type crystal structure is obtained regardless of whether x is in the above range.

When x in LiₓCoO₂ in the positive electrode active material 100 is greater than 0.1 and less than or equal to 0.24, not all of the inner portion of the positive electrode active material 100 has to have the O3′ type crystal structure. Some of the particles may have another crystal structure or be amorphous.

In order to make x in LiₓCoO₂ small, charging at a high charge voltage is necessary in general. Thus, a state where x in LiₓCoO₂ is small can be rephrased as a state where charging at a high charge voltage has been performed. For example, when charge is performed at 25° C. and 4.6 V or higher with reference to the potential of a lithium metal, the H1-3 type crystal structure appears in a conventional positive electrode active material. Hence, a high charge voltage with reference to the potential of a lithium metal can be regarded as a charge voltage of 4.6 V or higher. In this specification and the like, unless otherwise specified, charge voltage is shown with reference to the potential of a lithium metal.

It is preferred because the crystal structure with the symmetry of R-3m O3 can be kept when the positive electrode active material 100 is charged at a high charge voltage. As the high charge voltage, for example, a voltage higher than or equal to 4.6 V at 25° C. can be given. As a higher charge voltage, for example, a voltage higher than or equal to 4.65 V and lower than or equal to 4.7 V at 25° C. can be given.

In the positive electrode active material 100, when the charge voltage is increased, the H1-3 type crystal is observed little by little in some cases. As described above, the crystal structure is influenced by the number of charge and discharge cycles, a charge current and a discharge current, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, in the case of a secondary battery using graphite as a negative electrode active material, a similar crystal structure is obtained at a voltage obtained by subtracting the potential of the graphite from the above-described voltage.

Although a chance of the existence of lithium is the same in all lithium sites in O3′ in FIG. 18, one embodiment of the present invention is not limited thereto. Lithium may exist unevenly in only some of the lithium sites; for example, lithium may symmetrically exist as in the monoclinic O1 (Li_{0.5}CoO₂) shown in FIG. 20. Distribution of lithium can be analyzed by neutron diffraction, for example.

The O3′ type crystal structure can be regarded as a crystal structure that contains lithium between CoO₂ layers randomly and is similar to a CdCl₂ type crystal structure. The crystal structure similar to the CdCl₂ type crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ type crystal structure in general.

A slight amount of the additive element such as magnesium randomly existing between the CoO₂ layers, i.e., in lithium sites, can inhibit a shift in the CoO₂ layers at the time of charge with high voltage. Thus, magnesium between the CoO₂ layers makes it easier to obtain the O3′ type crystal structure. Therefore, magnesium is distributed in at least the surface portion of the positive electrode active material 100 of one embodiment of the present invention, preferably distributed throughout the whole positive electrode active material 100. To distribute magnesium throughout the whole positive electrode active material 100, heat treatment is preferably performed in the formation process of the positive electrode active material 100 of one embodiment of the present invention.

However, heat treatment at an excessively high temperature might cause cation mixing, which increases the possibility of entry of the additive element such as magnesium into the cobalt sites. Magnesium in the cobalt sites does not have the effect of maintaining the R-3m structure in high-voltage charging. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium to the positive electrode active material 100. The addition of the halogen compound decreases the melting point of lithium cobalt oxide. The decrease in the melting point makes it easier to distribute magnesium to the positive electrode active material 100 at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably larger than or equal to 0.001 times and less than or equal to 0.1 times, further preferably larger than 0.01 times and less than 0.04 times, still further preferably approximately 0.02 times the number of transition metal atoms such as cobalt atoms. The magnesium concentration described here may be a value obtained by element analysis on the whole particles of the positive electrode active material 100 using ICP-MS or the like, or may be a value based on the ratio of the raw materials mixed in the process of forming the positive electrode active material, for example.

As a metal other than cobalt (hereinafter, the metal Z), one or more metals selected from nickel, aluminum, manganese, titanium, vanadium, and chromium may be added to lithium cobalt oxide, for example, and in particular, one or both of nickel and aluminum are preferably added. In some cases, manganese, titanium, vanadium, and chromium are likely to have a valence of four stably and thus contribute highly to a stable structure. The addition of the metal Z may enable the crystal structure to be stabler in a high-voltage charged state. Here, in the positive electrode active material of one embodiment of the present invention, the metal Z is preferably added at a concentration that does not greatly change the crystallinity of the lithium cobalt oxide. For example, the metal Z is preferably added at an amount with which the aforementioned Jahn-Teller effect is not exhibited.

Aluminum and the transition metal typified by nickel and manganese preferably exist in cobalt sites, but part of them may exist in lithium sites. Magnesium preferably exists in lithium sites. Fluorine may be substituted for part of oxygen.

As the magnesium concentration in the positive electrode active material of one embodiment of the present invention increases, the capacity of the positive electrode active material decreases in some cases. As an example, one possible reason is that the amount of lithium that contributes to charging and discharging decreases when magnesium enters the lithium sites. Another possible reason is that excess magnesium generates a magnesium compound that does not contribute to charging and discharging. When the positive electrode active material of one embodiment of the present invention contains nickel as the metal Z in addition to magnesium, the capacity per weight and per volume can be increased in some cases. When the positive electrode active material of one embodiment of the present invention contains aluminum as the metal Z in addition to magnesium, the capacity per weight and per volume can be increased in some cases. When the positive electrode active material of one embodiment of the present invention contains nickel and aluminum in addition to magnesium, the capacity per weight and per volume can be increased in some cases.

The concentrations of the elements, such as magnesium and the metal Z, contained in the positive electrode active material of one embodiment of the present invention are discussed below.

When containing magnesium in addition to the element X, the positive electrode active material of one embodiment of the present invention is extremely stable in a high voltage charged state. When the element X is phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. The phosphorus concentration and the magnesium concentration described here may each be a value obtained by element analysis on the whole particles of the positive electrode active material using ICP-MS or the like, or may be a value based on the ratio of the raw materials mixed in the process of forming the positive electrode active material, for example.

The number of nickel atoms in the positive electrode active material of one embodiment of the present invention is preferably less than or equal to 10%, further preferably less than or equal to 7.5%, still further preferably greater than or equal to 0.05% and less than or equal to 4%, and especially preferably greater than or equal to 0.1% and less than or equal to 2% of the number of cobalt atoms. The nickel concentration described here may be a value obtained by element analysis on the whole particles of the positive electrode active material using ICP-MS or the like, or may be a value based on the ratio of the raw materials mixed in the process of forming the positive electrode active material, for example.

When a state being charged with high voltage is held for a long time, the transition metal dissolves in an electrolyte solution from the positive electrode active material, and the crystal structure might be broken. However, when nickel is included at the above-described proportion, dissolution of the transition metal from the positive electrode active material 100 can be inhibited in some cases.

The number of aluminum atoms in the positive electrode active material of one embodiment of the present invention is preferably greater than or equal to 0.05% and less than or equal to 4%, further preferably greater than or equal to 0.1% and less than or equal to 2% of the number of cobalt atoms. The aluminum concentration described here may be a value obtained by element analysis on the whole particles of the positive electrode active material using ICP-MS or the like, or may be a value based on the ratio of the raw materials mixed in the process of forming the positive electrode active material, for example.

It is preferable that the positive electrode active material of one embodiment of the present invention contain an element X and phosphorus be used as the element X. The positive electrode active material of one embodiment of the present invention further preferably includes a composite oxide containing phosphorus and oxygen.

When the positive electrode active material of one embodiment of the present invention includes a composite oxide containing the element X, a short circuit is unlikely to occur while a high voltage charged state is maintained, in some cases.

When the positive electrode active material of one embodiment of the present invention contains phosphorus as the element X, phosphorus may react with hydrogen fluoride generated by the decomposition of the electrolyte solution, which might decrease the hydrogen fluoride concentration in the electrolyte solution.

In the case where the electrolyte solution contains LiPF₆ as a lithium salt, hydrogen fluoride may be generated by hydrolysis. In some cases, hydrogen fluoride is generated by the reaction of PVDF used as a component of the positive electrode and alkali. The decrease in hydrogen fluoride concentration in the electrolyte solution can inhibit corrosion and/or coating film separation of a current collector in some cases. Furthermore, the decrease in hydrogen fluoride concentration in the electrolyte solution can inhibit a reduction in adhesion properties due to gelling and/or insolubilization of PVDF in some cases.

In the case where the positive electrode active material has a crack, phosphorus, more specifically, a composite oxide containing phosphorus and oxygen, in the inner portion of the positive electrode active material with the crack may inhibit crack development, for example.

As is obvious from oxygen atoms indicated by arrows in FIG. 18, the symmetry of the oxygen atoms slightly differs between the O3 type crystal structure and the O3′ type crystal structure. Specifically, the oxygen atoms in the O3 type crystal structure are aligned with the dotted line, whereas strict alignment of the oxygen atoms is not observed in the O3′ type crystal structure. This is caused by an increase in the amount of tetravalent cobalt along with a decrease in the amount of lithium in the O3′ type crystal structure, resulting in an increase in the Jahn-Teller distortion. Consequently, the octahedral structure of CoO₆ is distorted. In addition, an increase in repulsion between oxygen atoms in the CoO₂ layer with a reduction in lithium also affect.

<<Surface Portion 100a>>

It is preferable that magnesium be distributed throughout a particle of the positive electrode active material 100 of one embodiment of the present invention, and it is further preferable that the magnesium concentration in the surface portion 100a be higher than the average magnesium concentration in the whole particle. For example, the magnesium concentration of the surface portion 100a measured by XPS or the like is preferably higher than the average magnesium concentration in the whole particle measured by ICP-MS or the like.

In the case where the positive electrode active material 100 of one embodiment of the present invention contains an element other than cobalt, for example, one or more metals selected from nickel, aluminum, manganese, iron, and chromium, the concentration of the metal in the vicinity of the surface of the particle is preferably higher than the average concentration in the whole particle. For example, the concentration of the element other than cobalt in the surface portion 100a measured by XPS or the like is preferably higher than the average concentration of the element in the whole particles measured by ICP-MS or the like.

The surface portion of the positive electrode active material is a kind of crystal defects and lithium is extracted from the surface during charging; thus, the lithium concentration in the surface portion tends to be lower than that in the inner portion. Therefore, the surface portion tends to be unstable and its crystal structure is likely to be broken. The higher the magnesium concentration in the surface portion 100a is, the more effectively the change in the crystal structure can be reduced. In addition, a high magnesium concentration in the surface portion 100a probably increases the corrosion resistance to hydrofluoric acid generated by the decomposition of the electrolyte solution.

The concentration of halogen such as fluorine in the surface portion 100a of the positive electrode active material 100 of one embodiment of the present invention is preferably higher than the average concentration in the whole positive electrode active material 100. When halogen exists in the surface portion 100a, which is in contact with the electrolyte solution, the corrosion resistance to hydrofluoric acid can be effectively increased.

As described above, the surface portion 100a of the positive electrode active material 100 of one embodiment of the present invention preferably has a composition different from that in the inner portion 100b, i.e., the concentrations of the additive elements such as magnesium and fluorine are preferably higher than those in the inner portion 100b. The surface portion 100a having such a composition preferably has a crystal structure stable at room temperature. Accordingly, the surface portion 100a may have a crystal structure different from that of the inner portion 100b. For example, at least part of the surface portion 100a of the positive electrode active material 100 of one embodiment of the present invention may have a rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal have cubic closest packed structures (face-centered cubic lattice structures). Anions of an 03′ type crystal are presumed to form a cubic close-packed structure. When the pseudo-spinel crystal is in contact with the layered rock-salt crystal and the rock-salt crystal, there is a crystal plane at which orientations of cubic closest packed structures composed of anions are aligned. Note that a space group of the layered rock-salt crystal and the O3′ type crystal is R-3m, which is different from the space group Fm-3m of a rock-salt crystal (a space group of a general rock-salt crystal) and the space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic closest packed structures composed of anions in the layered rock-salt crystal, the O3′ type crystal, and the rock-salt crystal are aligned is referred to as a state where crystal orientations are substantially aligned in some cases.

Substantial alignment of the crystal orientations in two regions can be judged from a TEM (transmission electron microscopy) image, a STEM (scanning transmission electron microscopy) image, a HAADF-STEM (high-angle annular dark-field scanning transmission electron microscopy) image, an ABF-STEM (annular bright-field scanning transmission electron microscopy) image, or the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in the TEM image and the like, a light element such as oxygen or fluorine cannot be clearly observed in some cases; however, in such a case, alignment of orientations can be judged by arrangement of metal elements.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The element X is preferably positioned in the surface portion 100a of the positive electrode active material 100 of one embodiment of the present invention. For example, the positive electrode active material 100 of one embodiment of the present invention may be covered with a coating film (a barrier layer) containing the element X.

### <<Grain Boundary>>

The additive element X included in the positive electrode active material 100 of one embodiment of the present invention may randomly exist in the inner portion at a slight concentration, but part of the additive element X is preferably segregated in a grain boundary.

In other words, the concentration of the additive element X in the grain boundary and its vicinity of the positive electrode active material 100 of one embodiment of the present invention is preferably higher than that in the other regions in the inner portion.

Like the particle surface, the grain boundary is also a plane defect. Thus, the grain boundary tends to be unstable and its crystal structure easily starts to change. Therefore, the higher the concentration of the additive element X in the grain boundary and its vicinity is, the more effectively the change in the crystal structure can be inhibited.

In the case where the concentration of the additive element X is high in the grain boundary and its vicinity, even when a crack is generated along the grain boundary of the positive electrode active material 100 of one embodiment of the present invention, the concentration of the additive element X is increased in the vicinity of the surface generated by the crack. Thus, the positive electrode active material can have an increased corrosion resistance to hydrofluoric acid even after a crack is generated.

Note that in this specification and the like, the vicinity of the crystal grain boundary refers to a region of approximately 10 nm from the grain boundary.

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material is the positive electrode active material 100 of one embodiment of the present invention that has an 03′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 100 of one embodiment of the present invention features in a small change in the crystal structure between a high voltage charged state and a discharged state. A material 50 wt % or more of which has the crystal structure that largely changes between a high voltage charged state and a discharged state is not preferable because the material cannot withstand charging and discharging with high voltage. In addition, it should be noted that an objective crystal structure is not obtained in some cases only by addition of additive elements. For example, although the positive electrode active material that is lithium cobalt oxide containing magnesium and fluorine is a commonality, the positive electrode active material has 60 wt % or more of the O3′ type crystal structure in some cases, and has 50 wt % or more of the H1-3 type crystal structure in other cases, when charged with high voltage. Furthermore, at a predetermined voltage, the positive electrode active material has almost 100 wt % of the O3′ type crystal structure, and with an increase in the predetermined voltage, the H1-3 type crystal structure is generated in some cases. Thus, to determine whether or not a positive electrode active material is the positive electrode active material 100 of one embodiment of the present invention, the crystal structure should be analyzed by XRD or other methods.

However, the crystal structure of a positive electrode active material in a high voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <<Charging Method>>

High-voltage charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material and a conductive additive are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated with the above conditions is subjected to constant current charging at 4.6 V and 0.5 C and then constant voltage charging until the current value reaches 0.01 C. Note that here, 1 C is set to 200 mA/g. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode active material enclosed in an airtight container with an argon atmosphere.

### <<XRD>>

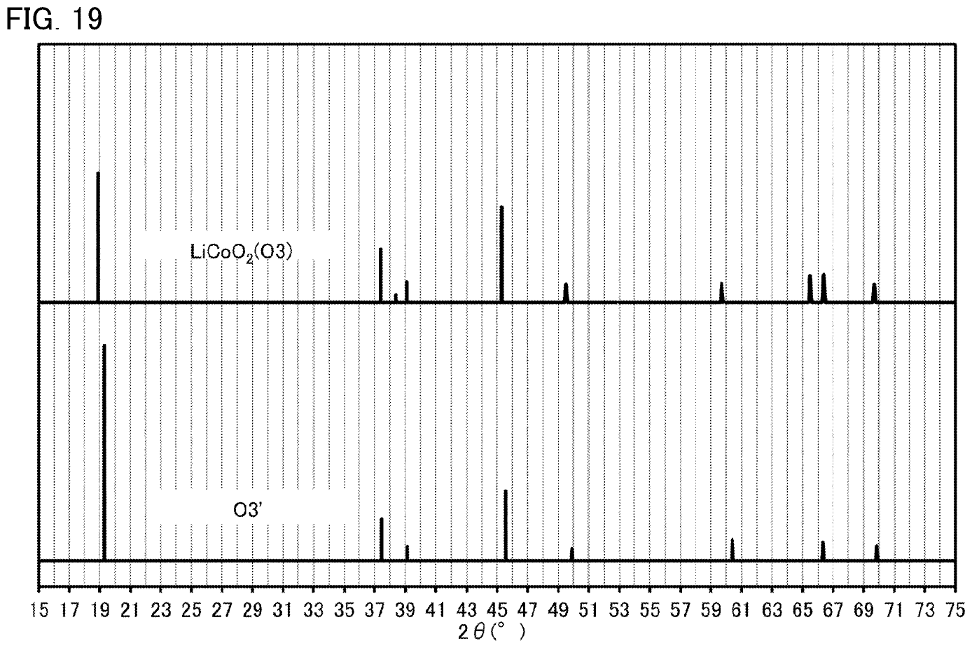

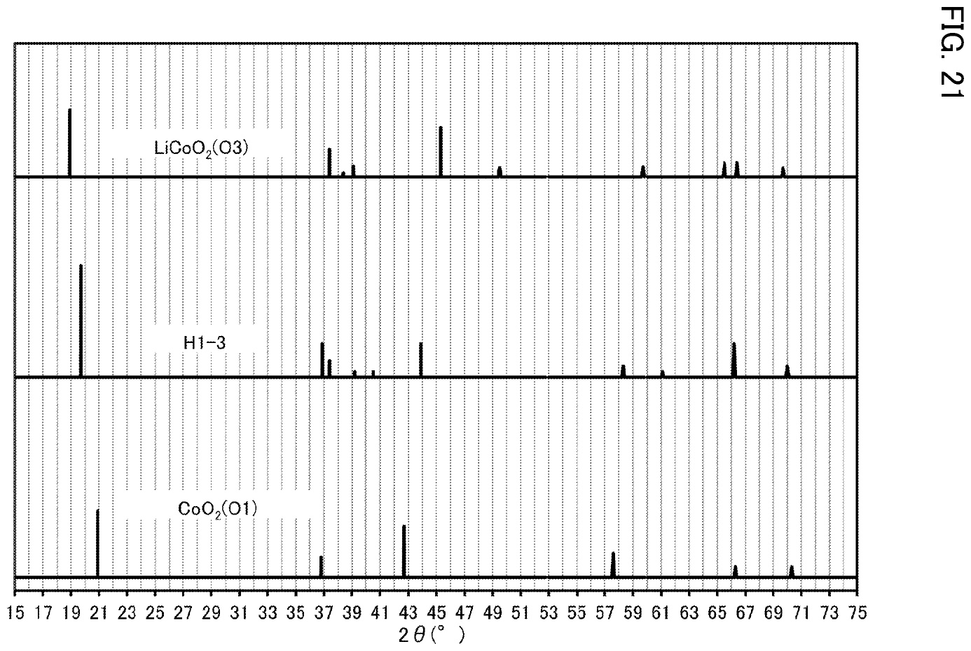

FIG. 19 and FIG. 21 show ideal powder XRD patterns with CuKα1 radiation that are calculated from models of the O3′ type crystal structure and the H1-3 type crystal structure. For comparison, ideal XRD patterns calculated from the crystal structure of LiCoO₂ O3 with x in LiₓCoO₂ being 1, the crystal structure of the H1-3 type, and the crystal structure of the trigonal O1 with x being 0 are also shown. Note that the patterns of LiCoO₂ O3 and CoO₂ O1 were made from crystal structure data obtained from the Inorganic Crystal Structure Database (ICSD) (see Non-Patent Document 5) with Reflex Powder Diffraction, which is a module of Materials Studio (BIOVIA). The range of 2θ was from 15° to 75°, the step size was 0.01, the wavelength λ1 was 1.540562×10⁻¹⁰ m, the wavelength λ2 was not set, and a single monochromator was used. The pattern of the H1-3 type crystal structure was similarly made from the crystal structure data disclosed in Non-Patent Document 3. The O3′ type crystal structure was estimated from the XRD pattern of the positive electrode active material of one embodiment of the present invention, the crystal structure was fitted with TOPAS ver. 3 (crystal structure analysis software produced by Bruker Corporation), and the XRD pattern of the O3′ type crystal structure was made in a similar manner to other structures.

As shown in FIG. 19, the O3′ type crystal structure exhibits diffraction peaks at 2θ of 19.30±0.20° (greater than or equal to 19.10° and less than or equal to) 19.50° and 2θ of 45.55±0.10° (greater than or equal to 45.45° and less than or equal to) 45.65°. More specifically, sharp diffraction peaks appear at 2θ of 19.30±0.10° (greater than or equal to 19.20° and less than or equal to) 19.40° and 2θ of 45.55±0.05° (greater than or equal to 45.50° and less than or equal to 45.60). By contrast, as shown in FIG. 21, the H1-3 type crystal structure and CoO₂ O1 do not exhibit peaks at these positions. Thus, the peaks at 2θ of 19.30±0.20° and 2θ of 45.55±0.10° in a high voltage charged state can be the features of the positive electrode active material 100 of one embodiment of the present invention.

It can be said that the positions of the XRD diffraction peaks exhibited at x=1 and x ≤0.24 are close to each other. More specifically, it can be said that a difference in the positions of two or more, preferably three or more of the main diffraction peaks between the crystal structures is 2θ=0.7 or less, preferably 2θ=0.5 or less.

Although the positive electrode active material 100 of one embodiment of the present invention has the O3′ type crystal structure when x in LiₓCoO₂ is small, the entire crystal structure of the positive electrode active material 100 is not necessarily the O3′ type. The positive electrode active material 100 may have another crystal structure or be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charging and discharging after the cycle measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material is only decreased to approximately one-tenth that of LiCoO₂ O3 in a discharged state. Thus, a clear peak of the O3′ type crystal structure can be observed when x in LiₓCoO₂ is small, even under the same XRD measurement conditions as those of a positive electrode before the charge and discharge. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described metal Z in addition to cobalt as long as the influence of the Jahn-Teller effect is small.

The range of the lattice constants where the influence of the Jahn-Teller effect is presumed to be small in the positive electrode active material is examined by XRD analysis.

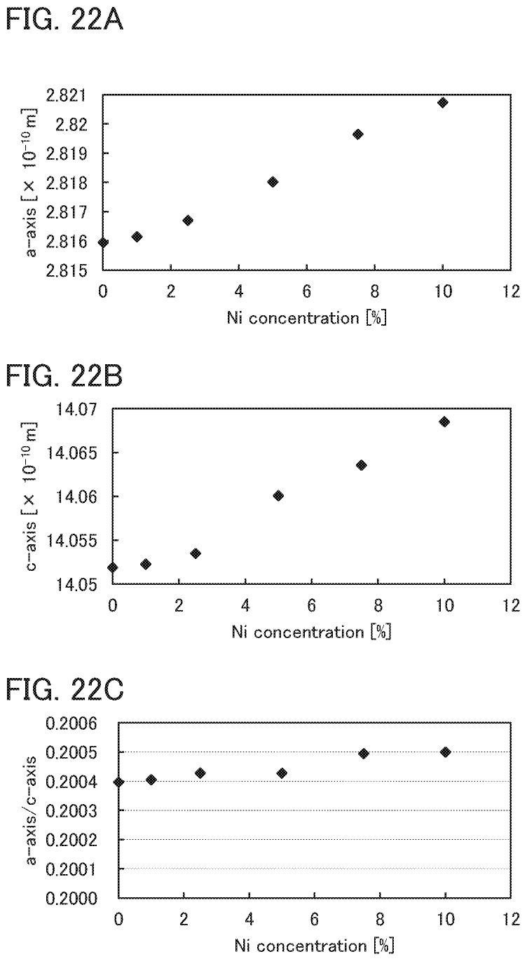

FIG. 22 shows the estimation results of the lattice constants of the a-axis and the c-axis by XRD in the case where the positive electrode active material of one embodiment of the present invention has a layered rock-salt crystal structure and contains cobalt and nickel. The positive electrode active material is formed through Step S11 to Step S34, which are described later, and at least a nickel source is used in Step S21. FIG. 22A shows the results of the a-axis, and FIG. 22B shows the results of the c-axis. Note that FIG. 22A and FIG. 22B show the results of a positive electrode active material powder obtained according to Step S11 to Step S34. That is, those are results obtained from the matter before being incorporated into a positive electrode. The nickel concentration (%) on the horizontal axis represents a nickel concentration proportion (percentage) with the sum of cobalt atoms and nickel atoms regarded as 100%. The nickel concentration proportion (percentage) can be obtained using a cobalt source and a nickel source.

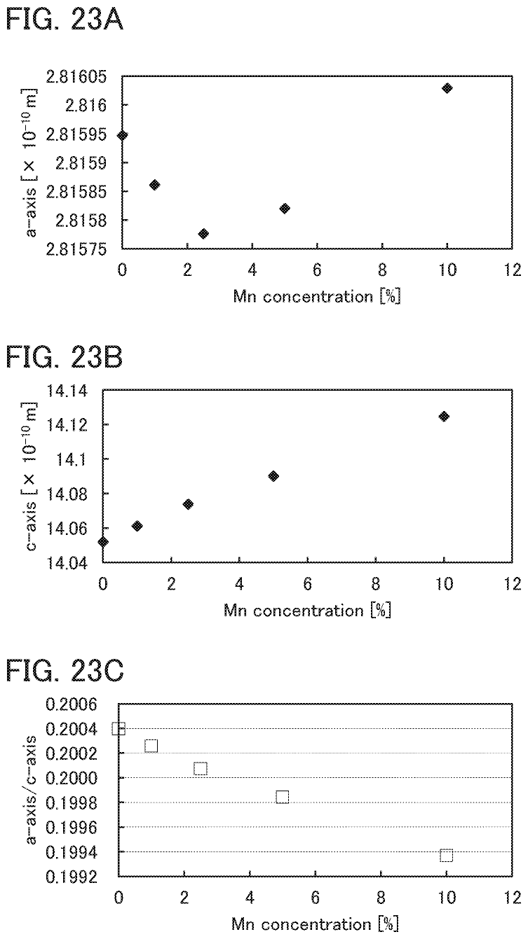

FIG. 23 shows the estimation results of the lattice constants of the a-axis and the c-axis using XRD patterns in the case where the positive electrode active material of one embodiment of the present invention has a layered rock-salt crystal structure and contains cobalt and manganese. The positive electrode active material is formed through Step S11 to Step S34, which are described later, and at least a manganese source is used in Step S21. FIG. 23A shows the results of the a-axis, and FIG. 23B shows the results of the c-axis. Note that FIG. 23A and FIG. 23B show the results on a positive electrode active material powder obtained according to Step S11 to Step S34. That is, those are results obtained on the matter before being incorporated into a positive electrode. The manganese concentration (%) on the horizontal axis represents a manganese concentration proportion (percentage) with the sum of cobalt atoms and manganese atoms regarded as 100%. The manganese concentration proportion (ratio) can be obtained using a cobalt source and a manganese source.

FIG. 22C shows values obtained by dividing the lattice constants of the a-axis by the lattice constants of the c-axis (a-axis/c-axis) in the positive electrode active material, whose results of the lattice constants are shown in FIG. 22A and FIG. 22B. FIG. 23C shows values obtained by dividing the lattice constants of the a-axis by the lattice constants of the c-axis (a-axis/c-axis) in the positive electrode active material, whose results of the lattice constants are shown in FIG. 23A and FIG. 23B.

As shown in FIG. 22C, the value of a-axis/c-axis tends to significantly change between nickel concentrations of 5% and 7.5% on the horizontal axis, indicating that the distortion of the a-axis becomes large. This distortion may be the Jahn-Teller distortion. It is suggested that an excellent positive electrode active material with small Jahn-Teller distortion can be obtained at a nickel concentration of lower than 7.5%.

FIG. 23A indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion 100a of the particle are not limited to the above ranges. In other words, the nickel concentration and the manganese concentration in the surface portion 100a of the particle may be higher than the above concentrations in some cases.

Preferable ranges of the lattice constants of the positive electrode active material of one embodiment of the present invention are examined above. In the layered rock-salt crystal structure of the particle of the positive electrode active material in a discharged state or a state where charging and discharging are not performed, which can be estimated from the XRD patterns, the a-axis lattice constant is preferably greater than 2.814×10⁻¹⁰ m and less than 2.817×10⁻¹⁰ m, and the c-axis lattice constant is preferably greater than 14.05×10⁻¹⁰ m and less than 14.07×10⁻¹⁰ m. The state where charging and discharging are not performed may be the state of a powder before the formation of a positive electrode of a secondary battery.

Alternatively, in the layered rock-salt crystal structure of particle of the positive electrode active material in the discharged state or the state where charging and discharging are not performed, the value obtained by dividing the a-axis lattice constant by the c-axis lattice constant (a-axis/c-axis) is preferably greater than 0.20000 and less than 0.20049.

Alternatively, when the layered rock-salt crystal structure of the particle of the positive electrode active material in the discharged state or the state where charging and discharging are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases. Note that the peaks appearing in the powder XRD patterns reflect the crystal structure of the inner portion 100b of the positive electrode active material 100, which accounts for the majority of the volume of the positive electrode active material 100. The crystal structure of the surface portion 100a or the like can be analyzed by electron diffraction of a cross section of the positive electrode active material 100, for example.

### <<XPS>>

A region from the surface to a depth of 2 nm to 8 nm inclusive (normally, approximately 5 nm) can be analyzed by X-ray photoelectron spectroscopy (XPS); thus, the concentration of each element in approximately half of the surface portion 100a can be quantitatively analyzed. The bonding states of the elements can be analyzed by narrow scanning. Note that the quantitative accuracy of XPS is approximately ±1 atomic % in many cases. The lower detection limit is approximately 1 atomic % but depends on the element.

When the positive electrode active material 100 of one embodiment of the present invention is subjected to XPS analysis, the number of atoms of the additive element is preferably greater than or equal to 1.6 times and less than or equal to 6.0 times, further preferably greater than or equal to 1.8 times and less than 4.0 times the number of atoms of the transition metal. When the additive element is magnesium and the transition metal is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of a halogen such as fluorine is preferably greater than or equal to 0.2 times and less than or equal to 6.0 times, further preferably greater than or equal to 1.2 times and less than or equal to 4.0 times the number of atoms of the transition metal.

In the XPS analysis, monochromatic aluminum can be used as an X-ray source, for example. An extraction angle is, for example, 45°.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentration of the additive element that preferably exists in the surface portion 100a in a large amount, such as magnesium or aluminum, measured by XPS or the like is preferably higher than the concentration measured by inductively coupled plasma mass spectrometry (ICP-MS), glow discharge mass spectrometry (GD-MS), or the like.

When a cross section is exposed by processing and analyzed by TEM-EDX, the concentration of magnesium or aluminum in the surface portion 100a is preferably higher than that in the inner portion 100b. An FIB (Focused Ion Beam) can be used for the processing, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals, not be unevenly distributed in the surface portion 100a but be distributed in the entire positive electrode active material 100. Note that one embodiment of the present invention is not limited thereto in the case where the above-described region where the excess additive element is unevenly distributed exists.

<<Charge Curve and dQ/dV Curve>>

An unbalanced phase change is presumed to occur around a peak in a dQ/dV curve obtained by differentiating capacitance (Q) with voltage (V) (dQ/dV) from the charge curve, resulting in a large change in the crystal structure. Note that in this specification and the like, an unbalanced phase change refers to a phenomenon that causes a nonlinear change in physical quantity.

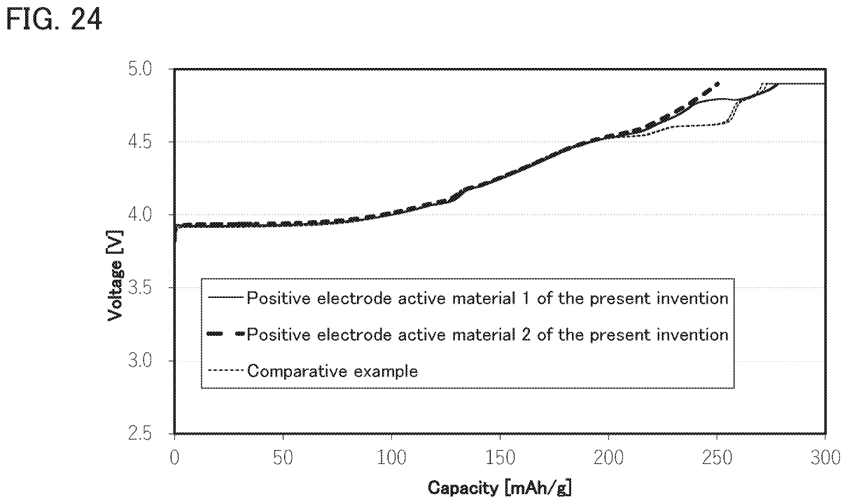

FIG. 24 shows charge curves of secondary batteries using the positive electrode active materials of embodiments of the present invention and a secondary battery using a positive electrode active material of a comparative example.

A positive electrode active material 1 of the present invention in FIG. 24 was formed by the formation method shown in FIG. 14A and FIG. 14B. More specifically, the positive electrode active material 1 was formed by using lithium cobalt oxide (C-10N, manufactured by Nippon Chemical Industrial Co., Ltd.) as LiM1O₂ in Step S14, mixing LiF and MgF₂, and performing heating. With the use of the positive electrode active material, a half cell was fabricated and charged in a manner similar to that of the fabrication and charging for the XRD measurement.

A positive electrode active material 2 of the present invention in FIG. 24 was formed by the formation method shown in FIG. 14A and FIG. 14C. More specifically, the positive electrode active material 2 was formed by using lithium cobalt oxide (C-10N, manufactured by Nippon Chemical Industrial Co., Ltd.) as LiM1O₂ in Step S14, mixing LiF, MgF₂, Ni(OH)₂, and Al(OH)₃, and performing heating. With the use of the positive electrode active material, a half cell was fabricated and charged in a manner similar to that of the fabrication and charging for the XRD measurement.

The positive electrode active material of the comparative example in FIG. 24 was formed by forming a layer containing aluminum on a surface of lithium cobalt oxide (C-5H, manufactured by Nippon Chemical Industrial Co., Ltd.) by a sol-gel method and performing heating at 500° C. for 2 hours. With the use of the positive electrode active material, a half cell was fabricated and charged in a manner similar to that of the fabrication and charging for the XRD measurement.

The charge curves in FIG. 24 are of the half cells charged up to 4.9 V at 25° C. at 10 mAh/g. Note that n of the positive electrode active material 1 and the comparative example is 2, and n of the positive electrode active material 2 is 1.

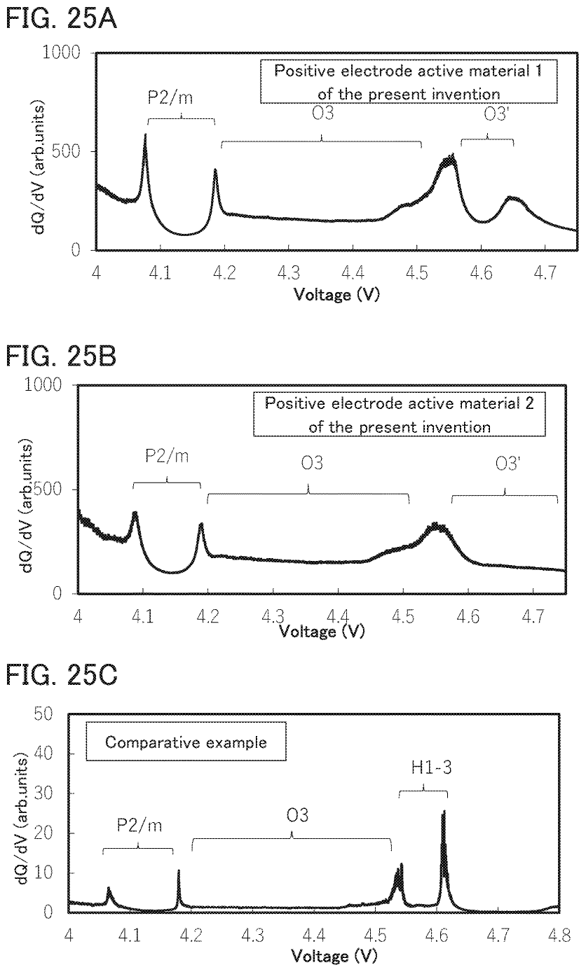

FIG. 25A to FIG. 25C show dQ/dV curves showing the amount of change in voltage with respect to charge capacity, which are calculated from the data of FIG. 24. FIG. 25A shows a dQ/dV curve of the half cell using the positive electrode active material 1 of one embodiment of the present invention, FIG. 25B shows a dQ/dV curve of the half cell using the positive electrode active material 2 of one embodiment of the present invention, and FIG. 25C shows a dQ/dV curve of the half cell using the positive electrode active material of the comparative example.

As apparent from FIG. 25A to FIG. 25C, in each of the embodiments of the present invention and the comparative example, peaks were observed at voltages of approximately 4.06 V and approximately 4.18 V, and the change in capacity with respect to voltage was nonlinear. The crystal structure with x in LiₓCoO₂ being 0.5 (space group P2/m) is probably between these two peaks. In the space group P2/m with x in LiₓCoO₂ being 0.5, lithium is arranged as shown in FIG. 20. It is suggested that energy is used for this lithium arrangement, and thus the change in capacity with respect to voltage becomes nonlinear.

In addition, in the comparative example of FIG. 25C, large peaks were observed at approximately 4.54 V and approximately 4.61 V. An H1-3 phase type crystal structure probably exists between these two peaks.

Meanwhile, in the secondary batteries of embodiments of the present invention of FIG. 25A and FIG. 25B showing extremely excellent cycle performance, a small peak was observed at approximately 4.55 V but it was not clear. Moreover, the positive electrode active material 2 does not show the next peak at voltages exceeding 4.7 V, suggesting that the O3′ structure is kept. Thus, in the dQ/dV curves of the secondary batteries using the positive electrode active materials of embodiments of the present invention, some peaks might be extremely broad or small at 25° C. In such a case, there is a possibility that two crystal structures coexist. For example, two phases of O3 and O3′ may coexist, or two phases of O3′ and H1-3 may coexist.

<<Discharge Curve and dQ/dV Curve>>

Moreover, when the positive electrode active material of one embodiment of the present invention is discharged at a low rate of, for example, 0.2 C or less after high-voltage charging, a characteristic change in voltage appears just before the end of discharging, in some cases. This change can be clearly observed by the fact that at least one peak appears within the range to 3.5 V at a voltage lower than that of a peak which appears around 3.9 V in a dQ/dV curve calculated from a discharge curve.

### <<Surface Roughness and Specific Surface Area>>

The positive electrode active material 100 of one embodiment of the present invention preferably has a smooth surface with little unevenness. A smooth surface with little unevenness indicates favorable distribution of the additive element in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with a magic hand tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness in at least 400 nm of the particle periphery of the positive electrode active material.

On the particle surface of the positive electrode active material 100 of this embodiment, roughness (RMS: root-mean-square surface roughness), which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes. The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area A_{R} to the ideal specific surface area Aᵢ obtained from the median diameter D50 (A_{R}/Aᵢ) is preferably less than or equal to 2.

### [Defects in Positive Electrode Active Material]

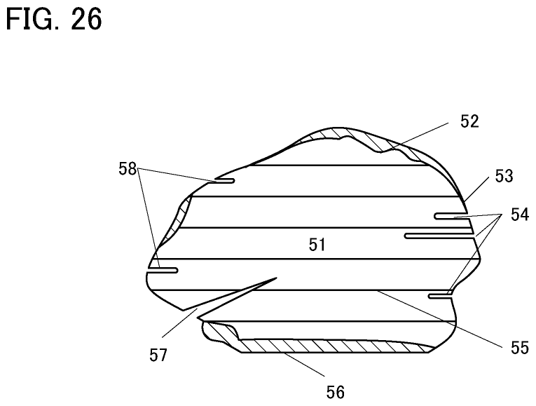

Examples of defects that can be generated in the positive electrode active material are shown in FIG. 26 to FIG. 36. An effect of inhibiting the generation of the defects can be expected in the positive electrode active material of one embodiment of the present invention.

With charging and discharging under a high-voltage condition at 4.5 V or higher or at a high temperature (45° C. or higher), a progressive defect such as a pit might be generated in the positive electrode active material. In addition, a crevice-like defect such as a crack is sometimes generated by expansion and contraction of the positive electrode active material due to charging and discharging. FIG. 26 shows a schematic cross-sectional view of a positive electrode active material 51. Although pits 54 and 58 in the positive electrode active material 51 are illustrated as holes, their opening shapes are not circular and have a depth. Moreover, the positive electrode active material 51 sometimes has a crack 57. The positive electrode active material 51 has a crystal plane 55 and may have a depression 52. It is preferable that barrier layers 53 and 56 cover the positive electrode active material 51, and they may be separated. The barrier layer 53 covers the depression 52.

A positive electrode active material of a lithium-ion secondary battery is LCO or NCM typically, and can also be referred to as an alloy containing a plurality of metal elements (cobalt, nickel, and the like). At least one of the plurality of positive electrode active materials has a defect and the defect might change before and after charge and discharge. When used in a secondary battery, a positive electrode active material might undergo a phenomenon such as chemical or electrochemical erosion or degradation in the material quality due to environmental substances (e.g., electrolyte solution) surrounding the positive electrode active material. This degradation does not occur uniformly in the surface of the positive electrode active material but occurs locally in a concentrated manner, and a defect is formed deeply from the surface toward the inner portion, for example, by repeated charging and discharging of the secondary battery.

Progress of a defect in a positive electrode active material to form a hole can be referred to as pitting corrosion.

In this specification, a crack and a pit are different from each other. Immediately after formation of a positive electrode active material, a crack can exist but a pit does not exist. A pit can also be regarded as a hole formed by extraction of some layers of cobalt or oxygen due to charging and discharging under a high-voltage condition at 4.5 V or higher or at a high temperature (45° C. or higher), i.e., a portion from which cobalt has been eluted. Therefore, there is no pit immediately after formation of the positive electrode active material. A crack refers to a surface newly generated by application of physical pressure or a crevice generated owing to a grain boundary. A crack might be caused by expansion and contraction of the particle due to charging and discharging. Furthermore, a pit might be generated from a crack or a cavity in the particle.

### <Disassembly of Secondary Battery>

Fifty cycles of charge-discharge tests were performed. The discharge capacity at the 50th cycle was reduced to be lower than 40% of that at the 1st cycle. The secondary battery was disassembled, and the positive electrode was extracted. The disassembly was performed in an argon atmosphere. After the disassembly, washing with DMC was performed, and then the solvent was volatilized. The positive electrode subjected to 50 cycles of charge-discharge tests and a positive electrode before being incorporated into the secondary battery, i.e., a positive electrode immediately after being formed, were observed.

### <SEM Observation>

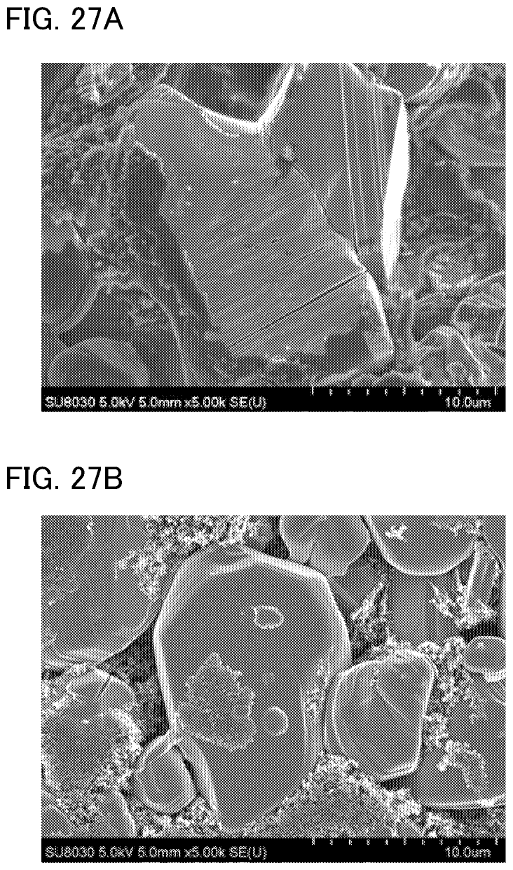

The positive electrodes were observed with a scanning electron microscope (SEM). FIG. 27A shows a SEM image of the positive electrode of the secondary battery after being subjected to the 50 cycles. FIG. 27B shows a SEM image of the positive electrode before being incorporated into the secondary battery. An SU8030 scanning electron microscope produced by Hitachi High-Tech Corporation was used for the SEM observation.

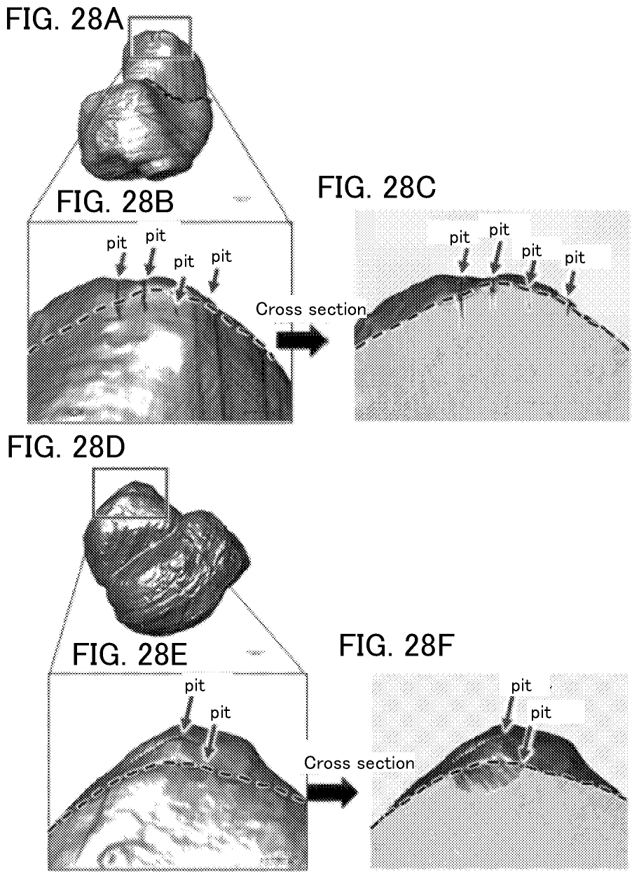

Next, the positive electrode active material was subjected to cross-section processing by an FIB, and the cross-section of the positive electrode active material was observed with a SEM. By repeating the cross-section processing by an FIB and the SEM observation, three-dimensional data on the structure shown in FIG. 28A or FIG. 28D can be obtained. Note that XVision 210B produced by Hitachi High-Tech Corporation was used for the FIB processing and the SEM observation.

FIG. 28B shows enlarged part of the front view of the three-dimensional data in FIG. 28A, and FIG. 28C shows its cross section. Three-dimensional data on a side surface obtained by rotating the three dimensional data of FIG. 28A corresponds to FIG. 28D. FIG. 28E shows enlarged part of FIG. 28D, and FIG. 28F shows its sliced cross section. As shown in FIG. 28F, a pit is not a hole but have a shape that can be referred to as a groove having a width or a split.

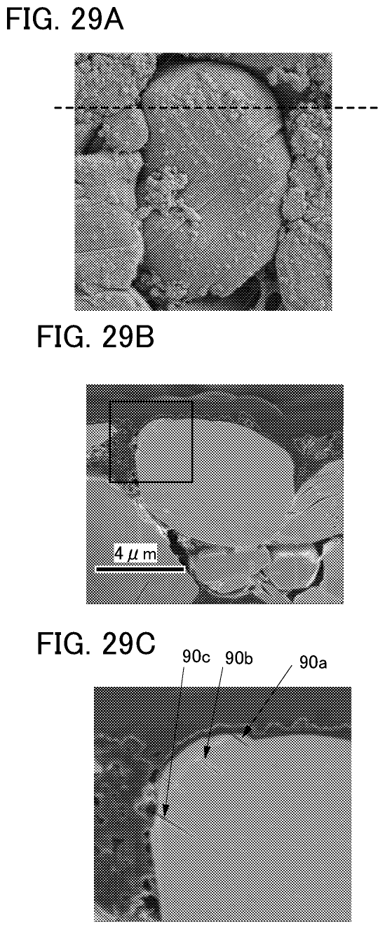

FIG. 29A shows a SEM image of the top surface of the positive electrode of the secondary battery after being subjected to the 50 cycles. FIG. 29B is a cross-sectional view taken along a dashed line in FIG. 29A. FIG. 29C is an enlarged view of a portion surrounded by a frame in FIG. 29B. Pits 90a, 90b, and 90c are shown in FIG. 29C.

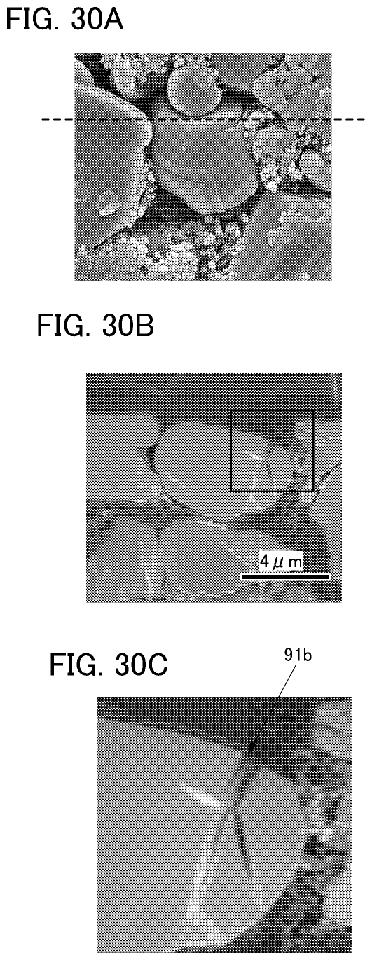

FIG. 30A shows a SEM image of the top surface of the positive electrode before being incorporated into the secondary battery. FIG. 30B is a cross-sectional view taken along a dashed line in FIG. 30A. FIG. 30C is an enlarged view of a portion surrounded by a frame in FIG. 30B. A crack 91b is shown in FIG. 30C.

As described above, pits and a crack were observed in the positive electrode after being subjected to the 50 cycles.

### <STEM Observation>

Then, a cross section of the positive electrode of the secondary battery after being subjected to the 50 cycles was observed with a scanning transmission electron microscope (STEM). FIB was used for processing the sample for cross-sectional observation.

### <EDX Analysis>

The positive electrode of the secondary battery after being subjected to the 50 cycles was evaluated by energy dispersive X-ray spectroscopy (EDX).

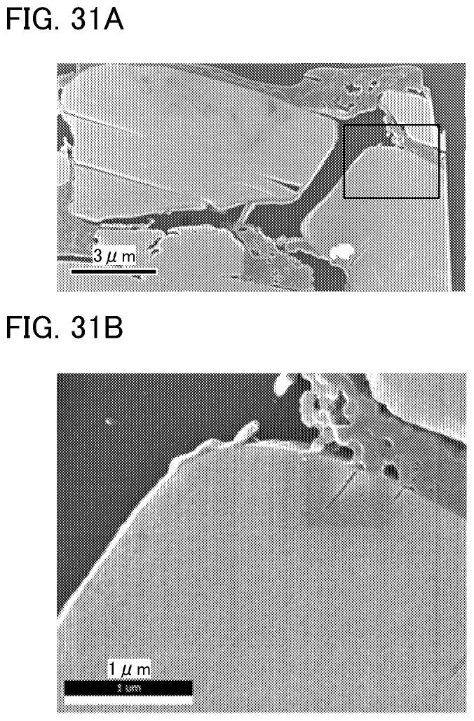

FIG. 31A shows a cross-sectional STEM image of the positive electrode. FIG. 31B is an enlarged view of a portion surrounded by a frame in FIG. 31A.

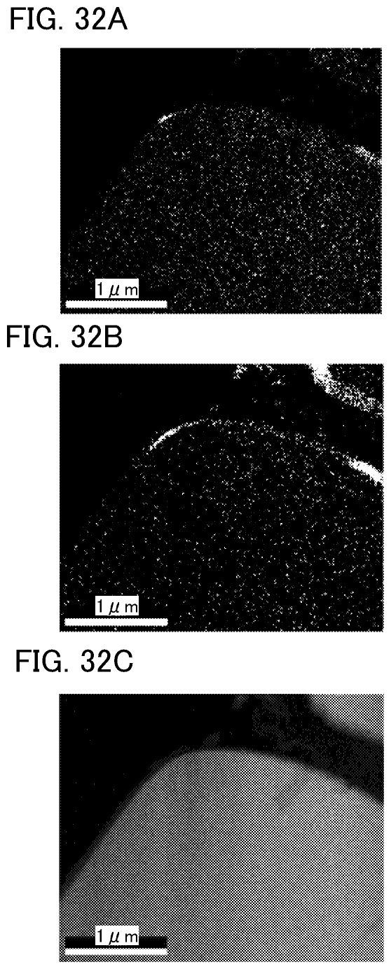

FIG. 32A to FIG. 32C show EDX maps of the region shown in FIG. 31B. FIG. 32A, FIG. 32B, and FIG. 32C show the EDX maps of magnesium, aluminum, and cobalt, respectively. For the EDX analysis, HD-2700 produced by Hitachi High-Technologies Corporation was used. The accelerating voltage was set to 200 kV. The EDX mapping suggests that magnesium and aluminum exist in at least part of the surface portion of the particle of the positive electrode active material.

### <Nanobeam Electron Diffraction>

Next, the crystal structures of the grain boundary of lithium cobalt oxide and the vicinity thereof were analyzed by nanobeam electron diffraction.

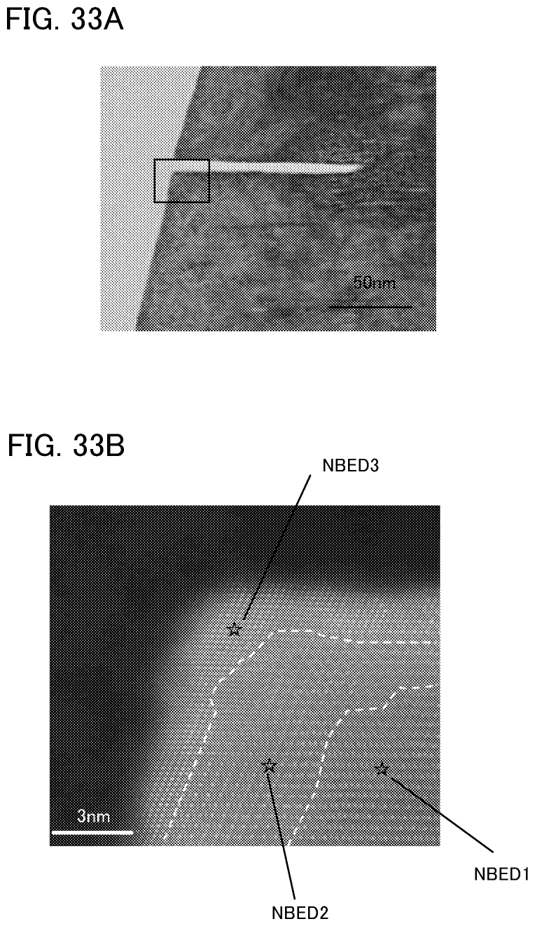

FIG. 33A is a cross-sectional TEM image of a degraded lithium cobalt oxide after being subjected to 50 cycles. FIG. 33B is an enlarged view of a portion surrounded by black lines in FIG. 33A. Portions analyzed by nanobeam electron diffraction are denoted by a star NBED1, a star NBED2, and a star NBED3 in FIG. 33B.

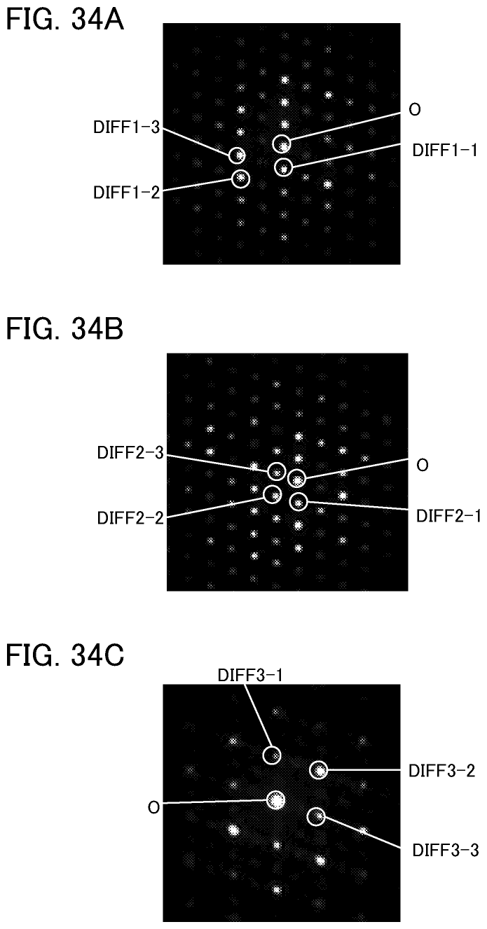

FIG. 34A shows a nanobeam electron diffraction pattern of the star NBED1 portion. Transmitted light is denoted by O, and some of diffraction spots are denoted by DIFF1-1, DIFF1-2, and DIFF1-3 in the figure. From the analysis on the star NBED1 portion, the interplanar spacing of DIFF1-1, the interplanar spacing of DIFF1-2, and the interplanar spacing of DIFF1-3 were calculated as 0.475 nm, 0.199 nm, and 0.238 nm, respectively. The interplanar angles were ∠1O2=55°, ∠1O3=80°, and ∠2O3=24°. In this case, the incident direction of the electron beam is [0-10] and the interplanar spacings and the interplanar angles suggest that DIFF1-1 is 10-2 of a layered rock-salt crystal, DIFF1-2 is 10-5 of a layered rock-salt crystal, and DIFF1-3 is 00-3 of a layered rock-salt crystal, which indicates that a crystal structure of LiCoO₂ is included.

FIG. 34B shows a nanobeam electron diffraction pattern of the star NBED2 portion. Transmitted light is denoted by O, and some of diffraction spots are denoted by DIFF2-1, DIFF2-2, and DIFF2-3 in the figure. From the analysis on the star NBED2 portion, the interplanar spacing of DIFF2-1, the interplanar spacing of DIFF2-2, and the interplanar spacing of DIFF2-3 were calculated as 0.468 nm, 0.398 nm, and 0.472 nm, respectively. The interplanar angles were ∠1O2=54°, ∠1O3=110°, and ∠2O3=56°. The interplanar spacings and the interplanar angles suggest that DIFF2-1, DIFF2-2, and DIFF2-3 are each a spinel crystal, which indicates that a crystal structure of Co₃₀₄ or a crystal structure of LiCo₂O₄ is included.

FIG. 34C shows a nanobeam electron diffraction pattern of the star NBED3 portion. Transmitted light is denoted by O, and some of diffraction spots are denoted by DIFF3-1, DIFF3-2, and DIFF3-3 in the figure. From the analysis on the star NBED1 portion, the interplanar spacing of DIFF3-1, the interplanar spacing of DIFF3-2, and the interplanar spacing of DIFF3-3 were calculated as 0.241 nm, 0.210 nm, and 0.246 nm, respectively. The interplanar angles were ∠1O2=55°, ∠1O3=110°, and ∠2O3=55°. The interplanar spacings and the interplanar angles suggest that DIFF3-1, DIFF3-2, and DIFF3-3 are each a rock-salt crystal, which indicates that a crystal structure of CoO is included.

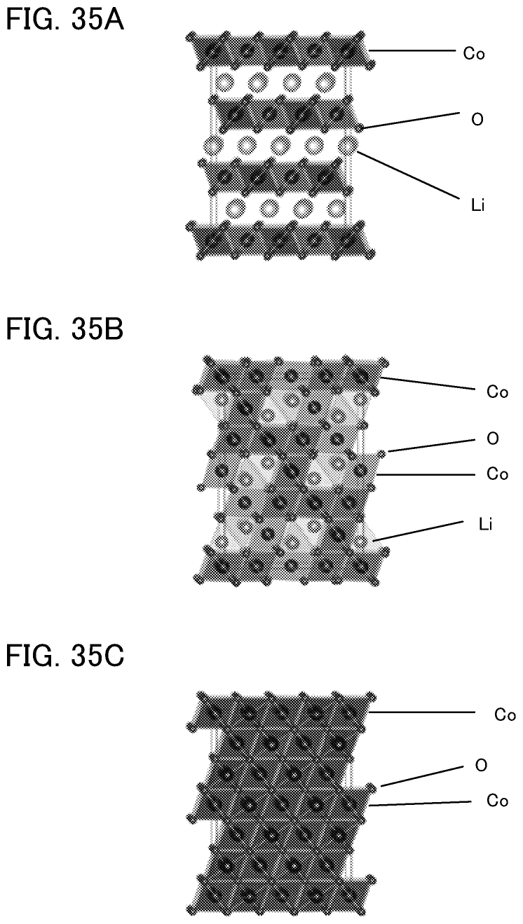

FIG. 35A shows a crystal structure of LiCoO₂, which is a layered rock-salt structure. FIG. 35B shows a crystal structure of LiCo₂O₄, which is a spinel crystal structure. FIG. 35C shows a crystal structure of CoO, which is a rock-salt crystal structure.

### <Slipping>

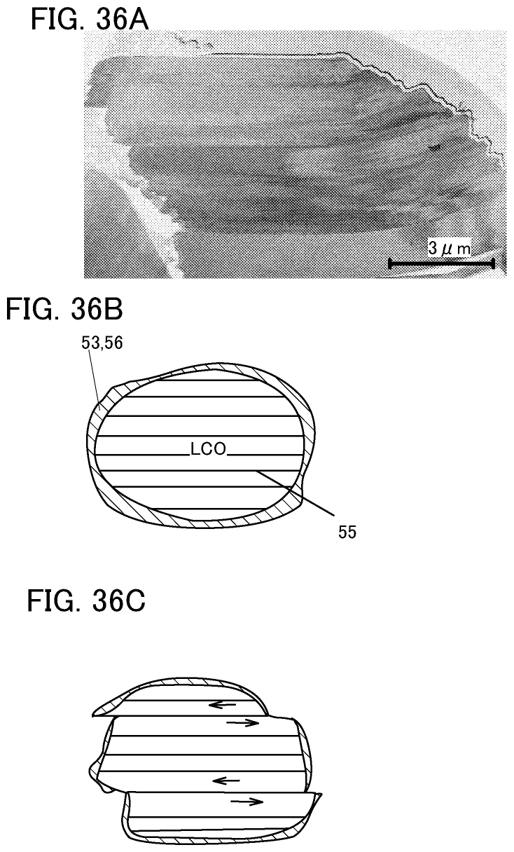

FIG. 36A is a cross-sectional STEM image of part of a positive electrode active material layer at the time after slurry to be the positive electrode active material is applied to a current collector and pressing is performed. There is a step on the particle surface in a direction (c-axis direction) perpendicular to lattice fringes owing to the pressing, and an evidence of deformation is found to be along the lattice fringe direction (ab plane direction).

FIG. 36B is a schematic cross-sectional view of the particle before being pressed. In the particle before being pressed, a barrier layer exists relatively uniformly on the particle surface along the direction perpendicular to the lattice fringes.

FIG. 36C is a schematic cross-sectional view of the particle after being pressed. Owing to the press step, distortion is generated in the lattice fringe direction (ab plane direction). Similarly, a barrier layer has a plurality of steps and is not uniform. With regard to the distortion in the ab plane direction, on a particle surface opposite to the surface where unevenness is observed, similarly shaped unevenness is also generated, and part of the particle has distortion in the ab plane direction.

The plurality of steps shown in FIG. 36C are observed as a stripe pattern on the particle surface. Such a stripe pattern on the particle surface, which is observed as the steps on the particle surface where distortion is caused owing to pressing, is called slipping (stacking fault). The slipping of the particle makes the barrier layer uneven, which might cause deterioration. Thus, it is desirable that the positive electrode active material have little or no slipping.

This embodiment can be implemented in appropriate combination with the other embodiments.

### Embodiment 4

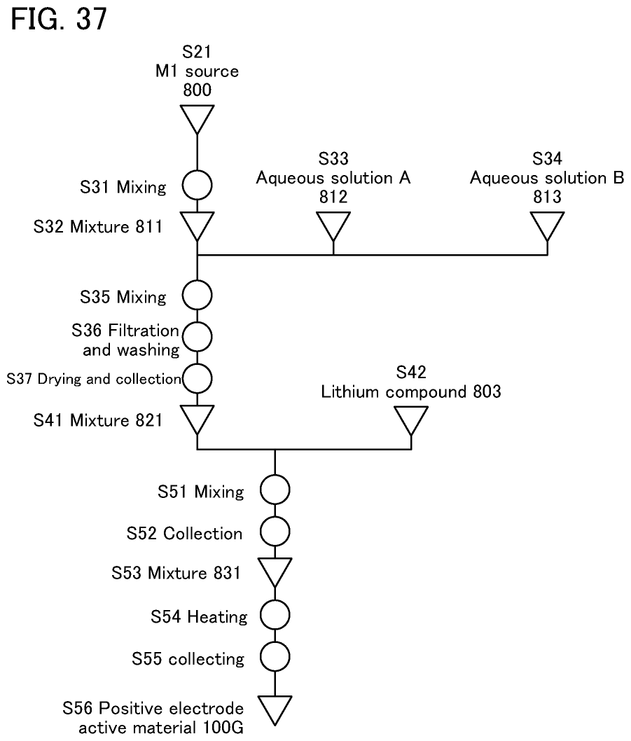

In this embodiment, an example of a method of forming a positive electrode active material of one embodiment of the present invention will be described with reference to FIG. 37 to FIG. 47.

### [Method 1 for Forming Positive Electrode Active Material]

An example of a method for forming a positive electrode active material of one embodiment of the present invention will be described below with reference to FIG. 37.

A transition metal M1 source 800 is prepared in Step S21 of FIG. 37.

As the transition metal M1, at least one of manganese, cobalt, and nickel can be used, for example. As the transition metal M1, for example, cobalt alone; nickel alone; two metals of cobalt and manganese; two metals of cobalt and nickel; or three metals of cobalt, manganese, and nickel may be used. As the transition metal M1 source, an aqueous solution containing the transition metal M1 is prepared.

As the transition metal M1 source 800, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M1 source 800 used in synthesis, a high-purity material is preferably used. Specifically, in the case of using the aqueous solution containing the transition metal M1, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

When metals that can form a layered rock-salt composite oxide are used, cobalt, manganese, and nickel are preferably mixed at the ratio at which the composite oxide can have a layered rock-salt crystal structure.

Next, in Step S31, the transition metal M1 source 800 is mixed, whereby a mixture 811 of Step S32 is obtained.

Next, an aqueous solution A 812 and an aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 of Step S32, the aqueous solution A 812, and the aqueous solution B 813 are mixed.

As a mixing method in Step S35, a mixing method in which the mixture 811 of Step S32 and the aqueous solution B 813 are dripped into the aqueous solution A 812 that is put in a reaction container can be used. While the mixture 811 of Step S32 is dripped at a constant rate, the aqueous solution B 813 is desirably dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Alternatively, as the mixing method in Step S35, a mixing method in which the aqueous solution A 812 and the aqueous solution B 813 are dripped into the mixture 811 of Step S32 that is put in a reaction container can be used. It is preferred to adjust the dripping rates of the aqueous solution A 812 and the aqueous solution B 813 in order to keep the concentration of hydroxyl groups and the concentration of dissolved ions of the aqueous solution A 812 in the reaction container in predetermined ranges. In the mixing of Step S35, it is desirable that the solution in the reaction container be stirred with a stirring blade or a stirrer, and that dissolved oxygen in the solution in the reaction container, the mixture 811 in Step S32, the aqueous solution A 812, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where the aqueous solution A 812 is not used in the mixing method in Step S35 is described. A certain amount of the aqueous solution B 813 is dripped and added to the mixture 811 of Step S32 that is put in a reaction container. In the mixing of Step S35, it is desirable that the solution in the reaction container be stirred with a stirring blade or a stirrer, and that dissolved oxygen in the solution in the reaction container, the mixture 811 of Step S32, and the aqueous solution B 813 be removed by N₂ bubbling. In the mixing of Step S35, the temperature of the solution in the reaction container is preferably higher than or equal to 40° C. and lower than or equal to 80° C., further preferably higher than or equal to 50° C. and lower than or equal to 70° C.

The case where pure water is used in addition to the mixture 811 of Step S32, the aqueous solution A 812, and the aqueous solution B 813 in the mixing method in Step S35 is described. While the mixture 811 of Step S32 and the aqueous solution A 812 are dripped into pure water that is put in a reaction container at constant rates, the aqueous solution B 813 can be dripped as appropriate so that the pH of the mixed solution in the reaction container is kept in a predetermined range. In the mixing of Step S35, it is desirable that the solution in the reaction container be stirred with a stirring blade or a stirrer, and that dissolved oxygen in the solution in the reaction container, the mixture 811 of Step S32, the aqueous solution A 812, and the aqueous solution B 813 be removed by N₂ bubbling. In the mixing of Step S35, the pH in the reaction container is preferably greater than or equal to 9 and less than or equal to 11, further preferably greater than or equal to 10.0 and less than or equal to 10.5. In the mixing of Step S35, the temperature of the solution in the reaction container is preferably higher than or equal to 40° C. and lower than or equal to 80° C., further preferably higher than or equal to 50° C. and lower than or equal to 70° C.

Next, in Step S36, a solution that is formed by the mixing in Step S35 and contains a hydroxide containing the transition metal M1 is filtered and then washed with water. It is desirable that the water used for the washing be pure water containing few impurities, with a specific resistance of preferably 1M Ω·cm or higher, further preferably 10M Ω·cm or higher, still further preferably 15M Ω·cm or higher. By using pure water including few impurities for the washing, impurities included in the hydroxide containing the transition metal M1 can be removed, and a high-purity hydroxide containing the transition metal M1 can be obtained as a reaction precursor.

Next, the hydroxide containing the transition metal M1 after the washing in Step S36 is dried and collected, whereby a mixture 821 of Step S41 is obtained.

Next, a lithium compound 803 is prepared in Step S42, and the mixture 821 of Step S41 and the lithium compound 803 are mixed in Step S51. After the mixing, the mixture is collected in Step S52 to give a mixture 831 of Step S53. The mixing can be performed by a dry process or a wet process. For example, a ball mill, a bead mill, or the like can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. Note that in Step S42, the peripheral speed is set to 838 mm/s (the rotational frequency is 400 rpm, and the diameter of the ball mill container is 40 mm).

As the lithium compound 803, lithium hydroxide, lithium carbonate, lithium nitrate, or lithium fluoride can be used, for example.

For the lithium compound 803 used in synthesis, a high-purity material is preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

Next, in Step S54, the mixture 831 of Step S53 is heated. The heating is preferably performed at higher than or equal to 700° C. and lower than 1100° C., further preferably at higher than or equal to 800° C. and lower than or equal to 1000° C., still further preferably at higher than or equal to 800° C. and lower than or equal to 950° C.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rising rate is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S54 is not essential.

Note that a crucible or a saggar used at the time of heating in Step S54 is preferably made of alumina (aluminum oxide), mullite cordierite, magnesia, or zirconia, i.e., preferably includes a highly heat resistant material. An alumina crucible is preferable because it is a material into which impurities do not enter. In this embodiment, a crucible made of alumina with a purity of 99.9% is preferably used. The heating is preferably performed with the crucible or the saggar covered with a lid. This can prevents volatilization of the materials.

It is suitable to collect the materials subjected to the heating in Step S54 after the materials are transferred from the crucible to a mortar because impurities are prevented from entering the materials. The mortar is suitably made of a material into which impurities do not enter. Specifically, it is preferable to use a mortar made of alumina with a purity of 90 wt % or higher, preferably 99 wt % or higher.

Next, the materials baked in the above step are collected in Step S55, whereby a positive electrode active material 100G of Step S56 is obtained. The positive electrode active material 100G can be used as the first material 100x described in Embodiment 1 and Embodiment 2.

### [Method 2 for Forming Positive Electrode Active Material]

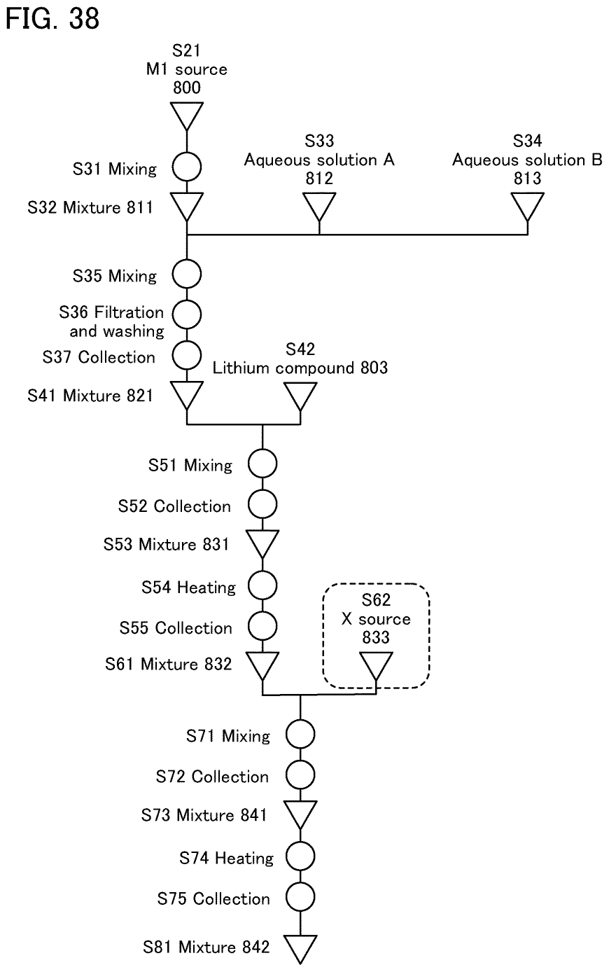

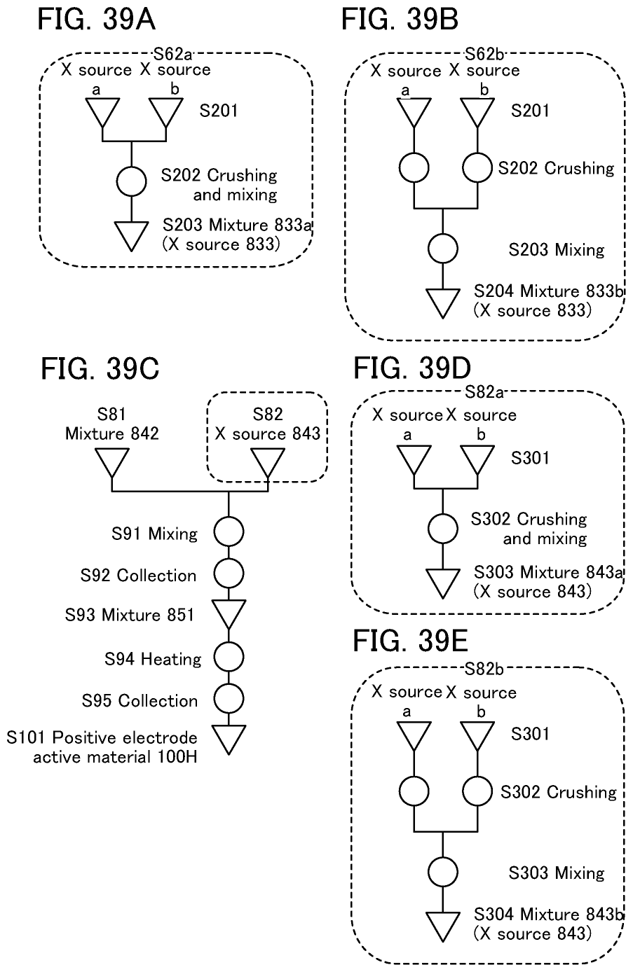

Another example of a method for forming a positive electrode active material of one embodiment of the present invention will be described with reference to FIG. 38 and FIG. 39A to FIG. 39E.

Step S21 to Step S55 of FIG. 38 can be performed in the same manner as those in the method shown in FIG. 37.

Next, in Step S62, an additive element X source 833 is prepared.

As the additive element X source, one or more selected from nickel, cobalt, magnesium, calcium, chlorine, fluorine, bromine, aluminum, manganese, titanium, zirconium, yttrium, vanadium, iron, chromium, niobium, lanthanum, hafnium, zinc, silicon, sulfur, phosphorus, boron, and arsenic can be used. As the additive element X source 833 of Step S62, any one or more of an aqueous solution containing the additive element X, an alkoxide containing the additive element X, and a solid compound containing the additive element X can be used. For example, as shown in S62a or S62b in FIG. 39A and FIG. 39B, one or more solid compounds each containing the additive element X may be prepared, crushing and mixing may be performed, and the mixture may be used as the additive element X source 833 of Step S62 in FIG. 38. In the case of using one or more solid compounds each containing the additive element X, mixing may be performed after crushing, crushing may be performed after mixing, or the solid compounds may be used as the additive element X source 833 of Step S62 without being subjected to crushing.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

In the case where the mixing and crushing step is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used.

Next, in Step S71, a mixture 832 of Step S61 and the additive element X source 833 of Step S62 are mixed. After the mixing, the mixture is collected in Step S72 to give a mixture 841 of Step S73. The mixing can be performed by a dry process or a wet process. For example, a ball mill, a bead mill, or the like can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. Note that in Step S71, the peripheral speed is set to 838 mm/s (the rotational frequency is 400 rpm, and the diameter of the ball mill container is 40 mm).

Next, in Step S74, the mixture 841 of Step S73 is heated. The temperature of the heating in Step S74 is preferably higher than or equal to 500° C. and lower than or equal to 1100° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

As the heating in Step S74, heating by a roller hearth kiln may be performed. When heat treatment is performed by a roller hearth kiln, the mixture 841 may be processed using a heat-resistant container having a lid.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rising rate is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected in Step S75, whereby a mixture 842 of Step S81 is obtained. The mixture 842 obtained in Step S81 can be used as the positive electrode active material 100. The mixture 842 obtained in Step S81 can be provided for steps after Step S81 shown in FIG. 39C.

Next, the steps after Step S81 shown in FIG. 39C are described. In Step S82, an additive element X source 843 is prepared.

The additive element X added in Step S82 can be selected from the above-described additive element X to be used. As the additive element X source 843 of Step S82, any one or more of an aqueous solution containing the additive element X, an alkoxide containing the additive element X, and a solid compound containing the additive element X can be used. For example, as shown in S82a or S82b in FIG. 39D and FIG. 39E, one or more solid compounds each containing the additive element X may be prepared, crushing and mixing may be performed, and the mixture may be used as the additive element X source 843 of Step S82 in FIG. 39C. In the case of using one or more solid compounds each containing the additive element X, mixing may be performed after crushing, crushing may be performed after mixing, or the solid compounds may be used as the additive element X source 843 in Step S82 without being subjected to crushing.

For the additive element X source used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S91, the mixture 842 of Step S81 and the additive element X source 843 of Step S82 are mixed. After the mixing, the mixture is collected in Step S92 to obtain a mixture 851 of Step S93. The mixing can be performed by a dry process or a wet process. For example, a ball mill, a bead mill, or the like can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. In Step S91, the mixing is performed with a ball mill using zirconia balls with a diameter of 1 mm by a dry process at 150 rpm for 1 hour. The mixing is performed in a dry room the dew point of which is higher than or equal to −100° C. and lower than or equal to −10° C.

Next, in Step S94, the mixture 851 of Step S93 is heated. The temperature of the heating in Step S94 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rising rate is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Note that the cooling to room temperature in Step S94 is not essential. As long as later steps are performed without problems, it is possible to perform cooling to a temperature higher than room temperature.

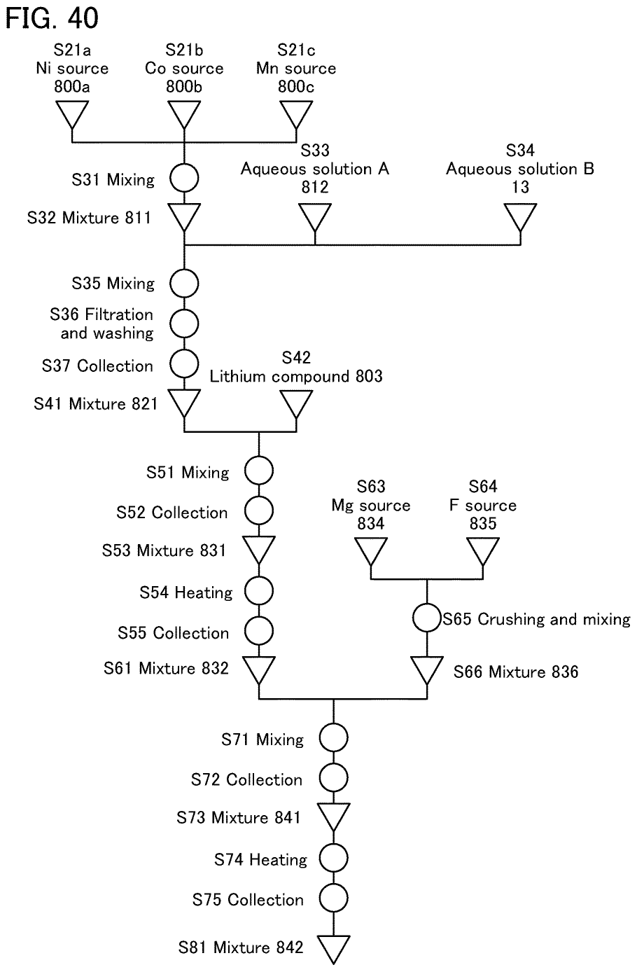

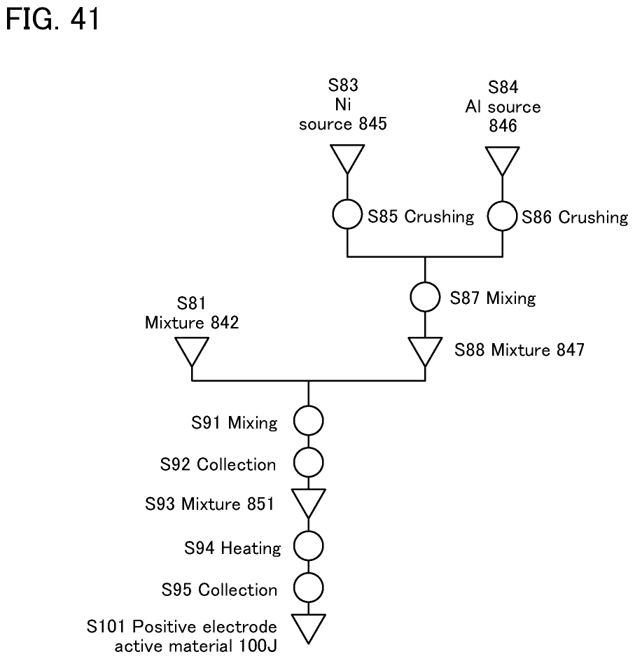

Next, the materials baked in the above step are collected in Step S95, whereby a positive electrode active material 100H of Step S101 is obtained. The positive electrode active material 100H can be used as the first material 100x described in Embodiment 1 and Embodiment 2.

[Method 3 for forming positive electrode active material] Another example of a method for forming a positive electrode active material of one embodiment of the present invention will be described with reference to FIG. 40 and FIG. 41.

In Step S21a, Step S21b, and Step S21c of FIG. 40, a transition metal M1 source 800 is prepared. In this embodiment, the case where three transition metal M1 sources, a nickel source 800a, a cobalt source 800b, and a manganese source 800c, are used as the transition metal M1 source 800 will be described.

As the nickel source 800a, an aqueous solution containing nickel, such as an aqueous solution of nickel sulfate or an aqueous solution of nickel nitrate, can be used. As the cobalt source 800b, an aqueous solution containing cobalt, such as an aqueous solution of cobalt sulfate or an aqueous solution of cobalt nitrate, can be used. As the manganese source 800c, an aqueous solution containing manganese, such as an aqueous solution of manganese sulfate or an aqueous solution of manganese nitrate, can be used.

For the transition metal M1 source 800 used in synthesis, a high-purity material is preferably used. Specifically, in the case of using the aqueous solution containing the transition metal M1, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

When metals that can form a layered rock-salt composite oxide are used, cobalt, manganese, and nickel are preferably mixed at the ratio at which the composite oxide can have a layered rock-salt crystal structure.

Next, in Step S31, the nickel source 800a, the cobalt source 800b, and the manganese source 800c are mixed, whereby the mixture 811 of Step S32 is obtained.

Next, an aqueous solution A 812 and an aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 of Step S32, the aqueous solution A 812, and the aqueous solution B 813 are mixed.

Step S35 to Step S55 of FIG. 40 can be performed in the same manner as those in the method shown in FIG. 37.

Next, in Step S63 and Step S64, a magnesium source 834 and a fluorine source 835 are prepared as additive element X sources. Subsequently, the magnesium source 834 and the fluorine source 835 are crushed and mixed in Step S65, whereby a mixture 836 of Step S66 is obtained.

As the magnesium source 834, for example, magnesium fluoride, magnesium oxide, magnesium hydroxide, or magnesium carbonate can be used.

As the fluorine source 835, for example, lithium fluoride (LiF), magnesium fluoride (MgF₂), aluminum fluoride (AlF₃), titanium fluoride (TiF₄), cobalt fluoride (CoF₂ or CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. The fluorine source is not limited to a solid, and for example, fluorine (F₂), carbon fluoride, sulfur fluoride, oxygen fluoride (OF₂, O₂F₂, O₃F₂, O₄F₂, or O₂F), or the like may be used and mixed in the atmosphere in a heating step described later. A plurality of fluorine sources may be mixed to be used. Among them, lithium fluoride having a relatively low melting point of 848° C. is preferably used because it is easily melted in the annealing process described later.

In this embodiment, lithium fluoride LiF is prepared as the fluorine source, and magnesium fluoride MgF₂ is prepared as the fluorine source and the magnesium source. When lithium fluoride LiF and magnesium fluoride MgF₂ are mixed at a mole ratio of approximately LiF:MgF₂=65:35, the effect of lowering the melting point becomes the highest. On the other hand, when the amount of lithium fluoride increases, cycle performance might deteriorate because of too large an amount of lithium. Thus, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value greater than 0.9 times and less than 1.1 times a certain value.

In the case where the crushing and mixing step in Step S65 is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity of higher than or equal to 99.5% is used.

For the magnesium source and the fluorine source used in synthesis, high-purity materials are preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

Next, in Step S71, the mixture 832 of Step S61 and the mixture 836 of Step S66 are mixed. After the mixing, the mixture is collected in Step S72 to obtain the mixture 841 of Step S73. The mixing can be performed by a dry process or a wet process. For example, a ball mill, a bead mill, or the like can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. Note that in Step S71, the peripheral speed is set to 838 mm/s (the rotational frequency is 400 rpm, and the diameter of the ball mill container is 40 mm).

Next, in Step S74, the mixture 841 of Step S73 is heated. The temperature of the heating in Step S74 is preferably higher than or equal to 500° C. and lower than or equal to 1100° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

As the heating in Step S74, heating by a roller hearth kiln may be performed. When heat treatment is performed by a roller hearth kiln, the mixture 841 may be processed using a heat-resistant container having a lid.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rising rate is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected in Step S75, whereby the mixture 842 of Step S81 is obtained. The mixture 842 obtained in Step S81 can be used as the positive electrode active material 100. The mixture 842 obtained in Step S81 can be provided for steps after Step S81 shown in FIG. 41.

Next, the steps after Step S81 shown in FIG. 41 are described. In Step S83 and Step S84, a nickel source 845 and an aluminum source 846 are prepared as additive element X sources. The nickel source 845 and the aluminum source 846 are crushed in Step S85 and Step S86, respectively, and mixed in Step S87, whereby a mixture 847 of Step S88 is obtained.

As the nickel source, nickel oxide, nickel hydroxide, or the like can be used.

As the aluminum source, aluminum oxide, aluminum hydroxide, or the like can be used.

For the nickel source and the aluminum source used in synthesis, high-purity materials are preferably used. Specifically, the purity of the material is higher than or equal to 4N (99.99%), preferably higher than or equal to 4N5UP (99.995%), further preferably higher than or equal to 5N (99.999%). The use of a high-purity material can increase the capacity of a secondary battery and/or increase the reliability of the secondary battery.

Next, in Step S91, the mixture 842 of Step S81 and the mixture 847 of Step S88 are mixed. After the mixing, the mixture is collected in Step S92 to obtain the mixture 851 of Step S93. The mixing can be performed by a dry process or a wet process. For example, a ball mill, a bead mill, or the like can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. In Step S91, the mixing is performed with a ball mill using zirconia balls with a diameter of 1 mm by a dry process at 150 rpm for 1 hour. The mixing is performed in a dry room the dew point of which is higher than or equal to −100° C. and lower than or equal to −10° C.

Next, in Step S94, the mixture 851 of Step S93 is heated. The temperature of the heating in Step S94 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C.

The heating time can be longer than or equal to 1 hour and shorter than or equal to 100 hours, for example, and is preferably longer than or equal to 2 hours and shorter than or equal to 20 hours. The heating is preferably performed in oxygen or an oxygen-containing atmosphere with few moisture (e.g., with a dew point lower than or equal to −50° C., preferably lower than or equal to −80° C.), such as a dry air. In this embodiment, the heating is performed in an atmosphere with a dew point of −93° C. Furthermore, it is suitable to perform the heating in an atmosphere where the concentrations of impurities, CH₄, CO, CO₂, and H₂, are each less than or equal to 5 ppb (parts per billion), in which case impurities can be inhibited from entering the materials.

For example, when the heating is performed at 850° C. for 10 hours, the temperature rising rate is preferably 200° C./h and the flow rate of a dry atmosphere is preferably 10 L/min. After that, the heated materials can be cooled to room temperature. The temperature decreasing time from the specified temperature to room temperature is preferably longer than or equal to 10 hours and shorter than or equal to 50 hours, for example. Note that the cooling to room temperature in Step S74 is not essential.

Next, the materials baked in the above step are collected in Step S95, whereby a positive electrode active material 100J of Step S101 is obtained. The positive electrode active material 100J can be used as the first material 100x described in Embodiment 1 and Embodiment 2.

### [Method 4 for Forming Positive Electrode Active Material]

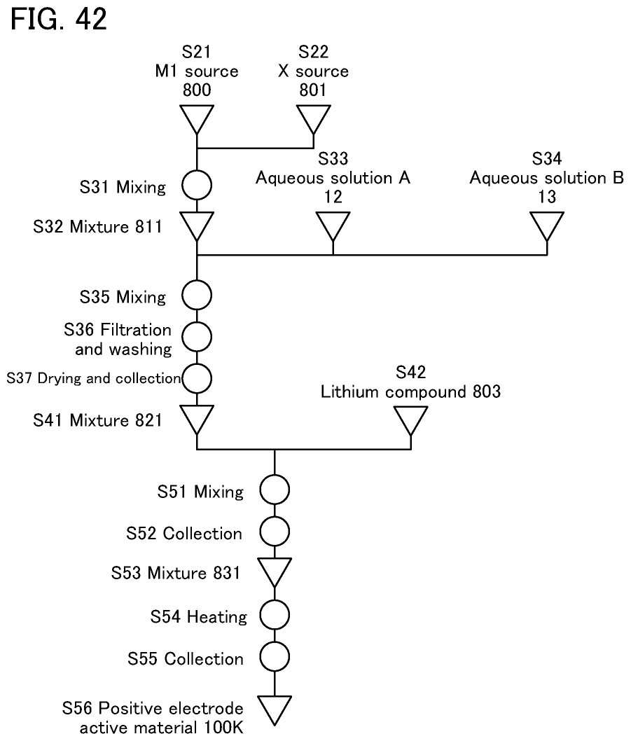

Another example of a method for forming a positive electrode active material of one embodiment of the present invention will be described with reference to FIG. 42.

The transition metal M1 source 800 and an additive element X source 801 are prepared in Step S21 and Step S22 in FIG. 42, respectively.

As the transition metal M1, at least one of manganese, cobalt, and nickel can be used, for example. As the transition metal M1, for example, cobalt alone; nickel alone; two metals of cobalt and manganese; two metals of cobalt and nickel; or three metals of cobalt, manganese, and nickel may be used. As the transition metal M1 source, an aqueous solution containing the transition metal M1 is prepared.

As the transition metal M1 source 800, an aqueous solution containing cobalt, such as an aqueous solution of cobalt sulfate or an aqueous solution of cobalt nitrate, can be used; an aqueous solution containing nickel, such as an aqueous solution of nickel sulfate or an aqueous solution of nickel nitrate, can be used; or an aqueous solution containing manganese, such as an aqueous solution of manganese sulfate or an aqueous solution of manganese nitrate, can be used.

For the transition metal M1 source 800 used in synthesis, a high-purity material is preferably used. Specifically, in the case of using the aqueous solution containing the transition metal M1, the aqueous solution is formed using a solute material with a purity higher than or equal to 2N (99%), preferably higher than or equal to 3N (99.9%), further preferably higher than or equal to 4N (99.99%), and water with a specific resistance of preferably 1 MΩ·cm or higher, further preferably 10 MΩ·cm or higher, still further preferably 15 MΩ·cm or higher, which is desirably pure water containing few impurities. The use of a high-purity material can increase the capacity of a secondary battery and/or increase the reliability of the secondary battery.

For the additive element X source 801, one or more selected from nickel, cobalt, magnesium, calcium, chlorine, fluorine, bromine, aluminum, manganese, titanium, zirconium, yttrium, vanadium, iron, chromium, niobium, lanthanum, hafnium, zinc, silicon, sulfur, phosphorus, boron, and arsenic can be used. As the additive element X source 801, any one or more of an aqueous solution containing the additive element X, an alkoxide containing the additive element X, and a solid compound containing the additive element X can be used. An aqueous solution containing the additive element X is preferably prepared as the additive element X source 801 of Step S22.

For the additive element X source 801 used in synthesis, a high-purity material is preferably used. Specifically, the purity of the material is higher than or equal to 2N (99%), preferably higher than or equal to 3N (99.9%), further preferably higher than or equal to 4N (99.99%). The use of a high-purity material can increase the capacity of a secondary battery and/or increase the reliability of the secondary battery.

Next, in Step S31, the transition metal M1 source and the additive element X are mixed, whereby the mixture 811 of Step S32 is obtained.

Next, the aqueous solution A 812 and the aqueous solution B 813 are prepared in Step S33 and Step S34, respectively.

As the aqueous solution A 812, any one of ammonia water and an aqueous solution containing at least one of chelating agents such as glycine, oxine, 1-nitroso-2-naphthol, and 2-mercaptobenzothiazole, or a mixed solution of a plurality of them can be used.

As the aqueous solution B 813, any one of an aqueous solution of sodium hydroxide, an aqueous solution of potassium hydroxide, and an aqueous solution of lithium hydroxide, or a mixed solution of a plurality of them can be used.

Next, in Step S35, the mixture 811 of Step S32, the aqueous solution A 812, and the aqueous solution B 813 are mixed.

Step S35 to Step S54 of FIG. 42 can be performed in the same manner as those in the method shown in FIG. 37.

Next, the materials baked in the above step are collected in Step S55, whereby a positive electrode active material 100K of Step S56 is obtained. The positive electrode active material 100K can be used as the first material 100x described in Embodiment 1 and Embodiment 2.

### [Method 5 for Forming Positive Electrode Active Material]

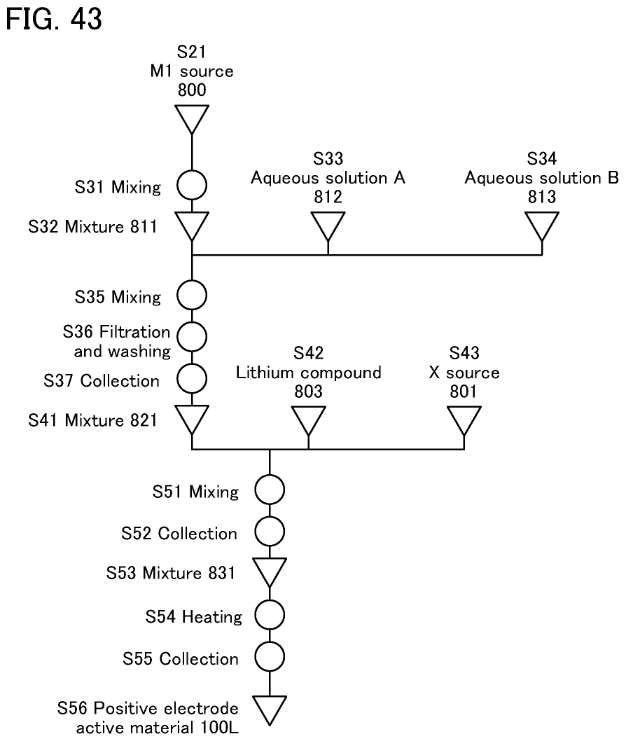

Next, another example of a method for forming a positive electrode active material of one embodiment of the present invention will be described with reference to FIG. 43.

Step S21 to Step S41 of FIG. 43 can be performed in the same manner as those in the method shown in FIG. 37.

Next, the lithium compound 803 is prepared in Step S42, and the additive element X source 801 is prepared in Step S43. In Step S51, the mixture 821 of Step S41, the lithium compound 803, and the additive element X source 801 are mixed.

Step S51 to Step S54 of FIG. 43 can be performed in the same manner as those in the method shown in FIG. 37.

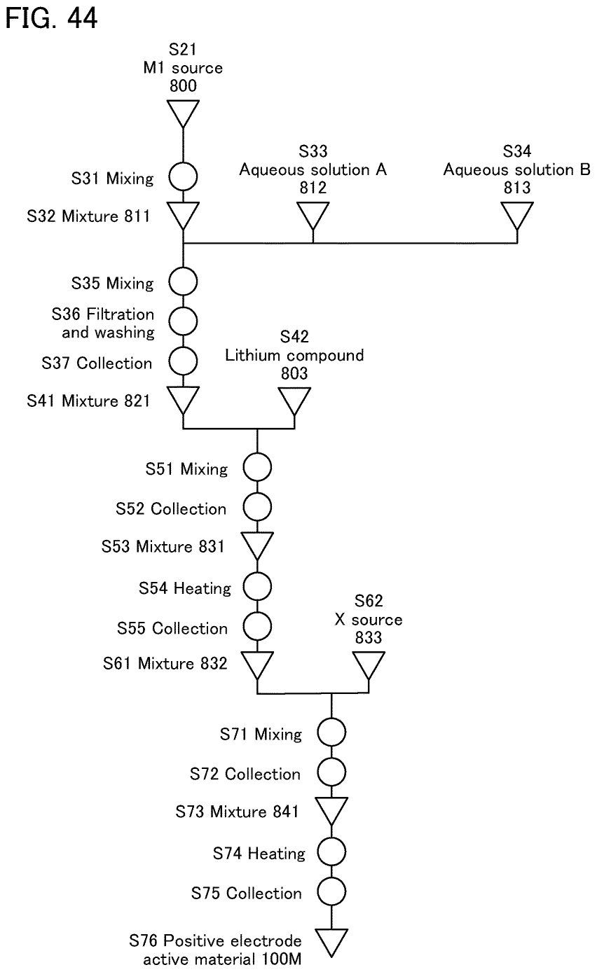

Next, the materials baked in the above step are collected in Step S55, whereby a positive electrode active material 100L of Step S56 is obtained. The positive electrode active material 100L can be used as the first material 100x described in Embodiment 1 and Embodiment 2.

[Method 6 for forming positive electrode active material] Next, another example of a method for forming a positive electrode active material of one embodiment of the present invention will be described with reference to FIG. 44.

Step S21 to Step S74 of FIG. 44 can be performed in the same manner as those in the method shown in FIG. 38.

Next, the materials baked in the above step are collected in Step S75, whereby a positive electrode active material 100M of Step S76 is obtained. The positive electrode active material 100M can be used as the first material 100x described in Embodiment 1 and Embodiment 2.

### [Method 7 for Forming Positive Electrode Active Material]

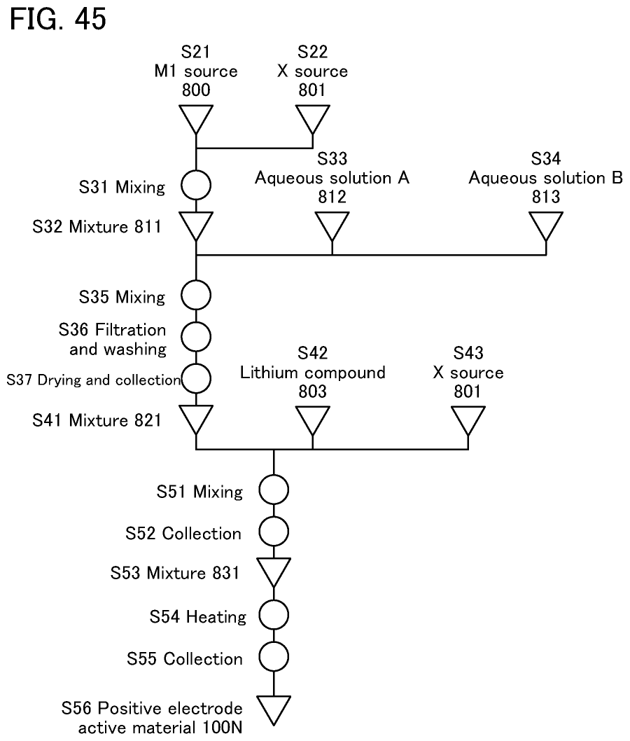

Next, another example of a method for forming a positive electrode active material of one embodiment of the present invention will be described with reference to FIG. 45.

Step S21 to Step S41 of FIG. 45 can be performed in the same manner as those in the method shown in FIG. 42. In addition, Step S42 to Step S54 of FIG. 45 can be performed in the same manner as those in the method shown in FIG. 43.

Next, the materials baked in the above step are collected in Step S55, whereby a positive electrode active material 100N of Step S56 is obtained. The positive electrode active material 100N can be used as the first material 100x described in Embodiment 1 and Embodiment 2.

### [Method 8 for Forming Positive Electrode Active Material]

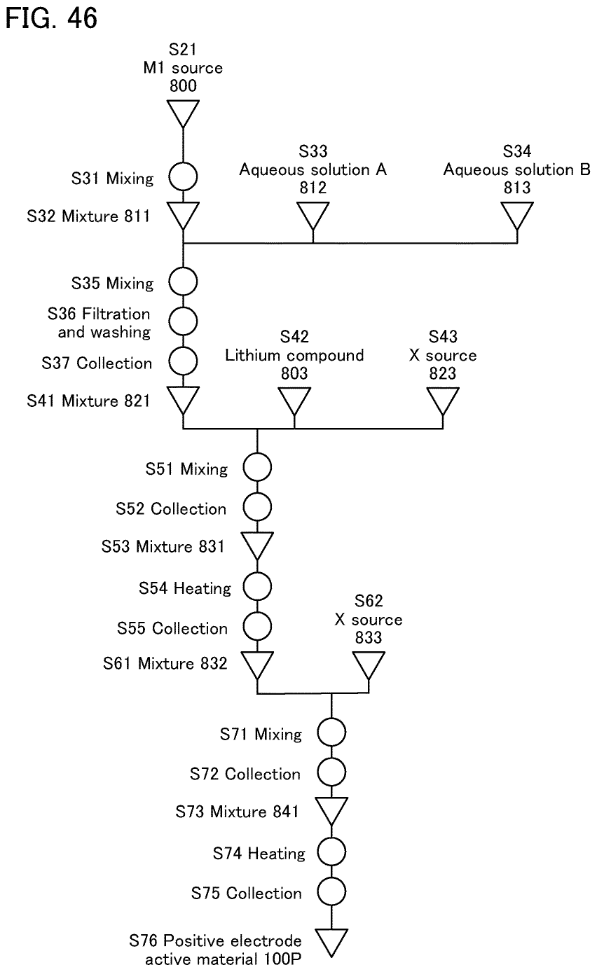

Next, another example of a method for forming a positive electrode active material of one embodiment of the present invention will be described with reference to FIG. 46.

Step S21 to Step S54 of FIG. 46 can be performed in the same manner as those in the method shown in FIG. 43. In addition, Step S55 to Step S74 of FIG. 46 can be performed in the same manner as those in the method shown in FIG. 38.

Next, the materials baked in the above step are collected in Step S75, whereby a positive electrode active material 100P of Step S76 is obtained. The positive electrode active material 100P can be used as the first material 100x described in Embodiment 1 and Embodiment 2.

### [Method 9 for Forming Positive Electrode Active Material]

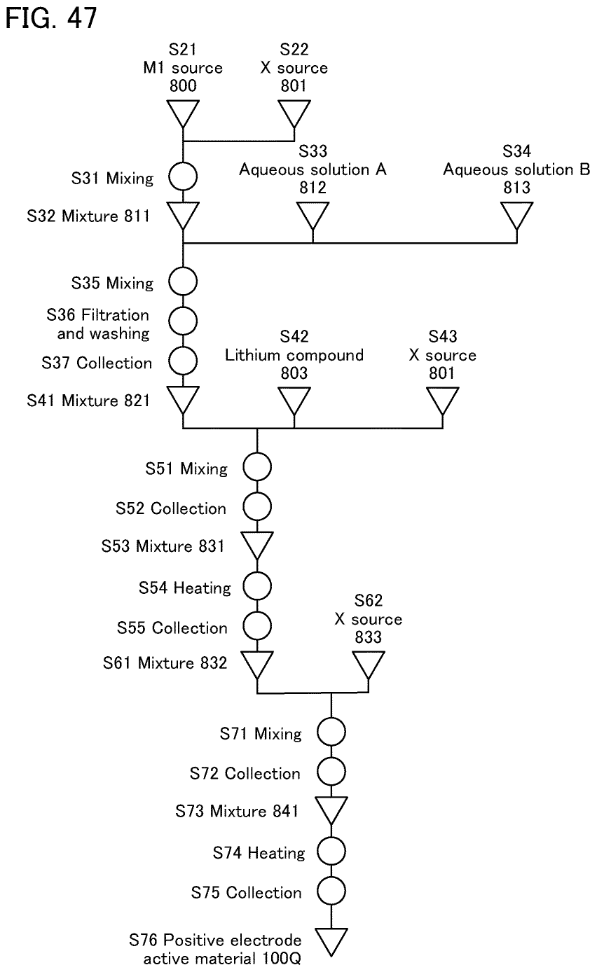

Next, another example of a method for forming a positive electrode active material of one embodiment of the present invention will be described with reference to FIG. 47.

Step S21 to Step S54 of FIG. 47 can be performed in the same manner as those in the method shown in FIG. 45. In addition, Step S55 to Step S74 of FIG. 47 can be performed in the same manner as those in the method shown in FIG. 38.

Next, the materials baked in the above step are collected in Step S75, whereby a positive electrode active material 100Q of Step S76 is obtained. The positive electrode active material 100Q can be used as the first material 100x described in Embodiment 1 and Embodiment 2.

When the step of introducing the transition metal M1 and the steps of introducing the additive element X are separately performed as shown in FIG. 38 to FIG. 47, the element concentration profiles in the depth direction can be made different from each other in some cases. For example, the concentration of the additive element can be made higher in the vicinity of the surface of the particle than in the inner portion thereof. Furthermore, with the number of atoms of the transition metal M1 as a reference, the ratio of the number of atoms of the additive element with respect to the reference can be higher in the vicinity of the surface than in the inner portion.

The positive electrode active material 100 is sometimes referred to as a composite oxide containing lithium, the transition metal M1, and oxygen (LiM1O₂). Note that the positive electrode active material of one embodiment of the present invention only needs to have a crystal structure of a lithium composite oxide represented by LiM1O₂, and the composition is not strictly limited to Li:M1:O=1:1:2.

In one embodiment of the present invention, a positive electrode active material is formed using a high-purity material for the transition metal M1 source used in synthesis and using a process which hardly allows entry of impurities in the synthesis. The formation method in which entry of impurities into the transition metal M1 source and entry of impurities in the synthesis are thoroughly prevented and in which a desired additive element (the additive element X, the additive element X1, or the additive element X2) is controlled to be introduced into the positive electrode active material can provide a positive electrode active material in which a region with a low impurity concentration and a region where the additive element is introduced are controlled. The positive electrode active material described in this embodiment is a material having high crystallinity. Furthermore, the positive electrode active material obtained by the method for forming a positive electrode active material, which is one embodiment of the present invention, can increase the capacity of a secondary battery and/or increase the reliability of the secondary battery.

### [Structure of Positive Electrode Active Material]

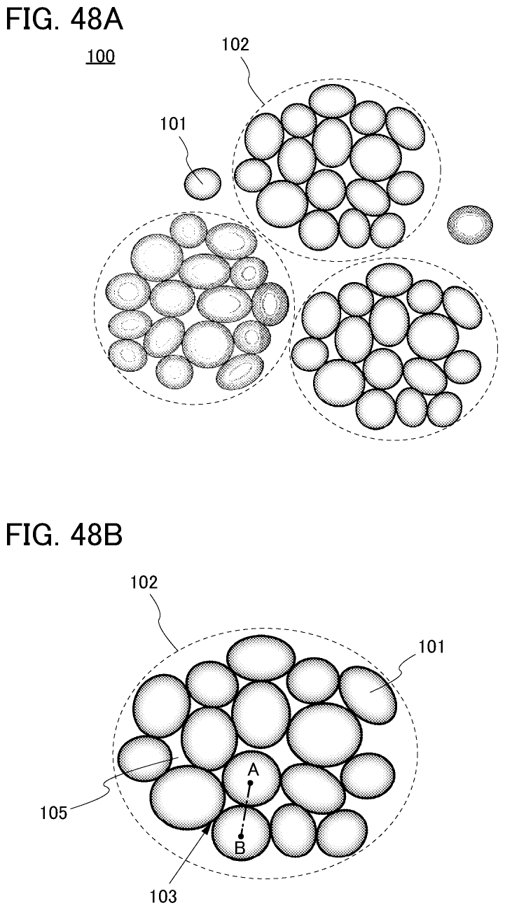

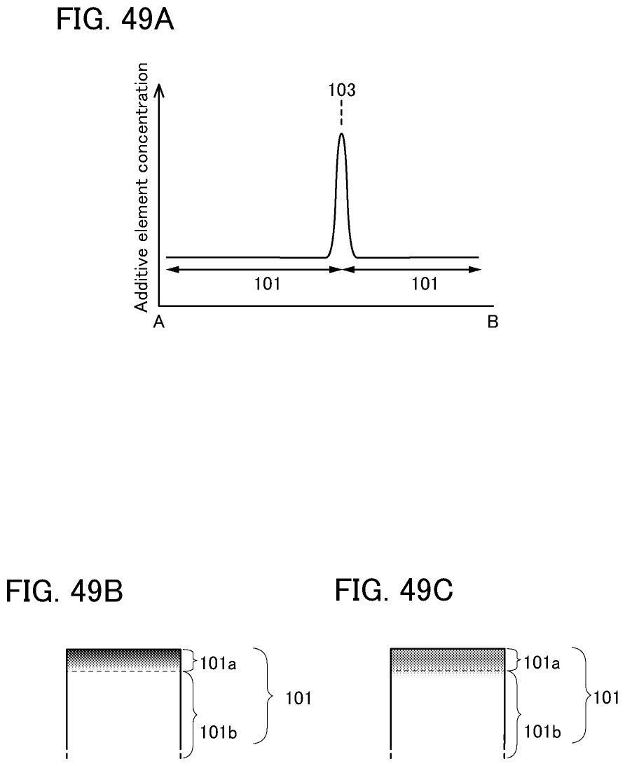

The positive electrode active material of one embodiment of the present invention will be described with reference to FIG. 48A to FIG. 49C.

FIG. 48A is a cross-sectional view of the positive electrode active material 100. The positive electrode active material 100 includes a plurality of primary particles 101. At least some of the plurality of primary particles 101 adhere to each other to form secondary particles 102. FIG. 48B is an enlarged view of the secondary particle 102. The positive electrode active material 100 may include a space 105. Note that the shapes of the primary particles 101 and the secondary particles 102 illustrated in FIG. 48A and FIG. 48B are just examples and are not limited thereto.

In this specification and the like, a primary particle is a smallest unit that is recognizable as a solid having a clear boundary in micrographs such as a SEM image, a TEM image, and a STEM image. A secondary particle is a particle in which a plurality of primary particles are sintered, adhere to each other, or aggregate. In this case, there is no limitation on the bonding force acting between the plurality of primary particles. The bonding force may be any of covalent bonding, ionic bonding, a hydrophobic interaction, the Van der Waals force, and other molecular interactions, or a plurality of bonding forces may work together. In addition, the simple term “particle” includes a primary particle and a secondary particle.

### <Contained Element>

The positive electrode active material 100 contains lithium, the transition metal M1, oxygen, and an additive element.

The positive electrode active material 100 can be regarded as a composite oxide represented by LiM1O₂ to which a plurality of additive elements are added. Note that the positive electrode active material of one embodiment of the present invention only needs to have a crystal structure of a lithium composite oxide represented by LiM1O₂, and the composition is not strictly limited to Li:M1:O=1:1:2.

As the transition metal M1 contained in the positive electrode active material 100, a metal that can form, together with lithium, a layered rock-salt composite oxide belonging to the space group R-3m is preferably used. For example, at least one of manganese, cobalt, and nickel can be used. That is, as the transition metal contained in the positive electrode active material 100, only cobalt may be used, only nickel may be used, two metals of cobalt and manganese or two metals of cobalt and nickel may be used, or three metals of cobalt, manganese, and nickel may be used. In other words, the positive electrode active material 100 can contain a composite oxide containing lithium and the transition metal M1, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Specifically, using cobalt at greater than or equal to 75 at %, preferably greater than or equal to 90 at %, further preferably greater than or equal to 95 at % as the transition metal M1 contained in the positive electrode active material 100 brings many advantages such as relatively easy synthesis, easy handling, and excellent cycle performance.

Using nickel at greater than or equal to 33 at %, preferably greater than or equal to 60 at %, further preferably greater than or equal to 80 at % as the transition metal M1 contained in the positive electrode active material 100 is preferable because in that case, the cost of the raw materials might be lower than that in the case of using a large amount of cobalt and charge and discharge capacity per weight might be increased.

Moreover, when nickel is partly contained as the transition metal M1 together with cobalt, a shift in a layered structure formed of octahedrons of cobalt and oxygen is sometimes inhibited. This is preferable because the crystal structure becomes more stable particularly in a charged state at a high temperature in some cases. This is presumably because nickel is easily diffused into the inner portion of lithium cobalt oxide and exists in a cobalt site at the time of discharging but can be positioned in a lithium site owing to cation mixing at the time of charging. Nickel existing in the lithium site at the time of charging functions as a pillar supporting the layered structure formed of octahedrons of cobalt and oxygen and presumably contributes to stabilization of the crystal structure.

Note that manganese is not necessarily contained as the transition metal M1. In addition, nickel is not necessarily contained. Furthermore, cobalt is not necessarily contained.

As the additive element, at least one of magnesium, fluorine, aluminum, titanium, zirconium, yttrium, vanadium, iron, chromium, niobium, lanthanum, hafnium, zinc, silicon, sulfur, phosphorus, boron, and arsenic is preferably used.

It is particularly preferred that phosphorus be added to the positive electrode active material 100, in which case the continuous charge tolerance can be improved and thus a highly safe secondary battery can be provided.

Manganese, titanium, vanadium, and chromium are materials each of which is likely to be tetravalent stably and thus can increase contribution to structure stability in some cases when used as the transition metal M1 of the positive electrode active material 100.

These additive elements further stabilize the crystal structure of the positive electrode active material 100 in some cases as described later. That is, the positive electrode active material 100 can contain lithium cobalt oxide to which magnesium and fluorine are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, lithium nickel-manganese-cobalt oxide to which magnesium and fluorine are added, or the like. Note that in this specification and the like, the additive element may be rephrased as a mixture, a constituent of a material, an impurity element, or the like.

The additive element in the positive electrode active material 100 is preferably added at a concentration that does not largely change the crystallinity of the composite oxide represented by LiM1O₂. For example, each of the additive elements is preferably added at an amount that does not cause the Jahn-Teller effect or the like.

Note that as the additive elements, magnesium, fluorine, aluminum, titanium, zirconium, yttrium, vanadium, iron, chromium, niobium, lanthanum, hafnium, zinc, silicon, sulfur, phosphorus, or boron is not necessarily contained.

### <Element Distribution>

At least one of the additive elements in the positive electrode active material 100 preferably has a concentration gradient.

For example, it is preferred that the primary particles 101 each include a surface portion 101a and an inner portion 101b, and that the concentration of the additive element be higher in the surface portion 101a than in the inner portion 101b. In FIG. 48A and FIG. 48B, the concentration of the additive element in the primary particles 101 is represented by a gradation. A dark color in the gradation, that is, a color close to black means that the concentration of the additive element is high; a light color, that is, a color close to white means that the concentration of the additive element is low.

The concentration of the additive element at an interface 103 between primary particles and around the interface 103 is preferably higher than that in the inner portions 101b of the primary particles 101. In this specification and the like, “around the interface 103” refers to a region within approximately 10 nm from the interface 103.

FIG. 49A shows an example of the concentration distribution of the additive element of the positive electrode active material 100 along the dashed-dotted line A-B in FIG. 48B.

In FIG. 49A, the horizontal axis represents the length of the dashed-dotted line A-B in FIG. 48B, and the vertical axis represents the concentration of the additive element.

The interface 103 and the vicinity of the interface 103 include a region where the concentration of the additive element is higher than that of the primary particles 101. Note that the shape of the concentration distribution of the additive element is not limited to the shape shown in FIG. 49A.

In the case where a plurality of additive elements are contained, the peak position of the concentration preferably differs between the additive elements.

Examples of the additive elements that preferably have a concentration gradient which increases from the inner portion 101b toward the surface as illustrated in FIG. 48A, FIG. 48B, and FIG. 49B include magnesium, fluorine, and titanium.

As illustrated in FIG. 49C, other the additive elements preferably have a concentration peak in the positive electrode active material 100 in a region close to the inner portion 101b, as compared with the additive element distributed as illustrated in FIG. 49B. An example of the additive element that is preferably distributed as above is aluminum. The concentration peak may be located in the surface portion or located deeper than the surface portion. For example, the concentration peak is preferably located in a region of 5 nm to 30 nm inclusive in depth from the surface.

It is preferred that some of the additive elements, e.g., magnesium, have a concentration gradient in which the concentration increases from the inner portion 101b toward the surface as illustrated in FIG. 49B, and be thinly distributed throughout each of the primary particles 101. For example, the magnesium concentration in the surface portion 101a measured by XPS or the like is preferably higher than the average magnesium concentration in the whole particle measured by ICP-MS or the like.

In the case where the positive electrode active material 100 of one embodiment of the present invention contains an element other than cobalt, for example, one or more metals selected from nickel, aluminum, manganese, iron, and chromium, the concentration of the metal in a region in the vicinity of the surface of the primary particle 101 is preferably higher than the average concentration in the whole particle. For example, the concentration of the element other than cobalt in the surface portion 101a measured by XPS or the like is preferably higher than the average concentration of the element in the whole particle measured by ICP-MS or the like.

The particle surface is in a state where bonds are cut unlike the crystal's inner portion, and lithium is extracted from the surface during charging; thus, the lithium concentration in the surface portion tends to be lower than that in the inner portion 101b. Therefore, the particle surface tends to be unstable and its crystal structure is likely to be broken. The higher the concentration of the additive element in the surface portion 101a is, the more effectively the change in the crystal structure can be inhibited. In addition, a high concentration of the additive element in the surface portion 101a probably increases corrosion resistance to hydrofluoric acid generated by decomposition of an electrolyte solution.

As described above, the surface portion 101a of the positive electrode active material 100 of one embodiment of the present invention preferably has a higher concentration of the additive element than the inner portion 101b and has a composition different from that of the inner portion 101b. The composition preferably has a crystal structure stable at room temperature (25° C.). Accordingly, the surface portion 101a may have a crystal structure different from that of the inner portion 101b. For example, at least part of the surface portion 101a of the positive electrode active material 100 of one embodiment of the present invention may have a rock-salt crystal structure. When the surface portion 101a and the inner portion 101b have different crystal structures, the orientations of crystals in the surface portion 101a and the inner portion 101b are preferably substantially aligned with each other.

However, in the surface portion 101a where only the additive element and oxygen, e.g., MgO, are contained or MgO and CoO(II) form a solid solution, it is difficult to insert and extract lithium. Thus, the surface portion 101a should contain at least the transition metal M1, and also contain lithium in a discharged state and have a path through which lithium is inserted and extracted. Moreover, the concentration of the transition metal M1 is preferably higher than the concentrations of the additive elements.

Note that the positive electrode active material 100 of one embodiment of the present invention is not limited thereto. Some of the additive elements may have no concentration gradient.

Note that the transition metal M1, especially cobalt and nickel, is preferably dissolved uniformly in the entire positive electrode active material 100.

Note that a kind of the transition metal M1, e.g., manganese, contained in the positive electrode active material 100 may have a concentration gradient in which the concentration increases from the inner portion 101b toward the surface.

When the additive elements are distributed in the above manner, deterioration of the positive electrode active material 100 due to charging and discharging can be reduced. That is, deterioration of a secondary battery can be inhibited. A highly safe secondary battery can be provided.

In general, the repetition of charging and discharging of a secondary battery causes the following side reactions: dissolution of the transition metal M1 such as cobalt or manganese from a positive electrode active material included in the secondary battery into an electrolyte solution, release of oxygen, and an unstable crystal structure; hence, deterioration of the positive electrode active material proceeds in some cases. The deterioration of the positive electrode active material sometimes accelerates deterioration such as a decrease in the capacity of the secondary battery. Note that in this specification and the like, a chemical or structural change of the positive electrode active material, such as dissolution of the transition metal M1 from a positive electrode active material into an electrolyte solution, release of oxygen, and an unstable crystal structure, is referred to as deterioration of the positive electrode active material in some cases. In this specification and the like, a decrease in the capacity of the secondary battery is referred to as deterioration of the secondary battery in some cases.

A metal dissolved from the positive electrode active material is reduced at a negative electrode and precipitated, which might inhibit the electrode reaction of the negative electrode. The precipitation of the metal in the negative electrode promotes deterioration such as a capacity decrease in some cases.

A crystal lattice of the positive electrode active material expands and contracts with insertion and extraction of lithium due to charging and discharging, thereby undergoing strain and a change in volume in some cases. The strain and change in volume of the crystal lattice cause cracking of the positive electrode active material, which might promote deterioration such as a capacity decrease. Cracking of the positive electrode active material may start from the interface 103 between the primary particles.

When the temperature inside the secondary battery turns high and oxygen is released from the positive electrode active material, the safety of the secondary battery might be adversely affected. In addition, the release of oxygen might change the crystal structure of the positive electrode active material and promote deterioration such as a capacity decrease. Note that oxygen is sometimes released from the positive electrode active material by insertion and extraction of lithium due to charging and discharging.

In view of above, the additive element or a compound (e.g., an oxide of the additive element) that is more chemically and structurally stable than a lithium composite oxide typified by LiM1O₂ is preferably contained in the surface portion 101a or the interface 103. Thus, the positive electrode active material 100 can be chemically and structurally stable, and a change in structure, a change in volume, and strain due to charging and discharging can be inhibited. That is, the crystal structure of the positive electrode active material 100 is more stable and hardly changes even after repetition of charging and discharging. In addition, cracking of the positive electrode active material 100 can be inhibited. This is preferable because deterioration such as a capacity decrease can be inhibited. When the charge voltage increases and the amount of lithium in the positive electrode at the time of charging decreases, the crystal structure becomes unstable and is more likely to deteriorate. The use of the positive electrode active material 100 of one embodiment of the present invention is particularly preferable, in which case the crystal structure can be more stable and thus deterioration such as a decrease in capacity can be inhibited.

Since the positive electrode active material 100 of one embodiment of the present invention has a stable crystal structure, dissolution of the transition metal M1 from the positive electrode active material can be inhibited. This is preferable because deterioration such as a capacity decrease can be inhibited.

When the positive electrode active material 100 of one embodiment of the present invention is cracked along the interface 103 between the primary particles 101, the compound of the additive element is included in the surfaces of the cracked primary particles 101. That is, a side reaction can be inhibited even in the cracked positive electrode active material 100 and deterioration of the positive electrode active material 100 can be reduced. That is, deterioration of a secondary battery can be inhibited.

### <Analysis Method>

### <<Particle Diameter>>

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution.

Thus, in the positive electrode active material 100 including the primary particles 101 and the secondary particles 102, the average particle diameter (D50, also referred to as a median diameter) obtained with a particle size distribution analyzer using a laser diffraction and scattering method is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, the D50 is preferably greater than or equal to 1 μm and less than or equal to 40 μm. Alternatively, the D50 is preferably greater than or equal to 1 μm and less than or equal to 30 μm. Alternatively, the D50 is preferably greater than or equal to 2 μm and less than or equal to 100 um. Alternatively, the D50 is preferably greater than or equal to 2 μm and less than or equal to 30 μm. Alternatively, the D50 is preferably greater than or equal to 5 μm and less than or equal to 100 μm. Alternatively, the D50 is preferably greater than or equal to 5 μm and less than or equal to 40 μm.

Alternatively, two or more positive electrode active materials 100 having different particle diameters may be mixed and used. In other words, the positive electrode active materials 100 exhibiting a plurality of peaks when subjected to particle size distribution measurement by a laser diffraction and scattering method may be used. In that case, the mixing ratio is preferably set such that the powder packing density is high in order to increase the capacity per volume of a secondary battery.

The size of each of the primary particles 101 in the positive electrode active material 100 can be calculated from the half width of the XRD pattern of the positive electrode active material 100, for example. The size of each of the primary particles 101 is preferably greater than or equal to 50 nm and less than or equal to 200 nm.

When the positive electrode active material 100 of one embodiment of the present invention is subjected to XPS analysis, the number of atoms of the additive element is preferably greater than or equal to 1.6 times and less than or equal to 6.0 times, further preferably greater than or equal to 1.8 times and less than 4.0 times the number of atoms of the transition metal M1. When the additive element is magnesium and the transition metal M1 is cobalt, the number of magnesium atoms is preferably greater than or equal to 1.6 times and less than or equal to 6.0 times, further preferably greater than or equal to 1.8 times and less than 4.0 times the number of cobalt atoms. The number of atoms of halogen such as fluorine is preferably greater than or equal to 0.2 times and less than or equal to 6.0 times, further preferably greater than or equal to 1.2 times and less than or equal to 4.0 times the number of atoms of the transition metal M1.

In the XPS analysis, monochromatic aluminum can be used as an X-ray source, for example. The output can be set to 1486.6 eV, for example. An extraction angle is, for example, 45°. With such measurement conditions, a region from the surface to a depth of 2 nm to 8 nm inclusive (normally, approximately 5 nm) can be analyzed, as mentioned above.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV). That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This bonding energy is different from that of magnesium fluoride (1305 eV) and is close to that of magnesium oxide. That is, the positive electrode active material 100 of one embodiment of the present invention containing magnesium is preferably in the bonding state other than magnesium fluoride.

The concentrations of the additive elements that preferably exist in the surface portion 101a in a large amount, such as magnesium, aluminum, and titanium, measured by XPS or the like are preferably higher than the concentrations measured by ICP-MS (inductively coupled plasma mass spectrometry), GD-MS (glow discharge mass spectrometry), or the like.

When a cross section is exposed by processing and analyzed by TEM-EDX, the concentrations of magnesium, aluminum, and titanium in the surface portion 101a are preferably higher than those in the inner portion 101b. For example, in the TEM-EDX analysis, the magnesium concentration preferably attenuates, at a depth of 1 nm from a point where the concentration reaches a peak, to less than or equal to 60% of the peak concentration. In addition, the magnesium concentration preferably attenuates, at a depth of 2 nm from the point where the concentration reaches the peak, to less than or equal to 30% of the peak concentration. The processing can be performed with an FIB (focused ion beam) system, for example.

In the XPS (X-ray photoelectron spectroscopy) analysis, the number of magnesium atoms is preferably greater than or equal to 0.4 times and less than or equal to 1.5 times the number of cobalt atoms. In the ICP-MS analysis, the atomic ratio of magnesium to cobalt (Mg/Co) is preferably greater than or equal to 0.001 and less than or equal to 0.06.

By contrast, it is preferable that nickel, which is one of the transition metals M1, not be unevenly distributed in the surface portion 101a but be distributed in the entire positive electrode active material 100.

### <<EPMA>>

Elements can be quantified by EPMA (electron probe microanalysis). In surface analysis, distribution of each element can be analyzed.

In EPMA, a region from a surface to a depth of approximately 1 μm is analyzed. Thus, the concentration of each element is sometimes different from measurement results obtained by other analysis methods. For example, when surface analysis is performed on the positive electrode active material 100, the concentration of the additive element existing in the surface portion might be lower than the concentration obtained in XPS. The concentration of the additive element existing in the surface portion might be higher than the concentration obtained in ICP-MS or a value based on the ratio of the raw materials mixed in the process of forming the positive electrode active material.

EPMA surface analysis of a cross section of the positive electrode active material 100 of one embodiment of the present invention preferably reveals a concentration gradient in which the concentration of the additive element increases from the inner portion toward the surface portion. Specifically, each of magnesium, fluorine, and titanium preferably has a concentration gradient in which the concentration increases from the inner portion toward the surface as illustrated in FIG. 49B. The concentration of aluminum preferably has a peak in a region deeper than the region where the concentration of any of the above elements has a peak, as illustrated in FIG. 49C. The aluminum concentration peak may be located in the surface portion or located deeper than the surface portion.

Note that the surface and the surface portion of the positive electrode active material of one embodiment of the present invention do not contain a carbonic acid, a hydroxy group, or the like which is chemisorbed after formation of the positive electrode active material. Furthermore, an electrolyte solution, a binder, a conductive additive, and a compound originating from any of these that are attached to the surface of the positive electrode active material are not contained either. Thus, in quantification of the elements contained in the positive electrode active material, correction may be performed to exclude carbon, hydrogen, excess oxygen, excess fluorine, and the like that might be detected in surface analysis such as XPS and EPMA. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive additive, and a compound originating from any of these that are attached to the surface of the positive electrode active material. Although lithium might be eluted to a solvent or the like used in the washing at this time, the transition metal M1 and the additive element are not easily eluted even in that case; thus, the atomic proportions of the transition metal M1 and the additive element are not affected.

The primary particles 101 included in the positive electrode active material 100 of one embodiment of the present invention preferably have smooth surfaces with little unevenness. A smooth surface with little unevenness indicates favorable distribution of the additive element in the surface portion 101a.

The smooth surfaces with little unevenness of the primary particles 101 can be determined from, for example, a cross-sectional SEM image or a cross-sectional TEM image of the positive electrode active material 100. For example, as described in Embodiment 3, it is possible to quantify the level of the surface smoothness.

The contents described in this embodiment can be implemented in combination with the contents described in the other embodiments.

### Embodiment 5

In this embodiment, a method for forming a positive electrode active material of one embodiment of the present invention are described.

### [Method 1 for Forming Positive Electrode Active Material]

The positive electrode active material of one embodiment of the present invention is formed using a liquid phase method, preferably a hydrothermal method.

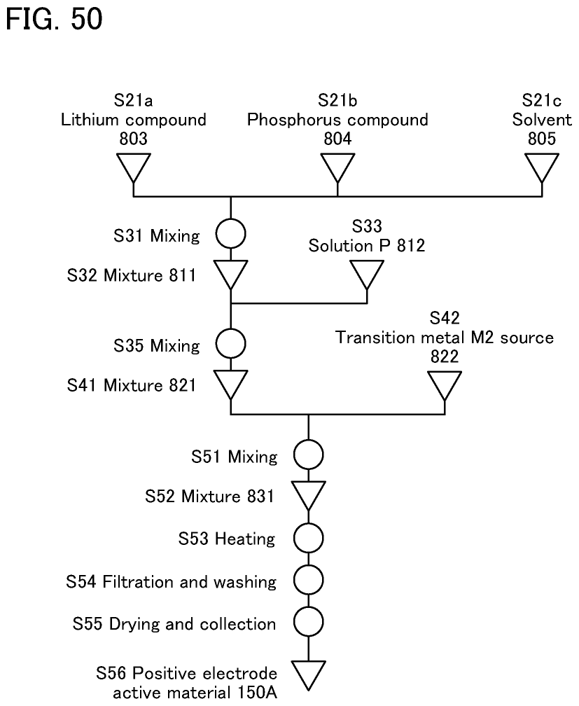

An example of a method for forming the positive electrode active material of one embodiment of the present invention is described with reference to FIG. 50.

In Step S21a, the lithium compound 803 is prepared. In Step S21b, a phosphorus compound 804 is prepared.

Here, the atomic ratio of lithium to a transition metal M2 and phosphorus of a composite oxide that is preferably obtained as a positive electrode active material 150 is x:y:z. In order to obtain LiM2PO₄, for example, x:y:z=1:1:1 is satisfied. The positive electrode active material 150 can be used as the second material 100y described in Embodiment 1 and Embodiment 2.

Typical examples of the lithium compound include lithium chloride (LiCl), lithium acetate (CH₃COOLi), lithium oxalate ((COOLi)₂), lithium carbonate (Li₂CO₃), and lithium hydroxide monohydrate (LiOH·H₂O).

Typical examples of the phosphorus compound include phosphoric acid such as orthophosphoric acid (H₃PO₄), and ammonium hydrogen phosphate such as diammonium hydrogen phosphate ((NH₄)₂HPO₄) and ammonium dihydrogen phosphate (NH₄H₂PO₄).

Next, in Step S21c, a solvent 805 is prepared. Water is preferably used as the solvent 805. Alternatively, a mixed solution of water and another liquid may be used as the solvent 805. For example, water and alcohol may be mixed. Here, the lithium compound 803 and the phosphorus compound 804 or a reaction product of the lithium compound 803 and the phosphorus compound 804 may have different solubilities in water and alcohol. Using alcohol makes the grain size of formed particles smaller in some cases. Furthermore, by using alcohol, which has a lower boiling point than water, pressure can be easily increased in some cases in Step S53 described later.

Note that in the case where water is used as the solvent 805, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of the secondary battery.

Next, in Step S31, the lithium compound 803, the phosphorus compound 804, and the solvent 805 are mixed, whereby the mixture 811 of Step S32 is obtained. The mixing in Step S31 can be performed in an atmosphere of air, an inert gas, or the like. As the inert gas, nitrogen may be used, for example. Here, as an example, the lithium compound 803 prepared in Step S21a, the phosphorus compound 804 prepared in Step S21b, and the solvent 805 prepared in Step S21c are mixed in an air atmosphere. For example, the lithium compound 803 prepared in Step S21a and the phosphorus compound 804 prepared in Step S21b are put in the solvent 805 prepared in Step S21c, whereby the mixture 811 of Step S32 is formed.

In the mixture 811 of Step S32, the lithium compound 803, the phosphorus compound 804, and the reaction product of the lithium compound and the phosphorus compound sometimes precipitate, but are partly dissolved without precipitating, i.e., partly exist in the solvent as ions. Here, when the mixture 811 has a low pH, there are cases where the reaction product and the like are easily dissolved in the solvent; when the mixture 811 has a high pH, there are cases where the reaction product and the like are easily precipitated.

Note that instead of forming the mixture 811 of Step S32 by mixing the lithium compound 803 and the phosphorus compound 804, the mixture 811 of Step S32 may be formed by preparing a compound containing phosphorus and lithium, such as Li₃PO₄, Li₂HPO₄, or LiH₂PO₄, and adding the compound to a solvent.

Here, in the case where the mixture 811 of Step S32 is an aqueous solution, the pH of the mixture 811 is determined by the kind and dissociation degree of the salt included in the mixture 811. Accordingly, the pH of the mixture 811 changes depending on the lithium compound 803 and the phosphorus compound 804 used as the source materials. For example, in the case of using lithium chloride as the lithium compound 803 and orthophosphoric acid as the phosphorus compound 804, the mixture 811 of Step S32 is likely to be a strong acid. As another example, in the case of using lithium hydroxide monohydrate as the lithium compound 803, the mixture 811 of Step S32 is likely to be alkaline.

Next, in Step S33, a solution P 812 is prepared. Then, in Step S35, the mixture 811 of Step S32 and the solution P 812 prepared in Step S33 are mixed, whereby the mixture 821 of Step S41 is formed. Here, by adjusting the amount or concentration of the solution P 812 to be added, the pH of the obtained mixture 821 of Step S41 and the mixture 831 of Step S52 obtained later can be adjusted. In Step S35, for example, the solution P 812 is dropped while the pH of the mixture 811 of Step S32 is measured. As the solution P 812, an alkaline solution or an acidic solution is used in accordance with the pH of the mixture 811 of Step S32. Here, by using a slightly alkaline or slightly acidic solution, the pH is easily adjusted in some cases. For example, the pH of the alkaline solution is greater than or equal to 8 and less than or equal to 12. Furthermore, the pH of the acidic solution is greater than or equal to 2 and less than or equal to 6. As the alkaline solution, ammonia water is used, for example. The pH and mixed amount of the solution P 812 are preferably determined so that the mixture 831 of Step S52, which is described later, becomes acidic or neutral.

Next, in Step S42, a transition metal M2 source 822 is prepared. As the transition metal M2 source 822, one or more of an iron (II) compound, a manganese (II) compound, a cobalt (II) compound, and a nickel (II) compound (hereinafter referred to as an M (II) compound) can be used.

Note that a high-purity material is preferably used as the transition metal M2 source used for the synthesis. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a secondary battery and/or increase the reliability of a secondary battery.

In addition, it is preferable that the transition metal M2 source at this time have high crystallinity. For example, the transition metal source preferably includes single crystal grains.

Typical examples of the iron (II) compound include iron chloride tetrahydrate (FeCl₂·4H₂O), iron sulfate heptahydrate (FeSO₄·7H₂O), and iron acetate (Fe(CH₃COO)₂).

Typical examples of the manganese (II) compound include manganese chloride tetrahydrate (MnCl₂·4H₂O), manganese sulfate monohydrate (MnSO₄·H₂O), and manganese acetate tetrahydrate (Mn(CH₃COO)₂·4H₂O).

Typical examples of the cobalt (II) compound include cobalt chloride hexahydrate (CoCl₂·6H₂O), cobalt sulfate heptahydrate (CoSO₄·7H₂O), and cobalt acetate tetrahydrate (Co(CH₃COO)₂·4H₂O).

Typical examples of the nickel (II) compound include nickel chloride hexahydrate (NiCl₂·6H₂O), nickel sulfate hexahydrate (NiSO₄·6H₂O), and nickel acetate tetrahydrate (Ni(CH₃COO)₂·4H₂O).

Note that in Step S42, an aqueous solution of any of the above compounds may be prepared as the transition metal M2 source 822. In the case of preparing an aqueous solution of the compound, water to be used is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher.

Next, in Step S51, the mixture 821 of Step S41 and the transition metal M2 source 822 are mixed, whereby the mixture 831 of Step S52 is obtained.

Here, in Step S51, the concentration of the mixture 831 of Step S52 can be reduced by addition of a solvent. For example, in Step S51, the mixture 821 of Step S41, the transition metal M2 source 822, and a solvent are mixed, whereby the mixture 831 of Step S52 can be formed.

Next, in Step S53, the mixture 831 of Step S52 is put into a heat- and pressure-resistant container such as an autoclave; then, heating is performed at a temperature higher than or equal to 100° C. and lower than or equal to 350° C., preferably higher than 100° C. and lower than 200° C. under a pressure higher than or equal to 0.11 MPa and lower than or equal to 100 MPa, preferably higher than or equal to 0.11 MPa and lower than or equal to 2 MPa for longer than or equal to 0.5 hours and shorter than or equal to 24 hours, preferably longer than or equal to 1 hour and shorter than or equal to 10 hours, further preferably longer than or equal to 1 hour and shorter than 5 hours; after that, cooling is performed. Then, in Step S54, the solution in the heat- and pressure-resistant container is filtered, followed by washing with water. Next, in Step S55, drying and subsequent collection are performed, whereby a positive electrode active material 150A of Step S56 is obtained. The positive electrode active material 150A can be used as the second material 100y described in Embodiment 1 and Embodiment 2.

Note that the water in Step S54 is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The washing with high-purity pure water makes it possible to obtain the high-purity positive electrode active material 150A, and can increase the capacity of a secondary battery and/or increase the reliability of a secondary battery.

### [Method 2 for Forming Positive Electrode Active Material]

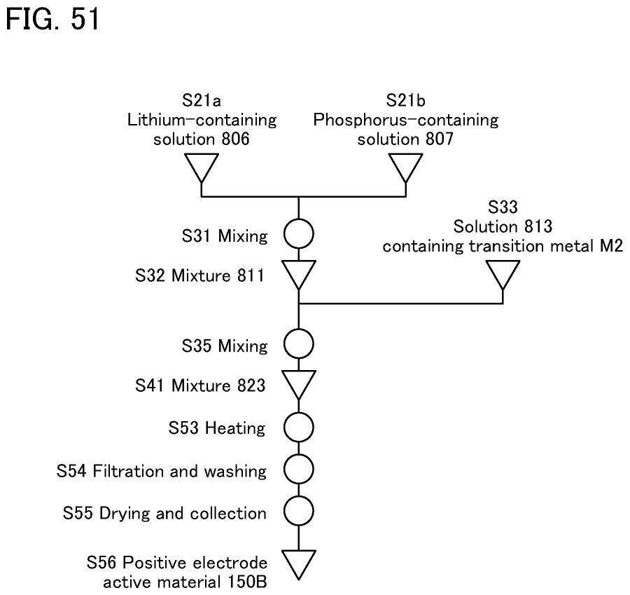

Another example of a method for forming a positive electrode active material of one embodiment of the present invention will be described with reference to FIG. 51.

In Step S21a, a lithium-containing solution 806 is prepared. In Step S21b, a phosphorus-containing solution 807 is prepared.

The lithium-containing solution 806 can be formed by dissolving a lithium compound in a solvent. As the lithium compound, any one or more of lithium hydroxide monohydrate (LiOH·H₂O), lithium chloride (LiCl), lithium carbonate (Li₂CO₃), lithium acetate (CH₃COOLi), and lithium oxalate ((COOLi)₂) can be used. Water can be given as the solvent in which the lithium compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

The phosphorus-containing solution 807 can be formed by dissolving a phosphorus compound in a solvent. As the phosphorus compound, any one or more of phosphoric acid such as orthophosphoric acid (H₃PO₄) and ammonium hydrogen phosphate such as diammonium hydrogen phosphate ((NH₄)₂HPO₄) and ammonium dihydrogen phosphate (NH₄H₂PO₄) can be used. Water can be given as the solvent in which the phosphorus compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

Next, in Step S31, the lithium-containing solution 806 and the phosphorus-containing solution 807 are mixed, whereby the mixture 811 of Step S32 is obtained. The mixing in Step S31 can be performed in an atmosphere of air, an inert gas, or the like. As the inert gas, nitrogen may be used, for example. Here, as an example, the lithium-containing solution 806 prepared in Step S21a and the phosphorus-containing solution 807 prepared in Step S21b are mixed in an air atmosphere.

Note that instead of forming the mixture 811 of Step S32 by mixing the lithium-containing solution 806 and the phosphorus-containing solution 807, the mixture 811 of Step S32 may be formed by preparing a compound containing phosphorus and lithium, such as Li₃PO₄, Li₂HPO₄, or LiH₂PO₄, and adding the compound to a solvent.

Next, in Step S33, a solution 813 containing the transition metal M2 is prepared.

The solution 813 containing the transition metal M2 can be formed by dissolving a transition metal M2 compound in a solvent. As the transition metal M2 compound, one or more of an iron (II) compound, a manganese (II) compound, a cobalt (II) compound, and a nickel (II) compound (hereinafter referred to as an M (II) compound) can be used. Water can be given as the solvent in which the transition metal M2 compound is dissolved. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The use of a high-purity material can increase the capacity of a secondary battery and/or increase the reliability of a secondary battery.

Note that a high-purity material is preferably used as the transition metal M2 compound used for the synthesis. Specifically, the purity of the material is higher than or equal to 3N (99.9%), preferably higher than or equal to 4N (99.99%), further preferably higher than or equal to 4N5 (99.995%), still further preferably higher than or equal to 5N (99.999%). The use of a high-purity material can increase the capacity of a secondary battery and/or increase the reliability of a secondary battery.

In addition, it is preferable that the transition metal M2 compound at this time have high crystallinity. For example, the transition metal compound preferably includes single crystal grains. To evaluate the crystallinity of the transition metal compound, for example, the crystallinity can be judged by a TEM (transmission electron microscope) image, an STEM (scanning transmission electron microscope) image, a HAADF-STEM (high-angle annular dark field scanning transmission electron microscope) image, an ABF-STEM (annular bright-field scan transmission electron microscope) image, and the like. For evaluation of the crystallinity of the transition metal M2 compound, X-ray diffraction (XRD), electron diffraction, neutron diffraction, and the like can also be used for judging. Note that the above-described crystallinity evaluation can be applied not only to the transition metal M2 compound but also to a primary particle or a secondary particle.

Typical examples of the iron (II) compound include iron chloride tetrahydrate (FeCl₂·4H₂O), iron sulfate heptahydrate (FeSO₄·7H₂O), and iron acetate (Fe(CH₃COO)₂).

Typical examples of the manganese (II) compound include manganese chloride tetrahydrate (MnCl₂·4H₂O), manganese sulfate monohydrate (MnSO₄·H₂O), and manganese acetate tetrahydrate (Mn(CH₃COO)₂·4H₂O).

Typical examples of the cobalt (II) compound include cobalt chloride hexahydrate (CoCl₂·6H₂O), cobalt sulfate heptahydrate (CoSO₄·7H₂O), and cobalt acetate tetrahydrate (Co(CH₃COO)₂·4H₂O).

Typical examples of the nickel (II) compound include nickel chloride hexahydrate (NiCl₂·6H₂O), nickel sulfate hexahydrate (NiSO₄·6H₂O), and nickel acetate tetrahydrate (Ni(CH₃COO)₂·4H₂O).

Next, in Step S35, the mixture 811 of Step S32 and the solution 813 containing the transition metal M2 are mixed, whereby a mixture 823 of Step S41 is obtained.

Here, the atomic ratio of lithium to the transition metal M2 and phosphorus of the composite oxide preferably obtained as the positive electrode active material 150 is x:y:z. In order to obtain LiM2PO₄, for example, x:y:z=1:1:1 is satisfied. The positive electrode active material 150 can be used as the second material 100y described in Embodiment 1 and Embodiment 2.

In a method for the mixing in Step S35, the solution 813 containing the transition metal M2 is dropped little by little into the mixture 811 of Step S32 that is put in a container, whereby the mixture 823 of Step S41 can be formed. In the mixing, it is preferred that the solution in the container and the solution used for the mixing be being stirred, and it is also preferred that dissolved oxygen be removed by N₂ bubbling.

Alternatively, in a method for the mixing in Step S35, the mixture 811 of Step S32 is dropped little by little into the solution 813 containing the transition metal M2 that is put in a container, whereby the mixture 823 of Step S41 can be formed. In the mixing, it is preferred that the solution in the container and the solution used for the mixing be being stirred, and it is also preferred that dissolved oxygen be removed by N₂ bubbling.

Here, in Step S35, the concentration of the mixture 823 of Step S41 can be adjusted by addition of a solvent. For example, in Step S35, the mixture 811 of Step S32, the solution 813 containing the transition metal M2, and a solvent are mixed, whereby the mixture 823 of Step S41 can be formed. In the case where water is used as the solvent, it is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher.

Next, in Step S53, the mixture 823 of Step S41 is put into a heat- and pressure-resistant container such as an autoclave; then, heating is performed at a temperature higher than or equal to 100° C. and lower than or equal to 350° C., preferably higher than 100° C. and lower than 200° C. under a pressure higher than or equal to 0.11 MPa and lower than or equal to 100 MPa, preferably higher than or equal to 0.11 MPa and lower than or equal to 2 MPa for longer than or equal to 0.5 hours and shorter than or equal to 24 hours, preferably longer than or equal to 1 hour and shorter than or equal to 10 hours, further preferably longer than or equal to 1 hour and shorter than 5 hours; after that, cooling is performed. Then, in Step S54, the solution in the heat- and pressure-resistant container is filtered, followed by washing with water. Next, in Step S55, drying and subsequent collection are performed, whereby a positive electrode active material 150B of Step S56 is obtained. The positive electrode active material 150B can be used as the second material 100y described in Embodiment 1 and Embodiment 2.

Note that the water in Step S54 is preferably pure water that includes few impurities and preferably has a resistivity of 1 MΩ·cm or higher, further preferably has a resistivity of 10 MΩ·cm or higher, and still further preferably has a resistivity of 15 MΩ·cm or higher. The washing with high-purity pure water makes it possible to obtain the high-purity positive electrode active material 150B, and can increase the capacity of a secondary battery and/or increase the reliability of a secondary battery.

As described above, a composite oxide, e.g., LiM2PO₄ (M is one or more of Fe(II), Ni(II), Co(II), and Mn(II)) is preferably obtained as the positive electrode active material 150 (the positive electrode active material 150A and the positive electrode active material 150B). Depending on the kind of the M (II) compound, any of the following is obtained as appropriate, for example: LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b is 1 or less, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e is 1 or less, 0<c<1, 0<d<1, and 0<e<1), and LiFe_{f}Ni_{g}CoₕMnᵢPO₄ (f+g+h+i is 1 or less, 0<d<1, 0<g<1, 0<h<1, and 0<i<1). The composite oxide obtained according to this embodiment may be a single crystal grain.

By performing crystal analysis such as XRD or electron diffraction, for example, on the positive electrode active material 150 (the positive electrode active material 150A and the positive electrode active material 150B), the crystal structure can be identified. By performing crystal analysis on the positive electrode active material 150, a crystal structure belonging to a space group Pnma can be obtained in some cases. Here, LiM2PO₄ having an olivine crystal structure belongs to the space group Pnma, for example.

As described above, in one embodiment of the present invention, high-purity materials are used as raw materials used in the synthesis, and a positive electrode active material is formed in a process where impurities are less likely to be mixed during the synthesis. The positive electrode active material obtained by such a method for forming a positive electrode active material is a material having a low impurity concentration, that is, a highly purified material. Moreover, the positive electrode active material obtained by such a method for forming a positive electrode active material is a material having high crystallinity. With the positive electrode active material obtained by the method for forming the positive electrode active material of one embodiment of the present invention, the capacity of a secondary battery can be increased and/or the reliability of a secondary battery can be increased.

This embodiment can be used in combination with the other embodiments.

### Embodiment 6

In this embodiment, a lithium-ion secondary battery including a positive electrode active material of one embodiment of the present invention will be described. The secondary battery at least includes an exterior body, a current collector, an active material (a positive electrode active material or a negative electrode active material), a conductive additive, and a binder. An electrolyte solution in which a lithium salt or the like is dissolved is also included. In the secondary battery using an electrolyte solution, a positive electrode, a negative electrode, and a separator between the positive electrode and the negative electrode are provided.

### [Positive Electrode]

The positive electrode includes a positive electrode active material layer and a positive electrode current collector. The positive electrode active material layer preferably includes the composite 100z including the positive electrode active material described in Embodiment 1, and may further include a binder, a conductive additive, or the like.

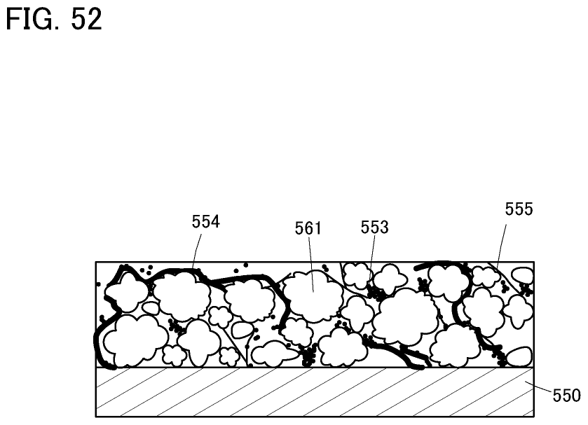

FIG. 52 illustrates an example of a cross-sectional schematic view of the positive electrode.

A current collector 550 is metal foil, and the positive electrode is formed by applying slurry onto the metal foil and drying the slurry. Pressing may be performed after drying. The positive electrode is a component obtained by forming an active material layer over the current collector 550.

Slurry refers to a material solution that is used to form an active material layer over the current collector 550 and includes at least an active material, a binder, and a solvent, preferably also a conductive additive mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A conductive additive is also referred to as a conductivity-imparting agent or a conductive agent, and a carbon material is used. A conductive additive is attached between a plurality of active materials, whereby the plurality of active materials are electrically connected to each other, and the conductivity increases. Note that the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Typical examples of the carbon material used as the conductive additive include carbon black (e.g., furnace black, acetylene black, and graphite).

In FIG. 52, acetylene black 553, a graphene compound 554, and a carbon nanotube 555 are illustrated as the conductive additives. Note that in FIG. 52, an active material 561 corresponds to the first material 100x or the composite 100z described in Embodiment 1.

In the positive electrode of the secondary battery, a binder (a resin) is mixed in order to fix the current collector 550 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is reduced to a minimum.

The graphene compound 554, which has electrically, mechanically, or chemically remarkable characteristics, is a carbon material that is expected to be used in a variety of fields, such as field-effect transistors and solar batteries.

The graphene compound 554 has excellent electrical characteristics of high conductivity and excellent physical properties of high flexibility and high mechanical strength in some cases. The graphene compound 554 has a sheet-like shape. The graphene compound 554 has a curved surface in some cases, thereby enabling low-resistant surface contact. Furthermore, the graphene compound 554 has extremely high conductivity even with a small thickness in some cases and thus allows a conductive path to be formed in an active material layer efficiently even with a small amount. Hence, the graphene compound 554 is preferably used as the conductive additive, in which case the area where the active material and the conductive additive are in contact with each other can be increased. Note that the graphene compound 554 preferably clings to at least part of the active material 561. The graphene compound 554 preferably overlays at least part of the active material 561. The shape of the graphene compound 554 preferably conforms to at least part of the shape of the active material 561. The shape of the active material means, for example, an uneven surface of a single active material particle or an uneven surface formed by a plurality of active material particles. The graphene compound 554 preferably surrounds at least part of the active material 561. The graphene or the graphene compound 554 may have a hole.

Note that in FIG. 52, a region that is not filled with the active material 561, the graphene compound 554, the acetylene black 553, or the carbon nanotube 555 represents a space or the binder. A space is required for the electrolyte solution to penetrate the positive electrode; too many spaces lower the electrode density, too few spaces do not allow the electrolyte solution to penetrate the positive electrode, and a space that remains after the secondary battery is completed lowers the energy density.

Note that all of the acetylene black 553, the graphene compound 554, and the carbon nanotube 555 are not necessarily included as the conductive additive. At least one kind of conductive additive is needed.

The composite 100z obtained in Embodiment 1 is used in the positive electrode, whereby a secondary battery having a high energy density and favorable output characteristics can be obtained.

The positive electrode in FIG. 52 is used, and a stack in which a separator is provided over the positive electrode and a negative electrode is provided over the separator is set in a container (e.g., an exterior body or a metal can) and the container is filled with an electrolyte solution, whereby a secondary battery can be fabricated.

Although the above structure is an example of a secondary battery using an electrolyte solution, one embodiment of the present invention is not limited thereto.

For example, a semi-solid-state battery or an all-solid-state battery can be fabricated using the composite 100z described in Embodiment 1.

In this specification and the like, a semi-solid-state battery refers to a battery in which at least one of an electrolyte layer, a positive electrode, and a negative electrode includes a semi-solid-state material. The term “semi-solid-state” here does not mean that the proportion of a solid-state material is 50%. The term “semi-solid-state” means having properties of a solid, such as a small volume change, and also having some of properties close to those of a liquid, such as flexibility. A single material or a plurality of materials can be used to satisfy the above properties. For example, a porous solid-state material infiltrated with a liquid material may be used.

In this specification and the like, a polymer electrolyte secondary battery refers to a secondary battery in which an electrolyte layer between a positive electrode and a negative electrode includes a polymer. Polymer electrolyte secondary batteries include a dry (or true) polymer electrolyte battery and a polymer gel electrolyte battery. A polymer electrolyte secondary battery may be referred to as a semi-solid-state battery.

A semi-solid-state battery fabricated using the composite 100z described in Embodiment 1 is a secondary battery having high charge and discharge capacity. The semi-solid-state battery can have high charge and discharge voltage. Alternatively, a highly safe or highly reliable semi-solid-state battery can be achieved.

The composite 100z described in Embodiment 1 and another positive electrode active material may be mixed to be used.

Examples of another positive electrode active material include composite oxides having an olivine crystal structure, a layered rock-salt crystal structure, and a spinel crystal structure. Examples include compounds such as LiFePO₄, LiFeO₂, LiNiO₂, LiMn₂O₄, V₂O₅, Cr₂O₅, and MnO₂.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide are measured, it is preferable to satisfy the following at the time of discharging: 0<a/(b+c)<2; c 0; and 0.26< (b+c)/d<0.5. Note that the proportions of metals, silicon, phosphorus, and other elements in the whole particles of a lithium-manganese composite oxide can be measured with, for example, an ICP-MS (inductively coupled plasma mass spectrometer). The proportion of oxygen in the whole particles of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one element selected from a group consisting of chromium, cobalt, aluminum, nickel, iron, magnesium, molybdenum, zinc, indium, gallium, copper, titanium, niobium, silicon, phosphorus, and the like.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not dissolve at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material, and may further include a conductive additive and a binder.

### <Negative Electrode Active Material>

As the negative electrode active material, an alloy-based material, a carbon-based material, or a mixture thereof can be used, for example.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by alloying and dealloying reactions with lithium, a compound containing the element, and the like may be referred to as an alloy-based material.

In this specification and the like, SiO refers to silicon monoxide, for example. Note that SiO can alternatively be expressed as SiOₓ. Here, it is preferred that x be 1 or have an approximate value of 1. For example, x is preferably more than or equal to 0.2 and less than or equal to 1.5, and preferably more than or equal to 0.3 and less than or equal to 1.2. As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. Here, as artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is generated). For this reason, a lithium-ion secondary battery including graphite can have a high operating voltage. In addition, graphite is preferred because of its advantages such as a relatively high capacity per unit volume, relatively small volume expansion, low cost, and higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride containing lithium and a transition metal, can be used. For example, Li_{2.6}Co_{0.4}N₃ is preferable because of high charge and discharge capacity (900 mAh/g and 1890 mAh/cm³).

A composite nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the composite nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive additive and the binder that can be included in the negative electrode active material layer, materials similar to those for the conductive additive and the binder that can be included in the positive electrode active material layer can be used.

### <Negative Electrode Current Collector>

For the negative electrode current collector, copper or the like can be used in addition to a material similar to that for the positive electrode current collector. Note that a material that is not alloyed with carrier ions of lithium or the like is preferably used for the negative electrode current collector.

### [Separator]

The separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be suppressed and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte]

As one mode of the electrolyte, an electrolyte solution containing a solvent and an electrolyte dissolved in the solvent can be used. As the solvent of the electrolyte solution, an aprotic organic solvent is preferably used. For example, one of ethylene carbonate (EC), propylene carbonate (PC), butylene carbonate, chloroethylene carbonate, vinylene carbonate, y-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more kinds of ionic liquids (room temperature molten salts) which have features of non-flammability and non-volatility as the solvent of the electrolyte solution can prevent a power storage device from exploding, catching fire, and the like even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (Li(C₂O₄)₂, LiBOB) can be used, or two or more of these lithium salts can be used in an appropriate combination in an appropriate ratio.

The electrolyte solution used for the power storage device is preferably highly purified and contains a small amount of dust particles and elements other than the constituent elements of the electrolyte solution (hereinafter also simply referred to as “impurities”). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound like succinonitrile or adiponitrile may be added to the electrolyte solution. The concentration of such an additive agent in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

As the electrolyte, a solid electrolyte including an inorganic material such as a sulfide-based inorganic material or an oxide-based inorganic material, or a solid electrolyte including a high-molecular material such as a PEO (polyethylene oxide)-based high-molecular material can be used. When the solid electrolyte is used, a separator or a spacer is not necessary. Furthermore, the battery can be entirely solidified; therefore, there is no possibility of liquid leakage and thus the safety of the battery is dramatically improved.

Accordingly, the composite 100z obtained in Embodiment 1 can also be applied to all-solid-state batteries. By using the positive electrode slurry or the electrode in an all-solid-state battery, an all-solid-state battery with a high level of safety and favorable characteristics can be obtained.

### [Exterior Body]

For the exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of polyethylene, polypropylene, polycarbonate, ionomer, polyamide, or the like and an insulating synthetic resin film of a polyamide-based resin, a polyester-based resin, or the like is provided over the metal thin film as the outer surface of the exterior body.

The contents described in this embodiment can be combined with the contents described in the other embodiments.

### Embodiment 7

This embodiment will describe examples of shapes of several types of secondary batteries including a positive electrode or a negative electrode formed by the fabrication method described in the foregoing embodiment.

### [Coin-Type Secondary Battery]

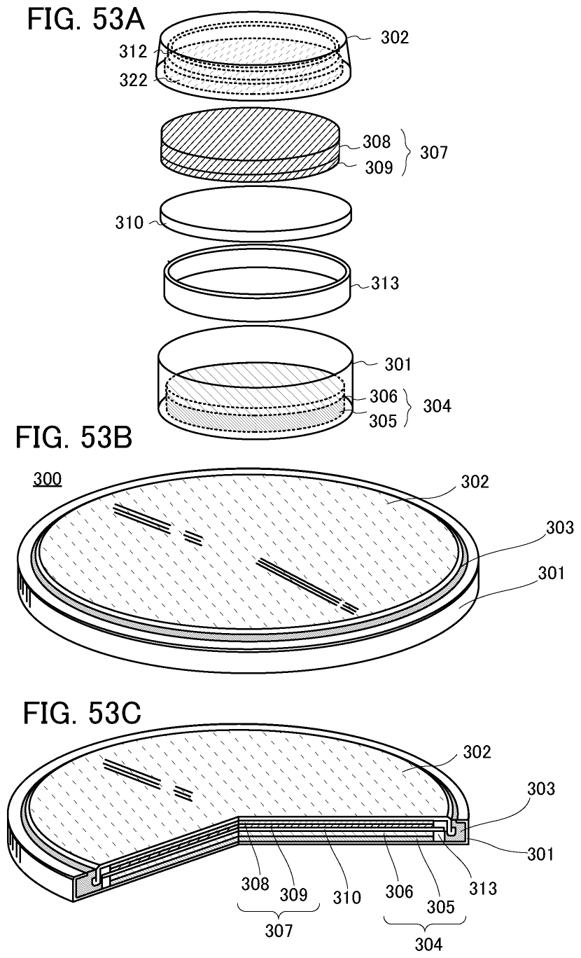

An example of a coin-type secondary battery will be described. FIG. 53A is an exploded perspective view of a coin-type (single-layer flat) secondary battery, FIG. 53B is an external view, and FIG. 53C is a cross-sectional view thereof. Coin-type secondary batteries are mainly used in small electronic devices. In this specification and the like, coin-type batteries include button-type batteries.

For easy understanding, FIG. 53A is a schematic view showing overlap (a vertical relation and a positional relation) between components. Thus, FIG. 53A and FIG. 53B do not completely correspond with each other.

In FIG. 53A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 53A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 53B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 53C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

The secondary battery can be the coin-type secondary battery 300 having high capacity, high charge and discharge capacity, and excellent cycle performance. Note that in the case of a secondary battery, the separator 310 is not necessarily provided between the negative electrode 307 and the positive electrode 304.

### [Cylindrical Secondary Battery]

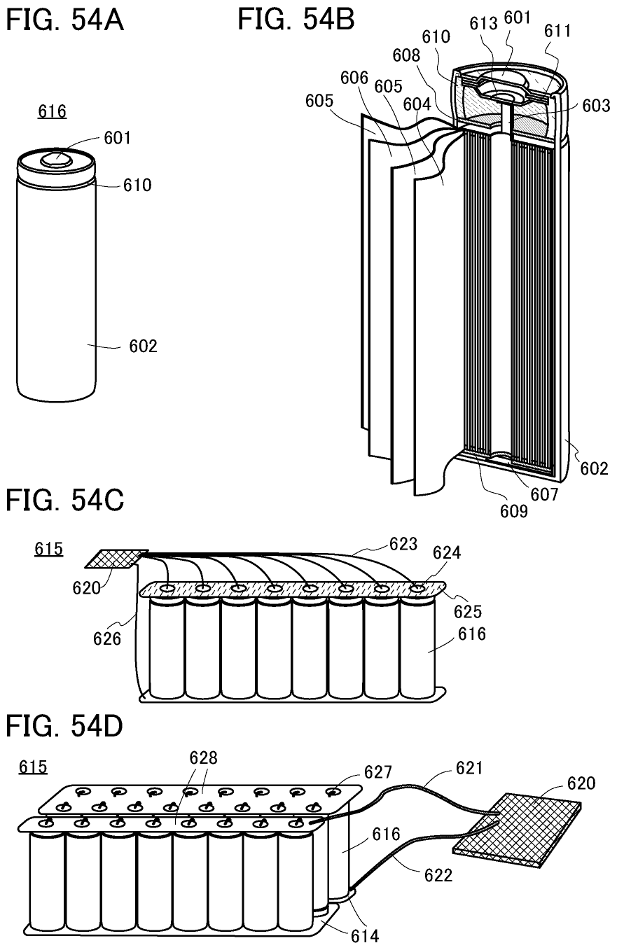

An example of a cylindrical secondary battery is described with reference to FIG. 54A. As illustrated in FIG. 54A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 54B schematically illustrates a cross section of a cylindrical secondary battery. The cylindrical secondary battery illustrated in FIG. 54B includes the positive electrode cap (battery cap) 601 on the top surface and the battery can (outer can) 602 on the side and bottom surfaces. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. Although FIG. 54A to FIG. 54D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The composite 100z obtained in Embodiment 1 is used in the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (positive temperature coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 54C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge or the like can be used, for example.

FIG. 54D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel or connected in series; alternatively, the plurality of secondary batteries 616 may be connected in parallel and then connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 54D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

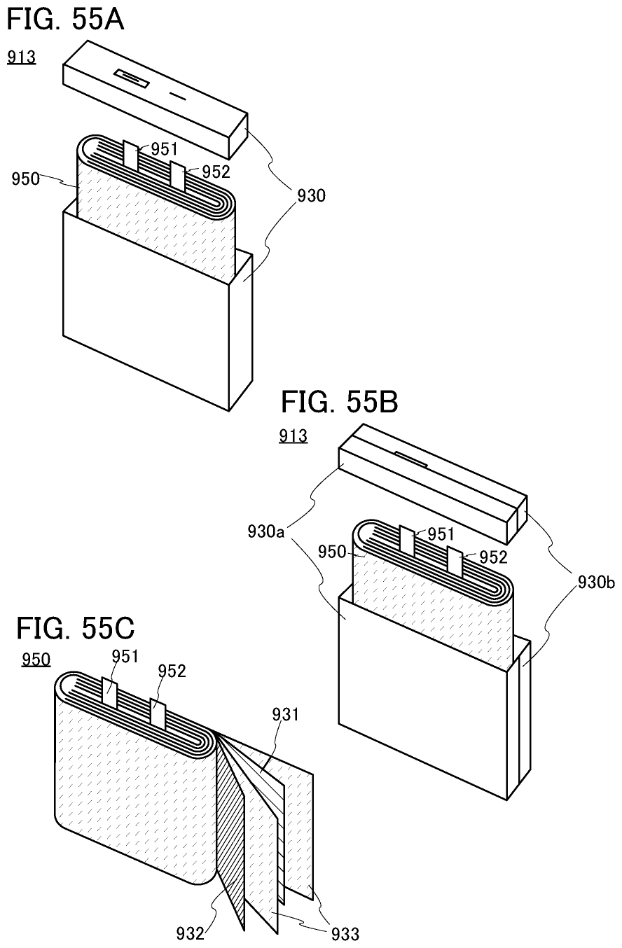

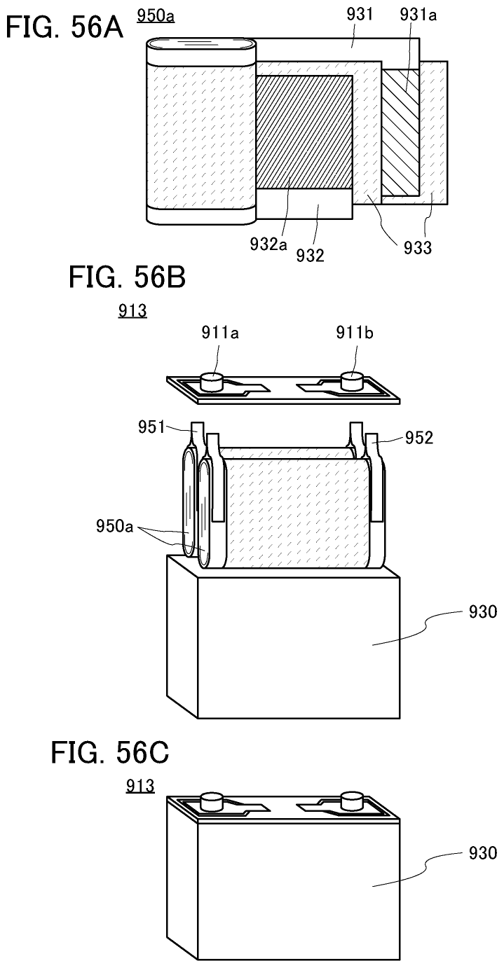

Structure examples of secondary batteries are described with reference to FIG. 55 and FIG. 56.

A secondary battery 913 illustrated in FIG. 55A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 55A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 55B, the housing 930 in FIG. 55A may be formed using a plurality of materials. For example, in the secondary battery 913 in FIG. 55B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 55C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIG. 56A to FIG. 56C, the secondary battery 913 may include a wound body 950a. The wound body 950a illustrated in FIG. 56A includes the negative electrode 931, the positive electrode 932, and the separators 933. The negative electrode 931 includes a negative electrode active material layer 931a. The positive electrode 932 includes a positive electrode active material layer 932a.

The composite 100z obtained in Embodiment 1 is used in the positive electrode 932, whereby the secondary battery 913 can have high capacity, high charge and discharge capacity, and excellent cycle performance.

The separator 933 has a larger width than the negative electrode active material layer 93 1a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 56B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 56C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 56B, the secondary battery 913 may include a plurality of wound bodies 950a. The use of the plurality of wound bodies 950a enables the secondary battery 913 to have higher charge and discharge capacity. The description of the secondary battery 913 in FIG. 55A to FIG. 55C can be referred to for the other components of the secondary battery 913 in FIG. 56A and FIG. 56B.

### <Laminated Secondary Battery>

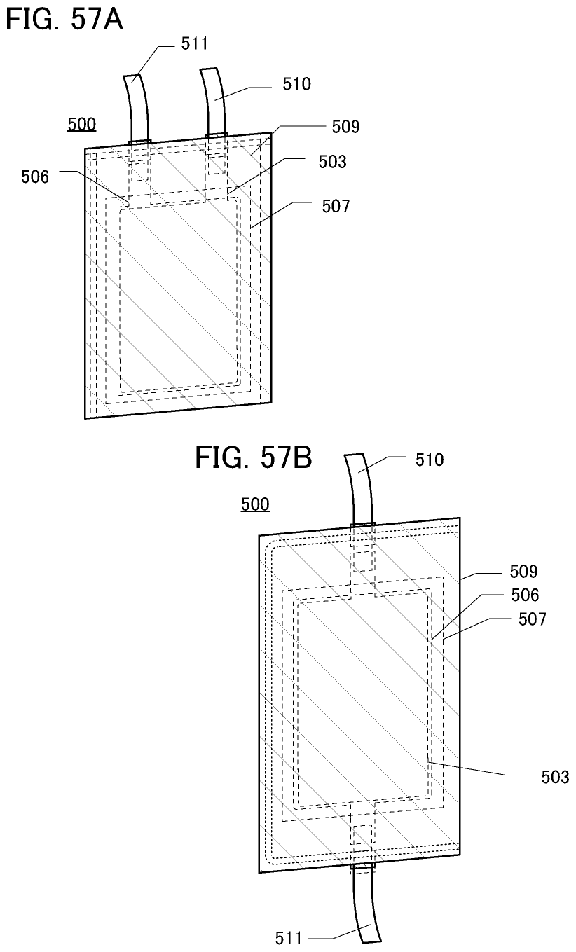

Next, examples of the appearance of a laminated secondary battery are shown in FIG. 57A and FIG. 57B. FIG. 57A and FIG. 57B each illustrate a positive electrode 503, a negative electrode 506, a separator 507, an exterior body 509, a positive electrode lead electrode 510, and a negative electrode lead electrode 511.

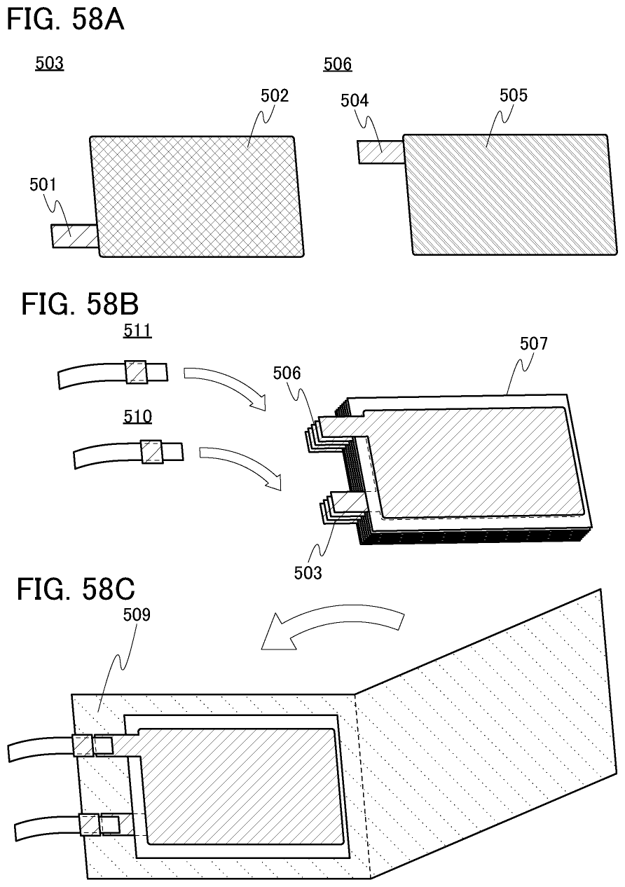

FIG. 58A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those illustrated in FIG. 58A.

### <Method for Fabricating Laminated Secondary Battery>

Here, an example of a method for fabricating the laminated secondary battery having the appearance illustrated in FIG. 57A will be described with reference to FIG. 58B and FIG. 58C.

First, the negative electrode 506, the separator 507, and the positive electrode 503 are stacked. FIG. 58B illustrates the negative electrodes 506, the separators 507, and the positive electrodes 503 that are stacked. Here, an example in which 5 negative electrodes and 4 positive electrodes are used is shown. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 58C. Then, the outer edges of the exterior body 509 are bonded to each other. The bonding can be performed by thermocompression, for example. At this time, a part (or one side) of the exterior body 509 is left unbonded (such part is hereinafter referred to as an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The composite 100z obtained in Embodiment 1 is used in the positive electrode 503, whereby the secondary battery 500 can have high capacity, high charge and discharge capacity, and excellent cycle performance.

### [Examples of Battery Pack]

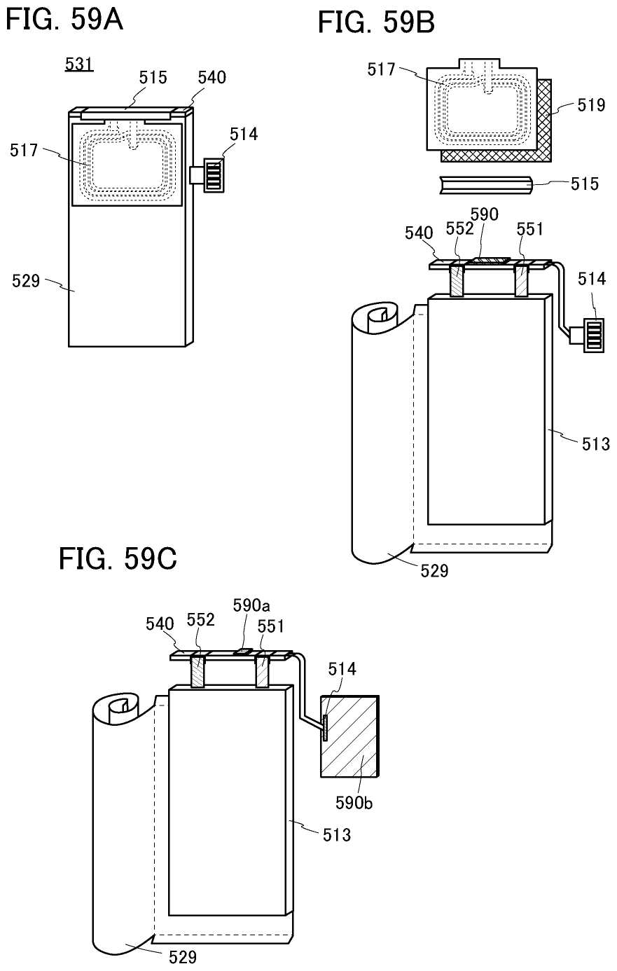

Examples of a secondary battery pack of one embodiment of the present invention that is capable of wireless charging using an antenna will be described with reference to FIG. 59A to FIG. 59C.

FIG. 59A illustrates the appearance of a secondary battery pack 531 that has a rectangular solid shape with a small thickness (also referred to as a flat plate shape with a certain thickness). FIG. 59B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 59B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 59C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

The contents in this embodiment can be freely combined with the contents in the other embodiments.

### Embodiment 8

This embodiment will describe an example in which an all-solid-state battery is fabricated using the composite 100z obtained in Embodiment 1.

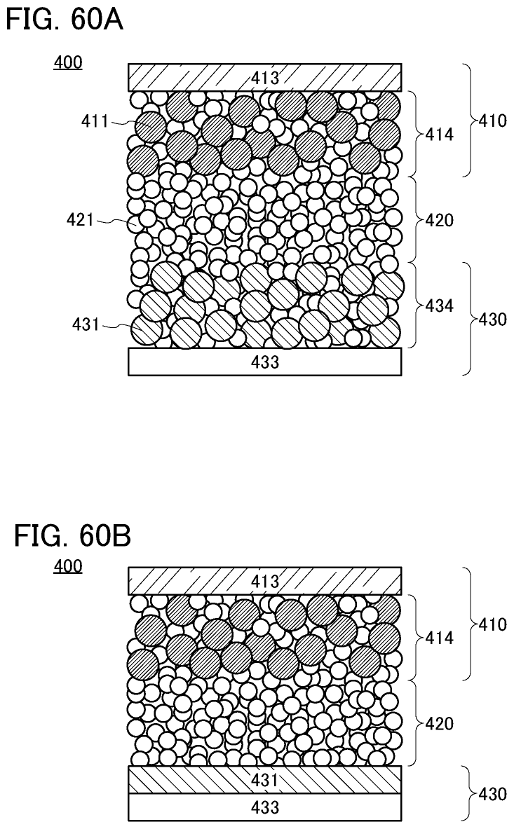

As illustrated in FIG. 60A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The composite 100z obtained in Embodiment 1 is used as the positive electrode active material 411. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used as the negative electrode active material 431, metal lithium does not need to be processed into particles; thus, the negative electrode 430 that does not include the solid electrolyte 421 can be formed, as illustrated in FIG. 60B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, and 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃ (0[x[1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can employ a variety of materials and have a variety of shapes, and preferably has a function of applying pressure to the positive electrode, the solid electrolyte layer, and the negative electrode.

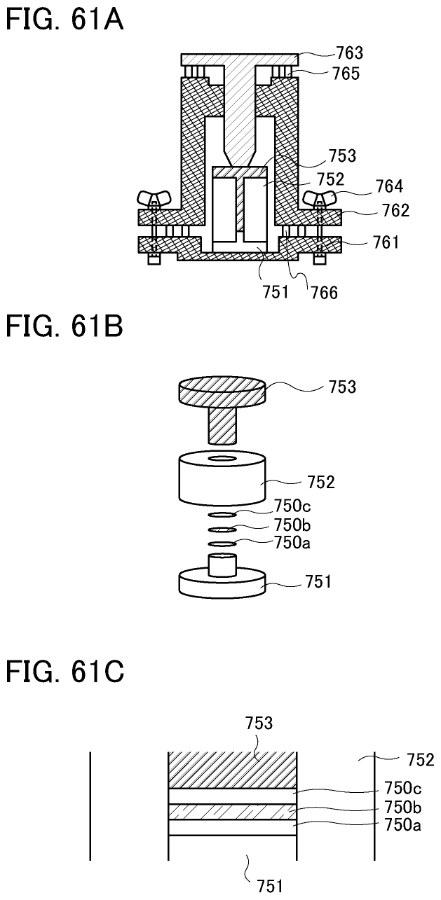

FIG. 61 show an example of a cell for evaluating materials of an all-solid-state battery.

FIG. 61A is a schematic cross-sectional view of the evaluation cell. The evaluation cell includes a lower component 761, an upper component 762, and a fixation screw or a butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 61B is an enlarged perspective view of the evaluation material and its vicinity.

A stack of a positive electrode 750a, a solid electrolyte layer 750b, and a negative electrode 750c is shown here as an example of the evaluation material, and its cross section is shown in FIG. 61C. Note that the same portions in FIG. 61A to FIG. 61C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

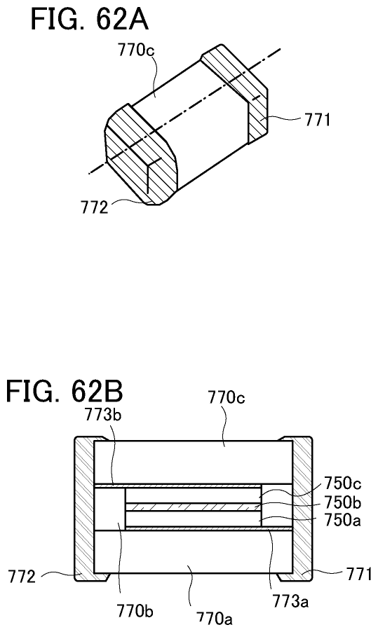

FIG. 62A is a perspective view of a secondary battery of one embodiment of the present invention that has an exterior body and a shape different from those in FIG. 61. The secondary battery in FIG. 62A includes an external electrode 771 and an external electrode 772 and is sealed with an exterior body including a plurality of package components.

FIG. 62B shows an example of a cross section along the dashed-dotted line in FIG. 62A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate. For the package components 770a, 770b, and 770c, an insulating material such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the composite 100z described in Embodiment 1 can achieve an all-solid-state secondary battery having a high energy density and favorable output characteristics.

The contents in this embodiment can be combined with the contents in the other embodiments as appropriate.

### Embodiment 9

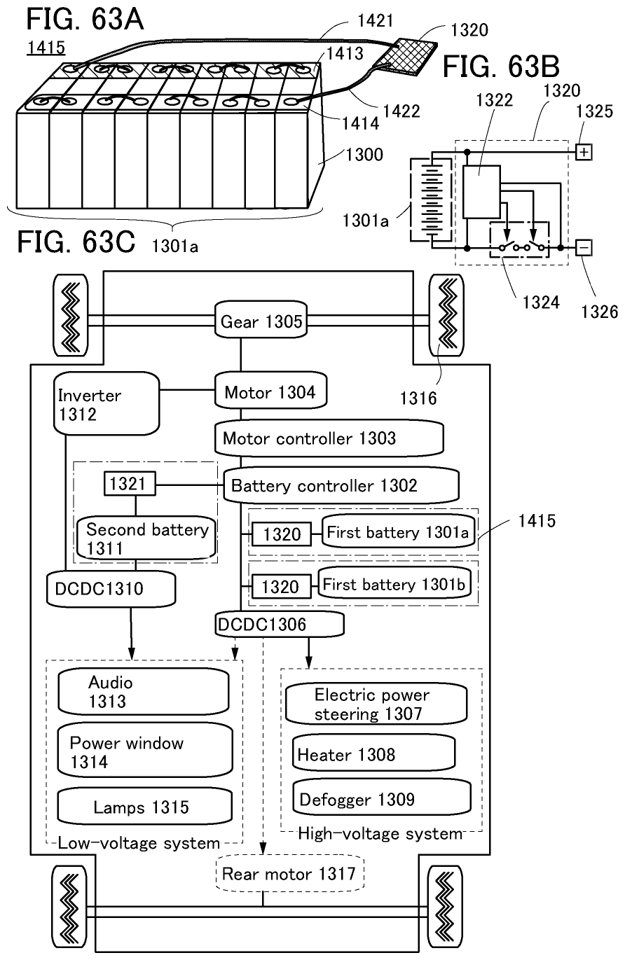

This embodiment is an example different from the cylindrical secondary battery of FIG. 54D. An example of application to an electric vehicle (EV) will be described with reference to FIG. 63C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 needs high output and high capacity is not so necessary, and the capacity of the second battery 1311 is lower than that of the first batteries 1301a and 1301b.

The internal structure of the first battery 1301a may be the wound structure illustrated in FIG. 55A or FIG. 56C or the stacked structure illustrated in FIG. 57A or FIG. 57B. Alternatively, the first battery 1301a may be the all-solid-state battery in Embodiment 8. Using the all-solid-state battery in Embodiment 8 as the first battery 1301a achieves high capacity, a high degree of safety, reduction in size, and reduction in weight.

Although this embodiment describes an example in which two first batteries 1301a and 1301b are connected in parallel, three or more first batteries may be connected in parallel. When the first battery 1301a is capable of storing sufficient electric power, the first battery 1301b may be omitted. With a battery pack including a plurality of secondary batteries, large electric power can be extracted. The plurality of secondary batteries may be connected in parallel, connected in series, or connected in series after being connected in parallel. The plurality of secondary batteries can also be referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a will be described with reference to FIG. 63A.

FIG. 63A shows an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a BTOS (Battery operating system or Battery oxide semiconductor).

A metal oxide functioning as an oxide semiconductor is preferably used. For example, as the oxide, a metal oxide such as an In-M-Zn oxide (the element Mis one or more selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the ratios of the numbers of In, Ga, and Zn atoms to the metal elements contained in the CAC-OS in an In—Ga—Zn oxide are denoted by [In], [Ga], and [Zn], respectively.

For example, the first region in the CAC-OS in the In—Ga—Zn oxide has [In] higher than [In] in the composition of the CAC-OS film. Moreover, the second region has [Ga] higher than [Ga] in the composition of the CAC-OS film. Alternatively, for example, the first region has [In] higher than [In] in the second region and [Ga] lower than [Ga] in the second region. Moreover, the second region has [Ga] higher than [Ga] in the first region and [In] lower than [In] in the first region.

Specifically, the first region is a region including indium oxide, indium zinc oxide, or the like as its main component. The second region is a region including gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, in EDX mapping obtained by energy dispersive X-ray spectroscopy (EDX), it is confirmed that the CAC-OS in the In—Ga—Zn oxide has a structure in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Ion), high field-effect mobility (u), and favorable switching operation can be achieved.

An oxide semiconductor has various structures with different properties. Two or more kinds among the amorphous oxide semiconductor, the polycrystalline oxide semiconductor, the a-like OS, the CAC-OS, the nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. regardless of the temperature. On the other hand, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the degree of safety. When the control circuit portion 1320 is used in combination with a secondary battery including a positive electrode using the composite 100z obtained in Embodiment 1, the synergy on safety can be obtained.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of the secondary battery include prevention of overcharge, prevention of overcurrent, control of overheating during charging, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

A cause of a micro-short circuit is a plurality of charging and discharging; an uneven distribution of positive electrode active materials leads to local concentration of current in part of the positive electrode and the negative electrode; and then part of a separator stops functioning or a by-product is generated by a side reaction, which is thought to generate a micro short-circuit.

It can be said that the control circuit portion 1320 not only detects a micro-short circuit but also senses a terminal voltage of the secondary battery and controls the charge and discharge state of the secondary battery. For example, to prevent overcharging, the control circuit portion 1320 can turn off an output transistor of a charging circuit and an interruption switch substantially at the same time.

FIG. 63B is an example of a block diagram of the battery pack 1415 illustrated in FIG. 63A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery is a recommended voltage range, and when a voltage is out of the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide; x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which a lithium-ion secondary battery is used as each of the first battery 1301a and the second battery 1311 is described. As the second battery 1311, a lead storage battery, an all-solid-state battery, or an electric double layer capacitor may be used. For example, the all-solid-state battery in Embodiment 8 may be used. Using the all-solid-state battery in Embodiment 8 as the second battery 1311 achieves high capacity, a high degree of safety, reduction in size, and reduction in weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or a connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet with 50 kW, for example. Furthermore, charging can be performed with electric power supplied from external charging equipment by a contactless power feeding system or the like.

For fast charging, secondary batteries that can withstand high-voltage charging have been desired to perform charging in a short time.

The above-described secondary battery in this embodiment includes the composite 100z obtained in Embodiment 1. Moreover, even when graphene is used as a conductive additive and the electrode layer is formed thick to increase the loading amount, it is possible to achieve a secondary battery with significantly improved electrical characteristics while synergy such as a reduction in capacity and the retention of high capacity can be obtained. This secondary battery is particularly effectively used in a vehicle and can achieve a vehicle that has a long range, specifically a driving range per charge of 500 km or longer, without increasing the proportion of the weight of the secondary battery to the weight of the entire vehicle.

Specifically, in the above-described secondary battery in this embodiment, the use of the composite 100z described in Embodiment 1 can increase the operating voltage of the secondary battery, and the increase in charge voltage can increase the available capacity. Moreover, using the composite 100z described in Embodiment 1 in the positive electrode can provide an automotive secondary battery having excellent charge and discharge cycle performance.

Next, as examples in which the secondary battery of one embodiment of the present invention is mounted on a moving object, examples in which it is mounted on a vehicle, typically a transport vehicle, will be described.

Mounting the secondary battery illustrated in any of FIG. 54D, FIG. 56C, and FIG. 63A on vehicles can achieve next-generation clean energy vehicles such as hybrid vehicles (HVs), electric vehicles (EVs), and plug-in hybrid vehicles (PHVs). The secondary battery can also be mounted on moving objects such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in moving objects.

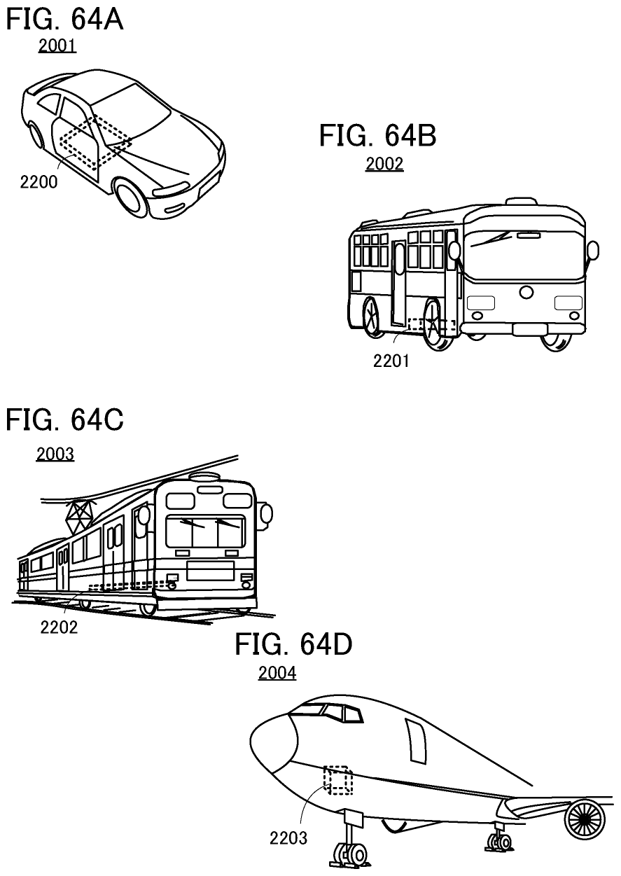

FIG. 64A to FIG. 64D show examples of transport vehicles using one embodiment of the present invention. An automobile 2001 illustrated in FIG. 64A is an electric vehicle that runs on an electric motor as a power source. Alternatively, the automobile 2001 is a hybrid electric vehicle that can appropriately select an electric motor or an engine as a driving power source. In the case where the secondary battery is mounted on the vehicle, an example of the secondary battery described in Embodiment 7 is provided at one position or several positions. The automobile 2001 illustrated in FIG. 64A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery of the automobile 2001 receives electric power from an external charging equipment through a plug-in system, a contactless charging system, or the like. In charging, a given method such as CHAdeMO (registered trademark) or Combined Charging System may be employed as a charging method, the standard of a connector, and the like as appropriate. The secondary battery may be a charging station provided in a commerce facility or a household power supply. For example, a plug-in technique enables an exterior power supply to charge a power storage device incorporated in the automobile 2001. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 64B shows a large transporter 2002 having a motor controlled by electric power, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has a function similar to that in FIG. 64A except, for example, the number of secondary batteries forming the secondary battery module of the battery pack 2201 or the like is different; thus the description is omitted.

FIG. 64C shows a large transport vehicle 2003 having a motor controlled by electricity as an example. The secondary battery module of the transport vehicle 2003 has 100 or more secondary batteries with a nominal voltage of 3.0 V or higher and 5.0 V or lower connected in series, and the maximum voltage is 600 V, for example. With the use of the positive electrode using the composite 100z described in Embodiment 1, a secondary battery having favorable rate characteristics and charge and discharge cycle performance can be fabricated, which can contribute to higher performance and a longer life of the transport vehicle 2003. A battery pack 2202 has a function similar to that in FIG. 64A except that the number of secondary batteries forming the secondary battery module of the battery pack 2202 or the like is different; thus, the detailed description is omitted.

FIG. 64D shows an aircraft 2004 having a combustion engine as an example. The aircraft 2004 shown in FIG. 64D can be regarded as a kind of transport vehicle since it is provided with wheels for takeoff and landing, and has a battery pack 2203 including a secondary battery module and a charging control device; the secondary battery module includes a plurality of connected secondary batteries.

The secondary battery module of the aircraft 2004 has eight 4 V secondary batteries connected in series, which has the maximum voltage of 32 V, for example. A battery pack 2203 has a function similar to that in FIG. 64A except, for example, the number of secondary batteries forming the secondary battery module of the battery pack 2203; thus the detailed description is omitted.

The contents in this embodiment can be combined with the contents in the other embodiments as appropriate.

### Embodiment 10

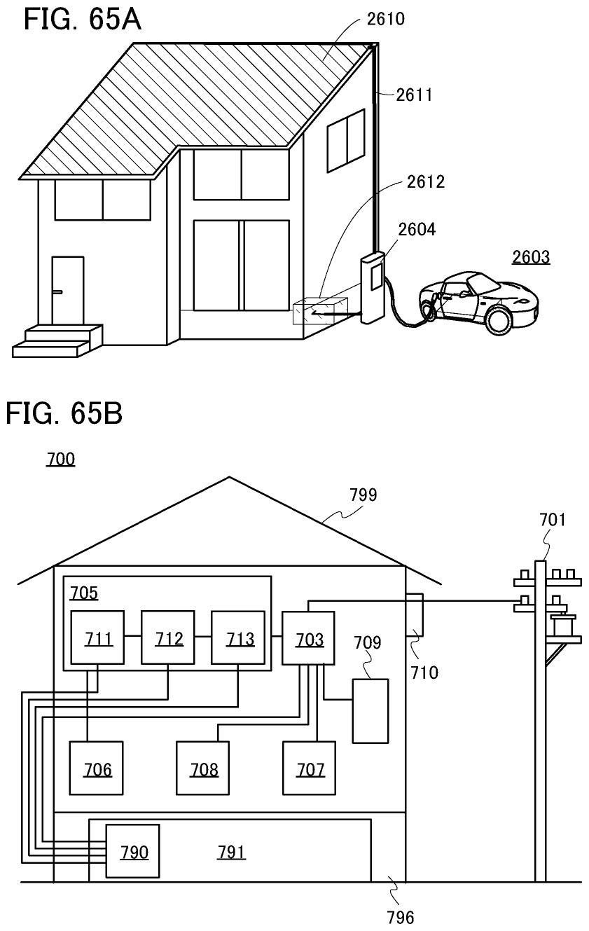

In this embodiment, examples in which the secondary battery of one embodiment of the present invention is mounted on a building will be described with reference to FIG. 65A and FIG. 65B.

A house illustrated in FIG. 65A includes a power storage device 2612 including the secondary battery which is one embodiment of the present invention and a solar panel 2610. The power storage device 2612 is electrically connected to the solar panel 2610 through a wiring 2611 or the like. The power storage device 2612 may be electrically connected to a ground-based charging equipment 2604. The power storage device 2612 can be charged with electric power generated by the solar panel 2610. The secondary battery included in the vehicle 2603 can be charged with the electric power stored in the power storage device 2612 through the charging equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like.

FIG. 65B shows an example of a power storage device of one embodiment of the present invention. As illustrated in FIG. 65B, a power storage device 791 of one embodiment of the present invention is provided in an underfloor space 796 of a building 799. The power storage device 791 may be provided with the control circuit described in Embodiment 9, and the use of a secondary battery including a positive electrode using the composite 100z obtained in Embodiment 1 for the power storage device 791 enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 11

This embodiment will describe examples in which the power storage device of one embodiment of the present invention is mounted on a motorcycle and a bicycle.

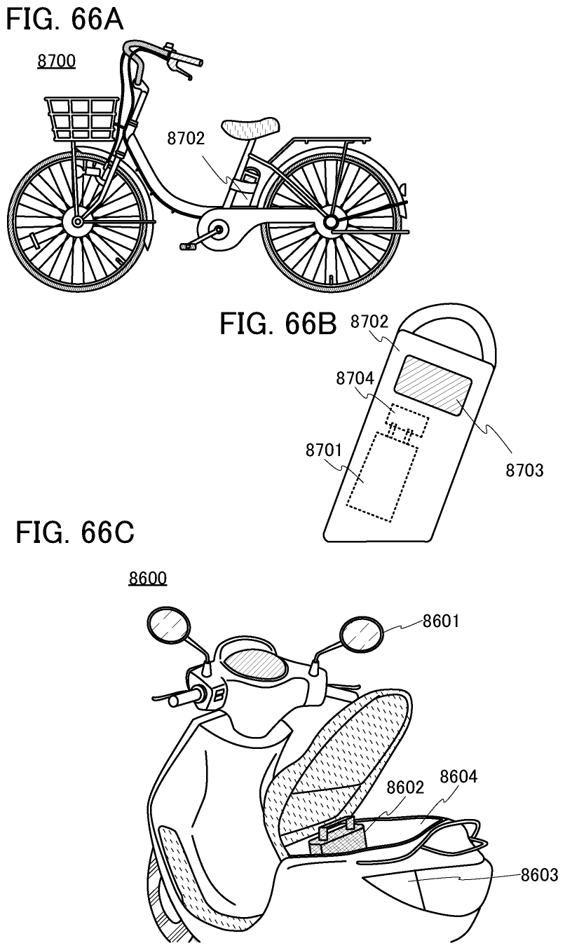

FIG. 66A shows an example of an electric bicycle using the power storage device of one embodiment of the present invention. The power storage device of one embodiment of the present invention can be used for an electric bicycle 8700 illustrated in FIG. 66A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 66B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 9. The control circuit 8704 is electrically connected to a positive electrode and a negative electrode of the storage battery 8701. The control circuit 8704 may include the small solid-state secondary battery illustrated in FIG. 62A and FIG. 62B. When the small solid-state secondary battery illustrated in FIG. 62A and FIG. 62B is provided in the control circuit 8704, electric power can be supplied to store data in a memory circuit included in the control circuit 8704 for a long time. When the control circuit 8704 is used in combination with a secondary battery including a positive electrode using the composite 100z obtained in Embodiment 1, the synergy on safety can be obtained. The secondary battery including the positive electrode using the composite 100z obtained in Embodiment 1 and the control circuit 8704 can contribute greatly to elimination of accidents due to secondary batteries, such as fires.

FIG. 66C shows an example of a motorcycle using the power storage device of one embodiment of the present invention. A motor scooter 8600 illustrated in FIG. 66C includes a power storage device 8602, side mirrors 8601, and indicator lights 8603. The power storage device 8602 can supply electricity to the indicator lights 8603. The power storage device 8602 including a plurality of secondary batteries including a positive electrode using the composite 100z obtained in Embodiment 1 can have high capacity and contribute to a reduction in size.

In the motor scooter 8600 illustrated in FIG. 66C, the power storage device 8602 can be stored in an under-seat storage unit 8604. The power storage device 8602 can be stored in the under-seat storage unit 8604 even with a small size.

The contents in this embodiment can be combined with the contents in the other embodiments as appropriate.

### Embodiment 12

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book terminal, and a mobile phone.

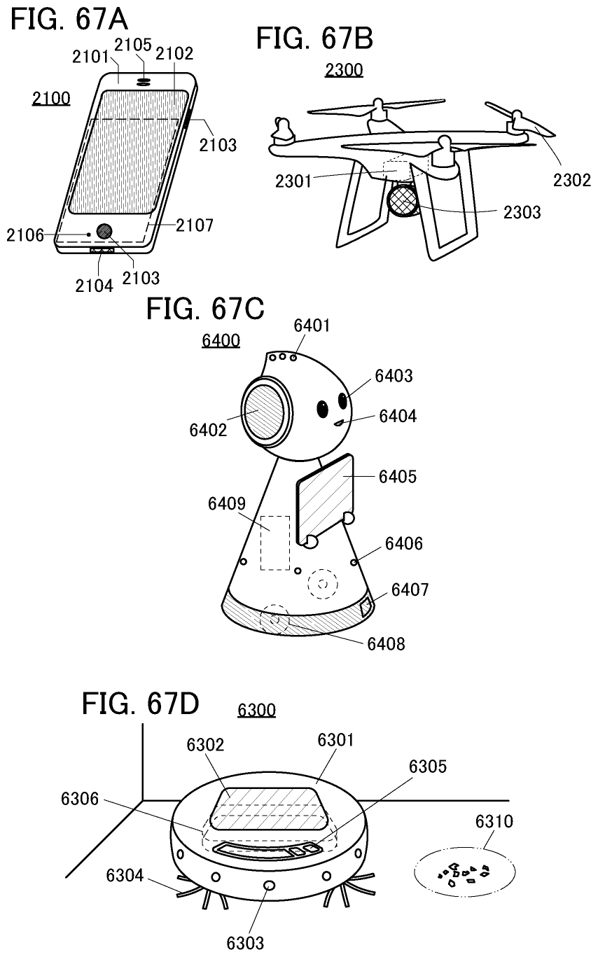

FIG. 67A shows an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the composite 100z described in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 67B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the composite 100z obtained in Embodiment 1 has high energy density and a high degree of safety, and thus can be used safely for a long time over a long period of time and is preferable as the secondary battery included in the unmanned aircraft 2300.

FIG. 67C shows an example of a robot. A robot 6400 illustrated in FIG. 67C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the composite 100z obtained in Embodiment 1 has high energy density and a high degree of safety, and thus can be used safely for a long time over a long period of time and is preferable as the secondary battery 6409 included in the robot 6400.

FIG. 67D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the composite 100z obtained in Embodiment 1 has high energy density and a high degree of safety, and thus can be used safely for a long time over a long period of time and is preferable as the secondary battery 6306 included in the cleaning robot 6300.

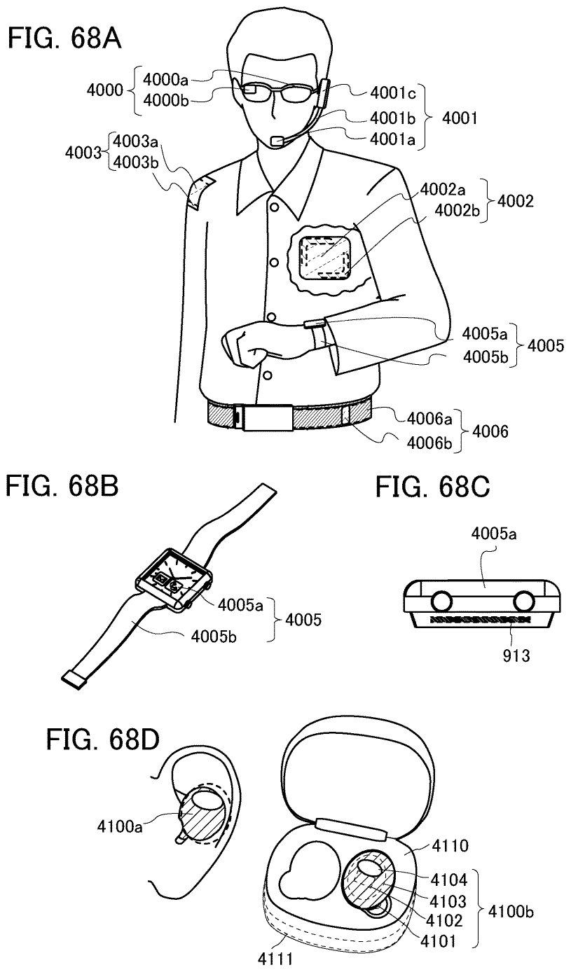

FIG. 68A shows examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 68A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the composite 100z obtained in Embodiment 1 has high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. A secondary battery including a positive electrode using the composite 100z obtained in Embodiment 1 has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the composite 100z obtained in Embodiment 1 has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the composite 100z obtained in Embodiment 1 has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the composite 100z obtained in Embodiment 1 has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the composite 100z obtained in Embodiment 1 has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 68B is a perspective view of the watch-type device 4005 that is detached from an arm.

FIG. 68C is a side view. FIG. 68C illustrates a state where the secondary battery 913 is incorporated in the inner region. The secondary battery 913 is the secondary battery described in Embodiment 7. The secondary battery 913 is provided to overlap the display portion 4005a, can have high density and high capacity, and is small and lightweight. Since the secondary battery in the watch-type device 4005 is required to be small and lightweight, the use of the composite 100z obtained in Embodiment 1 in the positive electrode of the secondary battery 913 enables the secondary battery 913 to have high energy density and a small size.

FIG. 68D shows an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably include a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the composite 100z obtained in Embodiment 1 has a high energy density; thus, with the use of the secondary battery as the secondary battery 4103 and the secondary battery 4111, space saving required with downsizing of the wireless earphones can be achieved.

This embodiment can be implemented in appropriate combination with the other embodiments.

### Example

In this example, the composite 100z including the positive electrode active material of one embodiment of the present invention was formed and its features were analyzed.

### <Formation of First Material>

A sample of a first material that was formed in this example in accordance with the formation method shown in FIG. 15, FIG. 16A, and FIG. 16B will be described.

As the LiM1O₂ in Step S14 in FIG. 15, with the use of cobalt as the transition metal M1, a commercially available lithium cobalt oxide (Cellseed C-10N produced by NIPPON CHEMICAL INDUSTRIAL CO., LTD.) not containing any additive element was prepared. The initial heating in Step S15 was performed on the lithium cobalt oxide, which was put in a crucible covered with a lid, in a muffle furnace at 850° C. for two hours. After the muffle furnace was filled with an oxygen atmosphere, no flowing was performed (O₂ purging). The collected amount after the initial heating showed a slight decrease in weight. The decrease in weight was probably caused by elimination of impurities from the lithium cobalt oxide.

In accordance with the formation flows shown in FIG. 15, FIG. 16A, and FIG. 16B, Mg, F, Ni, and Al as additive elements were separately added. In accordance with Step S21 shown in FIG. 16A, LiF and MgF₂ were prepared as the F source and the Mg source, respectively. LiF and MgF₂ were weighed at a molar ratio of LiF:MgF₂=1:3 (molar ratio). Then, LiF and MgF₂ were mixed into acetone (super-dehydrated) and the mixture was stirred at a rotating speed of 400 rpm for 12 hours, whereby an additive element source X_{A} was produced. Then, the mixture was made to pass through a sieve with an aperture of 300 μm, whereby the additive element source X_{A} having a uniform particle diameter was obtained.

Next, the additive element source X_{A} was weighed to be 1 at % of the transition metal M1, and mixed with the lithium cobalt oxide subjected to the initial heating by a dry process. Stirring was performed at a rotating speed of 150 rpm for one hour. These conditions were milder than those of the stirring in the production of the additive element source X_{A}. Finally, the mixture was made to pass through a sieve with an aperture of 300 μm, whereby a mixture A having a uniform particle diameter was obtained.

Then, the mixture A was heated. The heating conditions were 900° C. and 20 hours. During the heating, a lid was put on the crucible containing the mixture A. The crucible was filled with an atmosphere containing oxygen and entry and exit of the oxygen were blocked (purged). By the heating, a lithium cobalt oxide containing Mg and F (composite oxide A) was obtained.

Then, an additive element source X_{B} was added to the composite oxide A. In accordance with Step S41 shown in FIG. 16B, nickel hydroxide and aluminum hydroxide were prepared as the Ni source and the Al source, respectively. The nickel hydroxide and the aluminum hydroxide were each weighed to be 0.5 at % of the transition metal M1, and were mixed with the composite oxide A by a dry process. Stirring was performed at a rotating speed of 150 rpm for one hour. These conditions were milder than those of the stirring in the production of the additive element source X_{A}. Finally, the mixture was made to pass through a sieve with an aperture of 300 μm, whereby a mixture B having a uniform particle diameter was obtained.

Then, the mixture B was heated. The heating was performed at 850° C. for 10 hours. During the heating, a lid was put on the crucible containing the mixture B. The crucible was filled with an atmosphere containing oxygen and entry and exit of the oxygen were blocked (purged). By the heating, lithium cobalt oxide containing Mg, F, Ni, and Al was obtained. The positive electrode active material (composite oxide B) obtained in the above manner was used as Sample A.

### <Formation of Composite>

A sample of a composite including a positive electrode active material, which was formed in this example in accordance with the formation method shown in FIG. 1A and FIG. 1B, will be described.

As the first material of Step S101 in FIG. 1A, Sample A described above was prepared. As the second material of Step S102, an aluminum oxide (produced by Sigma-Aldrich Corporation, with an average particle diameter of 50 nm or less) was prepared. As the composing process in Step S103, Sample A and the aluminum oxide were processed using Picobond produced by Hosokawa Micron Ltd. The amount of the aluminum oxide was set at 1 at % with respect to that of Sample A. As the conditions of the composing process, the rotational frequency of the rotor was set to 3500 rpm and the processing time was set to 10 minutes. The composite including the positive electrode active material after being subjected to the composing process was collected and used as Sample B. Note that a high energy load-type particle design machine (NOB) was used for the composing process in Step S103 in this example; however, the formation method is not particularly limited, and a Mechano fusion system (AMS) may be used.

In Step S104 of FIG. 1B, the composite including the positive electrode active material formed by the same method as Sample B was heated. In the heat treatment, the composite including the positive electrode active material was put in a crucible, and the heating conditions were 650° C. and 2 hours. During the heating, a lid was put on the crucible containing the mixture A. The inside of the furnace is an oxygen-containing atmosphere, and supply of the oxygen was performed by flow control at 5 L/min. The composite including the positive electrode active material, which was collected after the heating, was used as Sample C.

A composite including a positive electrode active material that was processed by the same method except that the heating temperature in Step S104 of FIG. 1B was set to 850° C. was used as Sample D.

### <SEM>

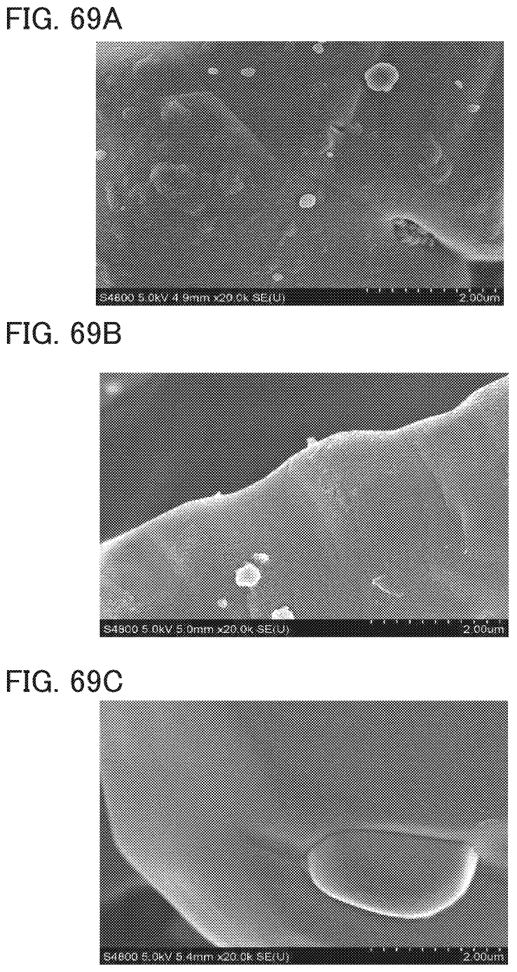

FIG. 69A to FIG. 69C show scanning electron microscope (SEM) observation results. In the SEM observation in this example, an S4800 scanning electron microscope produced by Hitachi High-Tech Corporation was used under the observation conditions where the acceleration voltage was 5 kV and the magnification was 20000 times.

FIG. 69A, FIG. 69B, and FIG. 69C show SEM observation results of Sample B, Sample C, and Sample D, respectively. In Sample B shown in FIG. 69A, which was not heated after the composing process, Al₂O₃ attached to the surface of the lithium cobalt oxide owing the composing process was observed. In Sample C shown in FIG. 69B, which was heated at 650° C. after the composing process, a state suggesting a possibility that Al₂O₃ attached to the surface of the lithium cobalt oxide melted and spread over the surface of the lithium cobalt oxide was observed. In the sample shown in FIG. 69C, which was heated at 850° C. after the composing process, the surface of the lithium cobalt oxide was smoother than those of Sample B and Sample C, indicating a possibility that Al in Al₂O₃ diffused into the inside of the lithium cobalt oxide.

### <Formation of Positive Electrodes>

Positive electrode B, Positive electrode C, and Positive electrode D were formed using Sample B, Sample C, and Sample D with reference to the formation method shown in FIG. 6A and FIG. 6B. PVDF, NMP, and acetylene black were used as the binder, the disperse medium, and the conductive additive, respectively. The mixing ratio was set to LCO:AB:PVDF=95:3:2 (wt %).

### <Cycle Tests>

Next, cycle tests are described. For the cycle tests, half cells using Positive electrode B, Positive electrode C, and Positive electrode D were fabricated and subjected to measurement.

As the electrolyte solution used in the half cells, a mixture of ethylene carbonate (EC) and diethyl carbonate (DEC) at a volume ratio of 3:7 to which vinylene carbonate (VC) was added as an additive at 2 wt % was prepared. As an electrolyte contained in an electrolyte solution, 1 mol/L lithium hexafluorophosphate (LiPF₆) was used.

As a separator used in the half cells, polypropylene was used. As a counter electrode used in the half cells, a lithium metal was prepared. Coin-type half cells were thus fabricated and their cycle performance was measured.

A discharge rate and a charge rate as cycle conditions are described. The discharge rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charge rate; the case where charging is performed with a current of 2X (A) is rephrased as to perform charging at 2 C, and the case where charging is performed with a current of X/5 (A) is rephrased as to perform charging at 0.2 C.

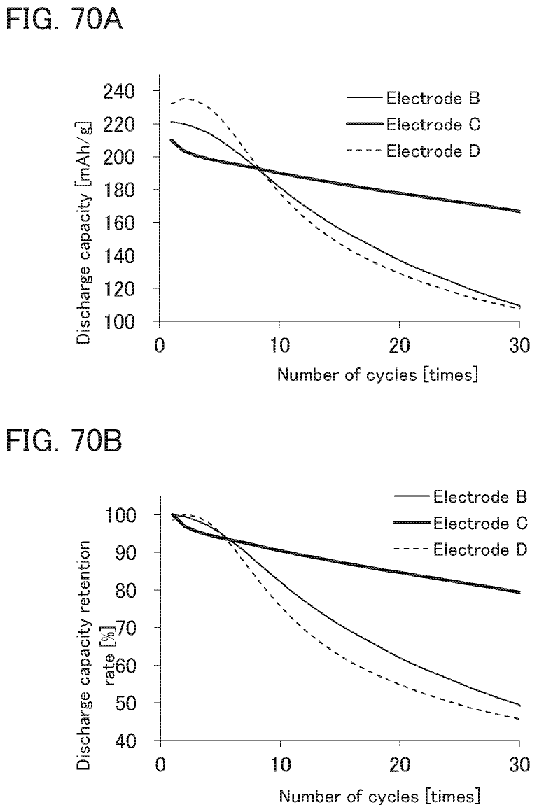

The fabricated half cells were each subjected to 30 cycles of charging and discharging at a charge rate of 0.5 C (1 C=200 mA/g), a discharge rate of 0.5 C, a charge and discharge voltage of 4.7 V, and a measurement temperature of 45° C. FIG. 70A and FIG. 70B show results of the cycle tests. It was found that the cycle performance of Sample C was superior to those of Sample B and Sample D. A comparison in the characteristics of discharge capacity retention rate shown in FIG. 70B indicates that Sample C and Sample D, which were heated after the composing process, have better cycle characteristics than Sample B, which was not heated after the composing process. A comparison between the results of Sample C and Sample D indicates that Sample C, which was heated at 650° C., has better cycle characteristics than Sample D, which was heated at 850° C. The results show the existence of a favorable temperature range including 650° C. in respect to the heating after the composing process.

### REFERENCE NUMERALS

100: positive electrode active material, 100a: surface portion, 100b: inner portion, 100x: first material, 100y: second material, 100z: composite, 101: primary particle, 101a: surface portion, 101b: inner portion, 102: secondary particle, 103: interface, 105: space, 110: binder, 120: dispersion medium, 150: positive electrode active material, 550: current collector, 553: acetylene black, 554: graphene compound, 555: carbon nanotube, 561: active material, 800: transition metal M1 source, 800a: nickel source, 800b: cobalt source, 800c: manganese source, 801: additive element X source, 803: lithium compound, 804: phosphorus compound, 805: solvent, 806: lithium-containing solution, 807: phosphorus-containing solution, 811: mixture, 813: solution containing transition metal M2, 821: mixture, 822: transition metal M2 source, 823: mixture, 831: mixture, 832: mixture, 833: additive element X source, 834: magnesium source, 835: fluorine source, 841: mixture, 842: mixture, 843: additive element X source, 845: nickel source, 846: aluminum source, 847: mixture, 851: mixture, 863: mixture, 903: mixture, 904: mixture, 1001: binder mixture, 1002: conductive additive, 1003: disperse medium, 1010: mixture, 1020: mixture, 1021: mixture, 1022: mixture, 1030: mixture, 1100: mixture

1. A method for forming a positive electrode active material comprising a first material and a second material, comprising:
a first step of covering at least part of a surface of the first material with the second material to form a composite; and
a second step of heating the composite,
wherein the first material comprises a lithium cobalt oxide comprising magnesium, fluorine, aluminum, and nickel,
wherein the second material comprises a second composite oxide represented by LiM2PO₄ (M2 is one or more selected from Fe, Ni, Co, and Mn), and
wherein the heating is performed in an oxygen-containing atmosphere.

2. A method for forming a positive electrode active material comprising a first material and a second material, comprising:
a first step of covering at least part of a surface of the first material with the second material to form a composite; and
a second step of heating the composite,
wherein the first material comprises a lithium cobalt oxide comprising magnesium, fluorine, aluminum, and nickel,
wherein the second material comprises an aluminum oxide, and
wherein the heating is performed in an oxygen-containing atmosphere.

3. The method for forming a positive electrode active material, according to claim 1,
wherein the heating is performed at higher than or equal to 450° C. and lower than or equal to 800° C.

4. The method for forming a positive electrode active material, according to claim 2,
wherein the heating is performed at higher than or equal to 450° C. and lower than or equal to 800° C.

5. A method for forming a positive electrode active material comprising a first material and a second material, comprising:
forming a first mixture by grinding and mixing a lithium source and a transition metal source;
heating the first mixture to form a first composite oxide;
heating the first composite oxide which is put in a crucible covered with a lid to form a second composite oxide;
forming a second mixture by mixing the second composite oxide with a magnesium source and a fluorine source;
heating the second mixture to form a third composite oxide;
forming a third mixture by mixing the third composite oxide with an aluminum source and a nickel source;
heating the third mixture to form the first material;
forming a composite by covering at least part of the first material with the second material; and
heating the composite,
wherein the first material comprises a lithium cobalt oxide comprising magnesium, fluorine, aluminum, and nickel,
wherein the second material comprises a material represented by LiM2PO₄ or an aluminum oxide,
wherein M2 is one or more selected from Fe, Ni, Co, and Mn,
wherein a temperature in the step of heating of the first composite oxide is lower than a temperature in the step of heating of the first mixture, and
wherein the step of heating of the composite is performed in an oxygen-containing atmosphere.

6. The method for forming a positive electrode active material, according to claim 5,
wherein the step of heating of the composite is performed at a temperature highrt than or equal to 400° C. and lower than or equal to 950° C.
